(19) United States
(12) Patent Application Publication
(10) Pub. No.: US 2026/0074183 A1
(43) Pub. Date: Mar. 12, 2026

(54) FORMATION OF SILICON-CARBON COMPOSITE PARTICLES BY MAGNESIOTHERMIC REDUCTION OF SILICON OXIDE FOR LITHIUM-ION BATTERIES

(71) Applicant: Sila Nanotechnologies, Inc., Alameda, CA (US)

(72) Inventors: Adam Paul KAJDOS, Alameda, CA (US); Valentin LULEVICH, Stockton, CA (US); Mareva FEVRE, Oakland, CA (US); Ramon Felix GUZMAN, III, Stockton, CA (US); Evan Neil KNUTSON, Stockton, CA (US); Gleb Nikolayevich Yushin, Atlanta, GA (US)

(21) Appl. No.: 19/320,560

(22) Filed: Sep. 5, 2025

Related U.S. Application Data
(60) Provisional application No. 63/691,716, filed on Sep. 6, 2024.

(51) Int. Cl. H01M 4/04; H01M 4/02; H01M 4/36; H01M 4/38; H01M 4/583; H01M 10/0525

(52) U.S. Cl. CPC H01M 4/049; H01M 4/0428; H01M 4/362; H01M 4/386; H01M 4/583; H01M 10/0525; H01M 2004/021; H01M 2004/027

(57) ABSTRACT

A method of making silicon-carbon composite particles is disclosed. The method includes: (A1) carrying out metallothermic reduction on initial particles comprising silicon oxide in the presence of a metal to form first intermediate particles comprising (1) an oxide of the metal and (2) silicon; (A2) forming a termination material on and in the first intermediate particles to form second intermediate particles; (A3) selectively removing the oxide of the metal from the second intermediate particles to form third intermediate particles; and (A4) forming a protective material on and in the third intermediate particles to form the silicon-carbon composite particles. In some implementations, the metal comprises magnesium or a magnesium-aluminum alloy. Silicon-carbon composite particles, lithium-ion rechargeable batteries, and other related processes and components are also disclosed.

### CROSS-REFERENCE TO RELATED APPLICATIONS

The present application for patent claims the benefit of U.S. Provisional Application No. 63/691,716, entitled “FORMATION OF SILICON-CARBON COMPOSITE PARTICLES BY MAGNESIOTHERMIC REDUCTION OF SILICON OXIDE FOR LITHIUM-ION BATTERIES,” filed Sep. 6, 2024, assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicles, grid storage and other important applications. However, despite the increasing commercial prevalence of batteries, further development of these batteries is needed, particularly for applications in low- or zero-emission, hybrid-electric or fully electric vehicles, consumer electronics, wearable devices, energy-efficient cargo ships and locomotives, drones, aerospace applications, and power grids. Further improvements are desired for various rechargeable batteries, such as rechargeable Li and Li-ion batteries, Na and Na-ion batteries, K and K-ion batteries, and dual ion batteries, to name a few.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

In certain types of rechargeable batteries, charge storing anode active materials may be produced as high-capacity (nano)composite powders, which exhibit moderately high volume changes (e.g., about 8-250 vol. %) during the first charge-discharge cycle and moderate volume changes (e.g., about 5-60 vol. %) during the subsequent charge-discharge cycles. A subset of such charge-storing anode particles includes anode particles with a volume-average size (e.g., diameter or thickness) in the range of about 0.2 to about 40 microns (micrometers, or μm), as measured using laser particle size distribution analysis (LPSA), laser image analysis, electron microscopy, optical microscopy or other suitable techniques. Such a class of charge-storing particles offers great promises for scalable manufacturing and achieving high cell-level energy density and other performance characteristics.

Achieving a net-zero carbon footprint by 2050 requires a fast transition to battery electric vehicles since they dramatically decrease greenhouse gas (GHG) emissions compared to internal combustion engine (ICE) vehicles. However, the electrification of the transportation sector is slowing down as customers anticipate longer driving range, faster charging, and longer battery warranties at a much-reduced cost and environmental impact. When integrated in lithium-ion batteries (LiBs), silicon-carbon (Si—C) dominant anodes suffer from volume expansion, as it results in persistent breaking and reforming of the SEI and disintegration of particles, destroying cycle life and from increased reactivity of the interphase due to poor passivating solid-electrolyte interphase (SEI) properties at high temperature (T) and state-of-charge (SOC). In some commercialization examples, Si—C composite material achieves ultra-low volume change with a scalable process, suitable for consumer devices and automotives. However, many Si—C anode materials that achieve high service life and energy density use a silane (such as SiH₄ (silane), Si₂H₆ (disilane), Si₃H₅ (trisilane), Si₄H₁₀ (tetrasilane), dichlorosilane, trichlorosilane, silicon tetrachloride (tetrachlorosilane), methyl silane, and methyl trichlorosilane (MTS)) as a silicon precursor in a chemical vapor deposition (CVD) process, thereby limiting the cost reductions that may be achieved at a given scale.

Accordingly, there remains a need for improved batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of making silicon-carbon composite particles includes (A1) carrying out metallothermic reduction on initial particles comprising silicon oxide in the presence of a metal to form first intermediate particles comprising (1) an oxide of the metal and (2) elemental silicon; (A2) forming a termination material on and in the first intermediate particles to form second intermediate particles; (A3) selectively removing the oxide of the metal from the second intermediate particles to form third intermediate particles; and (A4) forming a protective material on and in the third intermediate particles to form the silicon-carbon composite particles.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and/or other techniques described herein may be implemented.

FIG. 2 is a flow diagram of a process of making a Li-ion rechargeable battery cell in accordance with certain embodiments.

FIG. 3 is a flow diagram of a process of making silicon-carbon (nano)composite particles from porous carbon particles.

FIG. 4 is a schematic illustration of an example process of making silicon-carbon composite particles, in accordance with some embodiments. A starting material comprises a mixture of silicon oxide particles and a carbon precursor compound. The example process includes carrying out magnesiothermic reduction.

FIG. 5A is a schematic cross-sectional view of a lab-scale two-deck boat for use in a magnesiothermic reduction process to attain high-yield, uniform reduction of silicon oxide particles. FIG. 5B is a photograph of the lab-scale two-deck boat schematically shown in FIG. 5A. FIG. 5C is a schematic perspective view of a rotary two-deck boat for use in a magnesiothermic reduction process to attain high-yield, uniform reduction of silicon oxide particles.

FIGS. 6A and 6B are x-ray diffraction (XRD) data and XRD phase composition analysis results (inset) for material obtained from porous silica input material (A) from carrying out magnesiothermic reduction at 630° C. for 4 h and (B) from carrying out magnesiothermic reduction at 630° C. for 4 h followed by washing (etching) in 1 M HCl, respectively.

FIGS. 7A and 7B are scanning electron micrographs of (A) crystalline quartz input material and (B) material obtained from crystalline quartz input material, from carrying out magnesiothermic reduction at 630° C. for 4 h, followed by washing (etching) in 1 M HCl, and sealing by CVD-deposited carbon (33 vol. % propylene in N₂ at 630° C. for 18 h).

FIGS. 8A and 8B show scanning electron micrographs of (A) spheroidal porous silica particles (input material) and (B) material obtained from porous silica particles (input material), from carrying out magnesiothermic reduction at 630° C. for 4 h, followed by washing (etching) in 1 M HCl, and sealing by CVD-deposited carbon (33 vol. % propylene in N₂ at 630° C. for 18 h).

FIGS. 9A and 9B show scanning electron micrographs of a material obtained from carrying out magnesiothermic reduction at 630° C. for 4 h, followed by washing (etching) in 1 M HCl, and sealing by CVD-deposited carbon (33% propylene in N₂ at 630° C. for 9 h, at (A) 5000× magnification and (B) 50,000× magnification, where the reduced Si particles dispersed in a C matrix can be observed. The input material to the magnesiothermic reduction was a composite of 90 wt. % SiO₂ and 10 wt. % C.

FIG. 10A is a flow diagram of an example process of making silicon-comprising particles from silicon oxide feedstock via metallothermic reduction.

FIG. 10B is a flow diagram of an example sub-process of FIG. 10A for producing initial particles comprising silicon oxide embedded within or coated by a carbon matrix.

FIG. 10C is a flow diagram of an example process for making silicon-carbon (Si—C) composite particles from porous silicon dioxide particles.

FIGS. 10D, 10F, and 10G are flow diagrams of example processes for making silicon-carbon (Si—C) composite particles from SiO₂ or SiO₂-comprising particles.

FIG. 10E is a flow diagram of a plasma-assisted sealing process for sealing silicon-carbon composite particles.

FIG. 10H is a flow diagram of an example process for making an artificial solid-electrolyte-interphase-like layer on Si—C composite particles.

FIG. 10I is a flow diagram of an example process for partially lithiating Si—C composite particles.

FIG. 11 (Table 1) shows the silicon mass fraction of certain Si—C composite particles and selected electrochemical testing (ECT) results of half-cells comprising those Si—C composite particles.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aspects of the present disclosure provide for processes of making advanced carbon-containing composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

While most examples of the present disclosure focus on formation of nanocomposite Si, Si nanoparticles and Si-based (such as silicon-carbon, Si—C) composites (nanocomposites) using magnesiothermic (magnesiothermal) reduction process, it will be appreciated that (i) similar (e.g., similarly structured/nanostructured materials) may be produced and similar processes may be successfully employed for production of nanostructured, nanocomposite/composite battery anode materials based on other metals or semi-metals instead of (or in addition to) Si, such as tin (Sn), antimony (Sb), their various alloys and mixtures and others (e.g., for the formation of Sn—C, Sb—C, Sn—Sb—C, Si—Sn—C, Si—Sb—C, Si—Sb—Sn—C, Si—Mg—C, Sb—Mg—C, Sn—Mg—C, Si—Al—C, Sb—Al—C, Sb—Al—C, Si—Sn—Mg—C, Si—Sb—Mg—C, Si—Al—C, Si—Mg—Al—C, Sn—Mg—Al—C, Al—C, their various combinations and other related nanocomposites comprising one, two or more of the following metals—Si, Sn, Sb, Al and carbon) and (ii) metallothermic (metallothermal) reduction process may utilize metals other than magnesium (Mg), in some implementations (e.g., Al or Mg—Al mixtures, etc.).

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “≈” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., binders, molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types, such as precursor particles (e.g., carbon particles, etc.). Hence, unless otherwise indicated, the following Table provides examples of how such material properties may be readily measured by one of ordinary skill in the art using commercially available instrumentation:

TABLE of
Techniques and Instrumentation for Material Property Measurements

| Material | Property | Measurement | |
|---|---|---|---|
| Type | Type | Instrumentation | Measurement Technique |
| Active | Coulombic | Potentiostat | Charge (current) is passed to |
| Material | Efficiency | | an electrode containing the |
| | | | active material of interest |
| | | | until a given voltage limit is |
| | | | reached. Then, the current is |
| | | | reversed (discharge current) |
| | | | until a second voltage limit is |
| | | | reached. The ratio of the two |
| | | | charges passed determines |
| | | | the Coulombic Efficiency |
| | | | (CE). In the simplest case, |
| | | | the charge and discharge |
| | | | currents may be constant |
| | | | and often have absolute |
| | | | values that are the same or |
| | | | close to each other. It should |
| | | | be understood though that in |
| | | | some experiments, either |
| | | | charge current or discharge |
| | | | current or both may be |
| | | | changing during such |
| | | | experiments (e.g., be initially |
| | | | constant and when the |
| | | | voltage limit is reached, |
| | | | diminishing to a |
| | | | predetermined value). In |
| | | | addition, the absolute value |
| | | | of the charge and discharge |
| | | | currents may differ. |
| Active | Partial Vapor | Manometer | The partial vapor pressure |
| Material | Pressure | | of an active material in a |
| | (e.g., Torr.) | | mixture (e.g., composite |
| | at a | | particle) at a particular |
| | Temperature | | temperature is given by the |
| | (e.g., K) | | known vapor pressure of the |
| | | | active material multiplied by |
| | | | its mole fraction in the |
| | | | mixture. |
| Active | Volume | Gas pycnometer | Gas pycnometer measures |
| Material | | | the skeletal volume of a |
| Particle | | | material by gas displacement |
| | | | using the volume-pressure |
| | | | relationship of Boyle's Law. |
| | | | A sample of known mass is |
| | | | placed into the sample |
| | | | chamber and maintained at |
| | | | a constant temperature. An |
| | | | inert gas, typically helium, |
| | | | is used as the displacement |
| | | | medium. |
| | | | Note: |
| | | | A vol. % change may |
| | | | be calculated from two |
| | | | volume measurements of the |
| | | | active material particle. |
| Active | Open Internal | nitrogen | Nitrogen sorption/desorption |
| Material | Pore Volume | sorption/desorption | isotherm (typically at 77K) is |
| Particle | (e.g., cc/g or | isotherm | collected and analyzed to |
| | cm³/g) | | estimate the total amount of |
| | | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such |
| | | | as Non-Local Density |
| | | | Functional Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in |
| | Size | electron microscope | combination with image |
| | Distributions | (TEM), scanning | analyses, laser microscopy |
| | (e.g., nm) | transmission | (for larger particles and |
| | | microscope (STEM), | larger pores) in combination |
| | | laser microscope, | with image analyses, optical |
| | | Synchrotron X-ray, | microscopy (for larger |
| | | X-ray microscope | particles and larger pores), |
| | | | neutron scattering, X-ray |
| | | | scattering, X-ray microscopy |
| | | | imaging may be employed to |
| | | | measure pore sizes (average |
| | | | pore size or pore size |
| | | | distribution) in different size |
| | | | ranges (in addition to the |
| | | | analysis of the sorption/ |
| | | | desorption isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas |
| | | | pycnometer (or a nitrogen |
| | | | gas pycnometer) and |
| | | | comparing them to the |
| | | | theoretical density of the |
| | | | individual material |
| | | | components present in Si- |
| | | | comprising particles. In |
| | | | addition, closed internal |
| | | | pore volume may be |
| | | | estimated by comparing the |
| | | | total pore volume estimated |
| | | | from neutron scattering and |
| | | | the nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced |
| | (e.g., nm) | | by a solid can be determined. |
| Active | Size | TEM, STEM, SEM, | Laser particle size |
| Material | (e.g., nm, μm, | X-Ray, PSA, etc. | distribution analysis (LPSA), |
| Particle | etc.) | | laser image analysis, electron |
| | | | microscopy, optical |
| | | | microscopy or other suitable |
| | | | techniques |
| | | | transmission electron |
| | | | microscopy (TEM), scanning |
| | | | transmission electron |
| | | | microscopy (STEM), |
| | | | scanning electron |
| | | | microscopy (SEM)), X-ray |
| | | | microscopy, X-ray |
| | | | diffraction, neutron |
| | | | scattering and other suitable |
| | | | techniques |
| Active | Composition | Balance | Note #1: |
| Material | (e.g., mass | | A wt. % change may be |
| Particle | fraction or | | calculated by comparing the |
| | wt. %, mg, | | mass fraction of a material |
| | number of | | in the particle relative to |
| | atoms, etc.) | | the total particle mass. |
| | | | Note #2: |
| | | | The capacity attributable |
| | | | to particular active |
| | | | material(s) in the particle |
| | | | may be derived from the |
| | | | composition, based on the |
| | | | known (e.g., theoretical |
| | | | or practically attainable) |
| | | | capacity(ies) of each active |
| | | | material. |
| | | | Note #3: |
| | | | The composition of the |
| | | | particle may be characterized |
| | | | in terms of weight (e.g., mg). |
| | | | The composition of may |
| | | | alternatively be |
| | | | characterized by a number |
| | | | of atoms of a particular |
| | | | element (e.g., Si, C, etc.). In |
| | | | case of atoms, the number of |
| | | | atoms may be estimated |
| | | | from the weight of that atom |
| | | | in the particle (e.g., based on |
| | | | gas chromatography) |
| Active | Composition | X-ray Fluorescence | |
| Material | (e.g., mass | (XRF), Inductively | |
| Particle | fraction or | Coupled Plasma | |
| | wt. % of | Optical Emission | |
| | various | Spectroscopy (ICP- | |
| | atomic | OES); Energy | |
| | elements or | Dispersive | |
| | molecules, | Spectroscopy (EDS), | |
| | atomic | Wavelength | |
| | fraction or | Dispersive | |
| | at. % of | Spectroscopy | |
| | various | (WDS), Electron | |
| | elements, etc.) | Energy Loss | |
| | | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS); | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current to |
| | | | the electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) |
| | | | gives this quantity (e.g., in |
| | | | mAh/g). The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a |
| Material | (e.g., m²/g) | | sealed chamber at 77K, |
| Particle | | | where nitrogen is introduced |
| | | | at increasing pressure. The |
| | | | change in pressure of the |
| | | | nitrogen is used to calculate |
| | | | the surface area of the |
| | | | sample. |
| Active | Aspect Ratio | SEM, TEM | The dimensions and shape of |
| Material | | | the particles are typically |
| Particle | | | measured by using SEM or |
| | | | TEM or (for large particles) |
| | | | by using optical microscopy. |
| Active | True Density | Argon Gas | True density values may be |
| Material | of Particle | Pycnometer or | measured by using an argon |
| Particle | (e.g., g/cc or | nitrogen gas | gas pycnometer (or a |
| | g/cm³) | pycnometer | nitrogen gas pycnometer) |
| | | | and comparing to the |
| | | | theoretical density of the |
| | | | individual material |
| | | | components present in the |
| | | | particle. |
| Active | Particle Size | Dynamic light | laser particle size |
| Material | Distribution | scattering particle | distribution analysis (LPSA) |
| Particle | (e.g., nm or | size analyzer, | on well-dispersed particle |
| Population | μm) | scanning electron | suspensions in one example |
| | | microscope | or by image analysis of |
| | | | electron microscopy images, |
| | | | or by other suitable |
| | | | techniques. While there are |
| | | | diverse processes of |
| | | | measuring PSDs, laser |
| | | | particle size distribution |
| | | | analysis (LPSA) is quite |
| | | | efficient for some |
| | | | applications. Note that other |
| | | | types of particle size |
| | | | distribution (e.g., by SEM |
| | | | image analysis) could also be |
| | | | utilized (and may even lead |
| | | | to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a |
| | | | fiftieth-percentile volume- |
| | | | weighted particle size |
| | | | parameter (e.g., abbreviated |
| | | | as D₅₀), a ninetieth-percentile |
| | | | volume-weighted particle |
| | | | size parameter (e.g., |
| | | | abbreviated as D₉₀), and a |
| | | | ninety-ninth-percentile |
| | | | volume-weighted particle |
| | | | size parameter (e.g., |
| | | | abbreviated as D₉₉). |
| Active | Width (e.g., | PSA | Parameters relating to |
| Material | nm) | | characteristic widths of the |
| Particle | | | PSD may be derived from |
| Population | | | these particle size |
| | | | parameters, such as D₅₀ − |
| | | | D₁₀ (sometimes referred to |
| | | | herein as a left width), D₉₀ − |
| | | | D₅₀ (sometimes referred to |
| | | | herein as a right width), and |
| | | | D₉₀ − D₁₀ (sometimes |
| | | | referred to herein as a full |
| | | | width). |
| Active | Cumulative | Computed via LPSA | A cumulative volume |
| Material | Volume | data | fraction, defined as a |
| Particle | Fraction | | cumulative volume of the |
| Population | | | composite particles with |
| | | | particle sizes of a threshold |
| | | | particle size or less, divided |
| | | | by a total volume of all of the |
| | | | composite particles, may be |
| | | | estimated by LPSA. |
| Active | Composition | Balance | The mass of active materials |
| Material | (e.g., wt. %) | | added to the electrode |
| Particle | | | divided by the total mass of |
| Population | | | the electrode. |
| Active | BET SSA | BET Isotherm | obtained from the data of |
| Material | (e.g., m²/g) | | nitrogen sorption-desorption |
| Particle | | | at cryogenic temperatures, |
| Population | | | such as about 77K |
| Electrolyte | Salt | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar mass of the salt is then |
| | | | used to calculate the total |
| | | | number of moles of salt in |
| | | | the solution. The moles of |
| | | | salt is then divided by the |
| | | | total volume to obtain the |
| | | | solvent concentration in M |
| | | | (mol/L). |
| Electrolyte | Solvent | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar volume of each solvent |
| | | | is then used to calculate the |
| | | | total number of moles of |
| | | | solvent in the solution. The |
| | | | moles of solvent is then |
| | | | divided by the total volume |
| | | | to obtain the solvent |
| | | | concentration in M (mol/L). |
| Electrode | Composition | Balance | The mass fraction of a |
| | (e.g., mass | | material (e.g., active |
| | fraction or | | material, active material |
| | wt. %) | | particle, binder, etc.) in the |
| | | | electrode is calculated based |
| | | | on a measured or estimated |
| | | | mass of the material and a |
| | | | measured or estimated mass |
| | | | of the electrode, excluding |
| | | | the electrode current |
| | | | collector. |
| | | | Note: |
| | | | The mass of individual |
| | | | components (e.g., composite |
| | | | active material particles, |
| | | | graphite particles, binder, |
| | | | function additive(s), etc.) of |
| | | | the battery electrode |
| | | | composition may be |
| | | | measured before being |
| | | | mixed into a slurry to |
| | | | estimate their mass in a |
| | | | casted electrode. The mass of |
| | | | materials deposited onto the |
| | | | casted electrode may be |
| | | | measured by comparing the |
| | | | weight of the casted |
| | | | electrode before/after the |
| | | | material deposition. |
| Electrode | Areal Binder | balance | A mass fraction of the |
| | Loading (e.g., | | binder in the battery |
| | mg/m²) | | electrode, divided by a |
| | | | product of (1) a mass |
| | | | fraction of the active |
| | | | material (e.g., Si-C |
| | | | nanocomposite, etc.) |
| | | | particles in the battery |
| | | | electrode, and (2) a |
| | | | Brunauer-Emmett-Teller |
| | | | (BET) specific surface area |
| | | | of the active material |
| | | | particle population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on the |
| | | | mass of the active material |
| | | | particles before being mixed |
| | | | in the slurry. This process |
| | | | may be repeated if the |
| | | | electrode includes two or |
| | | | more active materials to |
| | | | calculate the relative |
| | | | capacity attribution for each |
| | | | active material in the |
| | | | electrode. |
| Electrode | Capacity | Potentiostat and | Determine the average |
| | Attributable | balance | specific capacity (mAh/g) of |
| | to Active | | active material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may |
| | | | be repeated if the electrode |
| | | | includes two or more active |
| | | | material particle types to |
| | | | calculate the relative |
| | | | capacity attribution for each |
| | | | active material particle type |
| | | | in the electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed |
| | | | in slurry. |
| Electrode | Mass of Active | balance | Measure the active material |
| | Material | | particle before the active |
| | Particle in | | material particle type is |
| | Electrode | | mixed in the slurry. |
| Electrode | Areal | Potentiostat and | Areal capacity loading is the |
| | Capacity | balance | weight of the coated active |
| | Loading (e.g., | | material per unit area |
| | mAh/cm²) | | (g/cm²) multiplied by the |
| | | | gravimetric capacity of the |
| | | | active material (not the |
| | | | electrode, but the active |
| | | | material itself with zero |
| | | | binder and zero electrolyte; |
| | | | mAh/g). |
| Electrode | Coulombic | Potentiostat | The change in charge |
| | Efficiency | | inserted (or extracted) to an |
| | | | electrode divided by the |
| | | | charge extracted (or |
| | | | inserted) from the electrode |
| | | | during a complete |
| | | | electrochemical cycle within |
| | | | given voltage limits. Because |
| | | | the direction of charge flow |
| | | | is opposite for cathodes and |
| | | | anodes, the definition is |
| | | | dependent on the electrode. |
| | | | Coulombic Efficiency is |
| | | | measured for both materials |
| | | | by constructing a so-called |
| | | | half-cell, which is an |
| | | | electrochemical cell |
| | | | consisting of a cathode or |
| | | | anode material of interest as |
| | | | the working electrode and a |
| | | | lithium metal foil which |
| | | | functions as both the counter |
| | | | and reference electrode. |
| | | | Then, charge is either |
| | | | inserted or removed from |
| | | | the material of interest until |
| | | | the cell voltage reaches an |
| | | | appropriate limit. Then, the |
| | | | process is reversed until a |
| | | | second voltage limit is |
| | | | reached, and the charge |
| | | | passed in both steps is used |
| | | | to calculate the Coulombic |
| | | | Efficiency, as described |
| | | | above. |
| Battery Cell | Rate | Potentiostat | This is the time it takes to |
| | Performance | | charge or discharge a |
| | | | battery between a given state |
| | | | of charge. It is measured by |
| | | | charging or discharging a |
| | | | battery and measuring the |
| | | | time until a specified amount |
| | | | of charge is passed, or until |
| | | | the battery operating voltage |
| | | | reaches a specified value. |
| Battery Cell | Cell | Potentiostat | A battery consisting of a |
| | Discharge | | relevant anode and cathode |
| | Voltage (e.g., | | is charged and discharged |
| | V) | | within certain voltage limits |
| | | | and the charge-weighted cell |
| | | | voltage during discharge is |
| | | | computed. |
| Battery Cell | Operating | Potentiostat and | Average temperature of |
| | Temperature | thermocouples | battery cell as measured at |
| | | | the positive/negative |
| | | | terminal/cell shaft/etc. |
| | | | while charging/discharging, |
| | | | or at a certain voltage level, |
| | | | or while a load is applied, |
| | | | etc. |
| Battery | Anode | Potentiostat | An electrode containing an |
| Half-Cell | Discharge | | active anode material (or a |
| | (de- | | mixture of active materials) |
| | lithiation) | | of interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material (or a |
| | (lithiation) | | mixture of active materials) |
| | Potential | | of interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to lithiation |
| | | | of the cathode) is computed. |
| Battery Cell | Volumetric | Potentiostat | The VED is calculated by |
| | Energy | | first calculating the energy |
| | Density | | per unit area of the battery, |
| | (VED) | | and then dividing the energy |
| | | | per unit area by the sum of |
| | | | the illustrative anode, |
| | | | cathode, separator, and |
| | | | current collector thicknesses |
| Battery Cell | Internal | Potentiostat | The internal resistance (also |
| | Resistance | | known as impedance in |
| | (impedance) | | many contexts) is measured |
| | | | by applying small pulses of |
| | | | current to the battery cell |
| | | | and recording the |
| | | | instantaneous change in cell |
| | | | voltage. |

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and/or other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated intercalation-type cathode materials, partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of the high-capacity silicon-comprising anode active materials (including but not limited to, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including, but not limited to core-shell or hierarchical or nanocomposite particles, etc.).

An aspect is directed to a battery anode and/or a battery anode precursor composition comprising a population of Si-comprising particles (e.g., nanocomposite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur (S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composites (or nanocomposites, if Si and/or C are nanostructures, for example).

In some embodiments, the total mass of O may contribute (on average) from about 0 wt. % to about 10 wt. % of the total mass of the Si-comprising particles (in some designs, from about 0 wt. % to about 1 wt. %; in other designs, from about 1 wt. % to about 2.5 wt. %; in other designs, from about 2.5 wt. % to about 5 wt. %; in other designs, from about 5 wt. % to about 10 wt. %). In some embodiments, the total mass of O may contribute (on average) to less than about 5 wt. % of the total mass of the Si-comprising particles. In some embodiments, the total mass of N may contribute (on average) from about 0 wt. % to about 10 wt. % of the total mass of the Si-comprising particles (in some designs, from about 0 wt. % to about 0.1 wt. %; in other designs, from about 0.1 wt. % to about 2 wt. %; in other designs, from about 2 wt. % to about 5 wt. %; in yet other designs, from about 5 wt. % to about 10 wt. %). In some embodiments, the total mass of P may contribute (on average) from about 0 wt. % to about 10 wt. % of the total mass of the Si-comprising particles (in some designs, from about 0 wt. % to about 0.1 wt. %; in other designs, from about 0.1 wt. % to about 1 wt. %; in other designs, from about 1 wt. % to about 5 wt. %; in yet other designs, from about 5 wt. % to about 10 wt. %). In some embodiments, the total mass of B may contribute (on average) from about 0 wt. % to about 5 wt. % of the total mass of the Si-comprising particles (in some designs, from about 0 wt. % to about 0.1 wt. %; in other designs, from about 0.1 wt. % to about 2.5 wt. %; in yet other designs, from about 2.5 wt. % to about 5 wt. %). In some embodiments, the total mass of H may contribute (on average) from about 0 wt. % to about 2 wt. % of the total mass of the Si-comprising particles (in some designs, from about 0 wt. % to about 0.5 wt. %; in other designs, from about 0.5 wt. % to about 1 wt. %; in yet other designs, from about 1 wt. % to about 2 wt. %). In some embodiments, the total mass of S may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %). In some embodiments, the total mass of F may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %).

In some embodiments, a total atomic fraction of the Si and the C may contribute from about 75 at. % or about 80 at. % to about 100 at. % of the overall composite particles. Such composite particles are sometimes referred to herein as Si—C composites. In some embodiments, such composite particles comprise nano-sized or nanostructured elements (e.g., nano-sized or nanostructured Si, Si nanoparticles, nanoporous Si nanoparticles, nano-sized, nanoporous or nanostructured C, or both), which may be referred to as nanocomposite particles. In some implementations, the Si or Si-comprising active material present in such nanocomposites may be in the form of nanoparticles. In some implementations, the mass-average size of Si or Si-comprising material nanoparticles (e.g., silicon nanoparticles or nanocrystals) may range from about 1 nm to about 200 nm (in some designs, from about 1.0 nm to about 10.0 nm; in other designs, from about 10.0 nm to about 30.0 nm; in yet other designs, from about 30.0 nm to about 100.0 nm; in yet other designs, from about 100.0 nm to about 200.0 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and/or other suitable techniques. In some designs, Si or Si-comprising material nanoparticles (e.g., silicon nanoparticles) may be doped (e.g., in some designs with Group V or Group III elements, such as N, P, B, etc.; or, in other designs, with Group IV elements, such as C, etc.; or their various combinations). The degree of doping may range from about 10 ppm to about 50,000 ppm (e.g., in some designs, from about 10 ppm to about 100 ppm; in other designs, from about 100 ppm to about 1000 ppm; in other designs, from about 1000 ppm to about 10,000 ppm; in yet other designs, from about 10,000 ppm to about 50,000 ppm), in some designs. X-ray diffraction may be particularly convenient and easy for identifying the average size of Si nanocrystals. Too small (e.g., smaller than about 1.0 nm in some designs or, e.g., about 2 nm in other designs) Si nanocrystals may exhibit too high reactivity during synthesis and become less active or induce too high first cycle capacity losses, while too large (e.g., larger than about 200 nm in some designs or, e.g., about 100 nm in other designs) Si crystals may reduce cycle stability of such Si—C composites (nanocomposites) or, broadly, nanocomposite silicon. As used here, a “nano”-material (e.g., nanostructure or nanoparticle or nanocomposite, etc.) may refer to any material that exhibits at least one dimension that is less than about 200 nm.

An aspect is directed to a battery anode and/or a battery anode precursor composition comprising a population of Si-comprising composite particles (e.g., nanocomposite particles, among others), in which each of the Si-comprising composite particles comprises Si and C, and the Si-comprising composite particles have certain characteristics. In some embodiments, a mass fraction of the silicon in the Si-comprising composite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 to about 70 wt. %; in yet other designs, from about 70 wt. % to about 80 wt. %; in yet other designs, from about 20 wt. % to about 80 wt. %; in yet other designs, from about 35 wt. % to about 60 wt. %). In some embodiments, a Brunauer-Emmett-Teller (BET) specific surface area (SSA) of the Si-comprising composite particles (e.g., nanocomposite particles, among others) is in a range of about 0.5 m²/g to about 150 m²/g (in some designs, from about 0.5 to about 3 m²/g; in other designs, from about 3 m²/g to about 12 m²/g; in yet other designs, from about 12 m²/g to about 18 m²/g; in yet other designs, from about 18 m²/g to about 30 m²/g; in other designs, from about 30 m²/g to about 50 m²/g; in yet other designs, from about 50 m²/g to about 150 m²/g). In some embodiments, about 90% or more of the Si-comprising composite particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery electrode and/or a battery electrode precursor composition comprising a population of Si-comprising active material particles (e.g., nanocomposite particles, among others), in which the particle population of may be characterized by a particle size distribution (PSD) as determined by laser particle size distribution analysis (LPSA), image analysis of electron microscopy images, or other suitable techniques. The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀−D₁₀ (sometimes referred to herein as a left width), D₉₀−D₅₀ (sometimes referred to herein as a right width), and D₉₀−D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising active material particles may advantageously be in a range of about 0.5 μm to about 25.0 μm, or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm. A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 0.5 μm to about 4.0 μm), the cumulative volume fraction, with the threshold particle size at about 5 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at about 7 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 6.0 μm to about 8.0 μm), the cumulative volume fraction, with the threshold particle size at about 10 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 8.0 μm to about 16.0 μm), the cumulative volume fraction, with the threshold particle size at about 20 μm, may advantageously be about 99 vol. % or less, or about 95 vol. % or less, or about 90 vol. % or less, or about 85 vol. % or less, or about 80 vol. % or less. In yet other embodiments (e.g., when the D₅₀ is in a range from about 16.0 μm to about 25.0 μm), the cumulative volume fraction, with the threshold particle size at about 30 μm, may advantageously be about 99 vol. % or less, or about 95 vol. % or less, or about 90 vol. % or less, or about 85 vol. % or less, or about 80 vol. % or less. In some embodiments, D₅₀ in a range from about 7.0 μm to about 13.0 μm may be particularly advantageous. In such embodiments, the cumulative volume fraction, with the threshold particle size at about 20 μm, may advantageously be about 99 vol. % or less, or about 95 vol. % or less, or about 90 vol. % or less, or about 85 vol. % or less, or about 80 vol. % or less.

Note that in some designs the presence of excessively large Si-comprising active material particles (e.g., in the form of nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at about 10 μm, may advantageously be about 80 vol. % or more, or about 85 vol. % or more, or (in some designs) even about 90 vol. % or more. In some embodiments (e.g., when the D₅₀ is in a range from about 0.5 μm to about 4.0 μm), the cumulative volume fraction, with the threshold particle size at about 12 μm, may advantageously be about 90 vol. % or more, or about 95 vol. % or more, or (in some designs) even about 98 vol. % or more. In other embodiments (e.g., when the D₅₀ is in a range from about 4.0 μm to about 6.0 μm), the cumulative volume fraction, with the threshold particle size at about 15 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 25 μm, may advantageously be about 90 vol. % or more, or about 95 vol. % or more, or (in some designs) even about 98 vol. % or more. In other embodiments (e.g., when the D₅₀ is in a range from about 6.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 6.0 μm to about 8.0 μm or from about 8.0 μm to about 12.0 μm), the cumulative volume fraction, with the threshold particle size at about 22 μm or about 25 μm, may advantageously be about 80 vol. % or more, or about 85 vol. % or more about 90 vol. % or more, or about 95 vol. % or more, or (in some designs) even about 98 vol. % or more. In other embodiments (e.g., when the D₅₀ is in a range from about 8.0 μm to about 16.0 μm or from about 12.0 μm to about 16.0 μm), the cumulative volume fraction, with the threshold particle size at about 30 μm or about 40 μm, may advantageously be about 80 vol. % or more, or about 85 vol. % or more, or (in some designs) even about 90 vol. % or more. In other embodiments (e.g., when the D₅₀ is in a range from about 8.0 μm to about 16.0 μm), the cumulative volume fraction, with the threshold particle size at about 50 μm, may advantageously be about 90 vol. % or more, or about 95 vol. % or more, or (in some designs) even about 98 vol. % or more. In other embodiments (e.g., when the D₅₀ is in a range from about 7.0 μm to about 13.0 μm), the cumulative volume fraction, with the threshold particle size at about 30 μm, may advantageously be about 90 vol. % or more, or about 95 vol. % or more, or (in some designs) even about 98 vol. % or more. In other embodiments (e.g., when the D₅₀ is in a range from about 7.0 μm to about 13.0 μm), the cumulative volume fraction, with the threshold particle size at about 40 μm, may advantageously be about 90 vol. % or more, or about 95 vol. % or more, or (in some designs) even about 98 vol. % or more.

In one or more embodiments of the present disclosure, Si-comprising active material particles (e.g., Si-comprising active material composite particles) may exhibit true density (e.g., as measured by using nitrogen gas pycnometer, hence in this case sometimes referred to as pycnometer-measured density or pycnometer density or pyc density) in the range from about 1.1 g/cc to about 2.8 g/cc (in some designs, from about 1.1 g/cc to about 1.5 g/cc; in other designs, from about 1.5 g/cc to about 1.8 g/cc; in other designs, from about 1.8 g/cc to about 2.1 g/cc; in other designs, from about 2.1 g/cc to about 2.4 g/cc; in yet other designs, from about 2.4 g/cc to about 2.8 g/cc).

In one or more embodiments of the present disclosure, Si-comprising active material particles (e.g., Si-comprising active material composite particles) may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming theoretical density of the individual material components present in Si-comprising active material particles)—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising active material particles) may range from about 0.00 cc/g to about 1.00 cc/g—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g; in other designs, from about 0.50 cc/g to about 0.60 cc/g; in other designs, from about 0.60 cc/g to about 0.70 cc/g; in other designs, from about 0.70 cc/g to about 0.80 cc/g; in other designs, from about 0.80 cc/g to about 0.90 cc/g; in other designs, from about 0.90 cc/g to about 1.00 cc/g). In some designs, the volume-average size of the open (e.g., to nitrogen gas at 77K) pores may range from about 0.5 nm to about 100 nm—in some designs, from about 0.5 nm to about 5 nm; in other designs, from about 5 nm to about 20 nm; in other designs, from about 20 nm to about 50 nm; in yet other designs, from about 50 nm to about 100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm—in some designs, from about 0.5 nm to about 5 nm; in other designs, from about 5 nm to about 20 nm; in other designs, from about 20 nm to about 50 nm; in other designs, from about 50 nm to about 100 nm; in yet other designs, from about 100 nm to about 200 nm.

In one or more embodiments of the present disclosure, Si-comprising active material particles (e.g., Si-comprising active material composite particles) may exhibit moderate (e.g., about 7-120 vol. %) or high (e.g., about 120-250 vol. %) volume changes during initial lithiation (e.g., down to around 0.01 V vs. Li/Li). In some designs, Si-comprising active material particles may exhibit volume changes in the range from about 8 vol. % to about 180 vol. % during one or more charge-discharge cycles of the battery cell. In one or more embodiments of the present disclosure, Si-comprising active material particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation.

In one or more embodiments of the present disclosure, a preferred anode for a battery cell may comprise a mixture of Si-comprising active material particles (e.g., nanocomposite Si—C particles, nanocomposite Si particles, among others) and graphite active material particles (or, more broadly, carbon active material particles) as the anode active material particles, i.e., a so-called blended anode. In addition to the anode active material particles, an anode may comprise inactive material (separate from any inactive material that is an integral part of the Si-comprising active material composite particles), such as binder(s) (e.g., polymer binder) and/or other functional additives (e.g., surfactants, electrically conductive additives, etc.). In some implementations, the anode active material particles (e.g., Si-comprising active material composite particles, carbon or Gr anode particles in case of a blended anode, etc.) may be in a range of about 85 wt. % to about 98 wt. % of the total weight of the anode (not counting the weight of the current collector)—in some designs, from about 85 wt. % to about 89 wt. %; from about 89 wt. % to about 91 wt. %; from about 91 wt. % to about 93 wt. %; from about 93 wt. % to about 95 wt. %; or from about 95 wt. % to about 98 wt. %. Too low or too high % anodes may result in the undesirable performance deterioration.

In some implementations, blended anodes may comprise Si-comprising active material particles (e.g., Si—C nanocomposite particles, among others) ranging from about 7 wt. % to about 98 wt. % of all the anode active material particles and the graphite (e.g., particles) making up the remainder of the mass (the weight) of the anode active material particles (from about 2 wt. % to about 93 wt. %). In some designs, the Si-comprising active material particles (e.g., Si—C nanocomposite particles, etc.) comprise from about 7 wt. % to about 15 wt. % of the blended anode active material particles; in other designs—from about 15 wt. % to about 25 wt. % of the blended anode active material particles; in other designs—from about 25 wt. % to about 40 wt. % of the blended anode active material particles; in other designs—from about 40 wt. % to about 60 wt. % of the blended anode active material particles; in other designs—from about 60 wt. % to about 80 wt. % of the blended anode active material particles; in yet other designs—from about 80 wt. % to about 98 wt. % of the blended anode active material particles.

While the descriptions below may also describe certain examples of the blended anode formulations expressed as mass (wt. %) of Si-comprising active material particles (e.g., Si—C nanocomposite particles, among others) among the anode active materials or as mass (wt. %) of Si-comprising active material particles (e.g., Si—C nanocomposite particles, etc.) in the total anode (not counting the weight of the current collector), it will be appreciated that various aspects of this disclosure may be applicable to blended anode formulations expressed as wt. % of Si in the anode (counting the weight of all the active material particles, binder, conductive and/or other additives, but not counting the weight of the current collector). In some implementations, a blended anode composition of about 7 wt. % of Si-comprising active material particles (e.g., Si—C nanocomposite particles, among others) (relative to the total weight of all the active materials in the anode, binder(s), conductive and/or other additive(s), but not counting the weight of the current collector) may correspond, for example, to about 3 wt. % of Si in the blended anode. In some implementations, a blended anode composition of about 19 wt. % of Si-comprising active material particles (e.g., Si—C nanocomposite particles, among others) may correspond, for example, to about 8 wt. % of Si in the blended anode. In some implementations, a blended anode composition of about 35 wt. % of Si-comprising active material particles (e.g., Si—C nanocomposite particles, among others) may correspond, for example, about 15 wt. % of Si in the blended anode. In some implementations, a blended anode composition of about 50 wt. % of Si-comprising active material particles (e.g., Si—C nanocomposite particles, among others) may correspond, for example, to about 21 wt. % of Si in the blended anode. In some implementations, a blended anode composition of about 70 wt. % of Si-comprising active material particles (e.g., Si—C nanocomposite particles, among others) may correspond, for example, to about 30 wt. % of Si in the blended anode. In some implementations, a blended anode composition of about 90 wt. % of Si-comprising active material particles (e.g., Si—C nanocomposite particles, among others) may correspond, for example, to about 38 wt. % of Si in the blended anode. The wt. % of Si in the anode depends on the wt. % of Si in the Si-comprising active material particles, the wt. % of the binder and conductive additives and the wt. % of the graphite in the blended anode. Smaller fractions of inactive materials (e.g., binder and conductive or other additives), higher fraction of Si in the Si-comprising anode material particles (e.g., Si—C composite particles) and smaller fraction of graphite in the blended anode result in higher wt. % Si in the anode. For example, in some implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 30 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 40 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 50 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 60 wt. % of Si in the blended anode. In respective implementations, blended anodes may be obtained in which the mass (weight) of the silicon is in a range of about 3 wt. % to about 60 wt. % of a total mass of the anode (not counting the weight of the current collector).

While the descriptions below may also describe certain examples of the blended anode formulations expressed as mass (wt. %) of Si-comprising active material particles (e.g., Si—C nanocomposite particles, etc.) in the active material blends, it will be appreciated that various aspects of this disclosure may be applicable to blended anode formulations attributing a fraction (e.g., %) of the total capacity of the blended anode to the capacity of the Si-comprising active material particles. In some implementations, for example, about 25% of the total capacity of the blended anode may be obtained from the Si-comprising active material particles (e.g., Si—C nanocomposite particles, etc.) in a blended anode composition of about 5-8 wt. % of Si-comprising active material particles (e.g., Si—C nanocomposite particles, etc.) relative to the total weight of active material particles (both Si-comprising and graphite active material particles). In some other implementations, as another example, about 50% of the total capacity of the blended anode may be obtained from the Si-comprising active material particles (e.g., Si—C nanocomposite particles, etc.) in a blended anode composition of about 15-21 wt. % of Si-comprising active material particles (e.g., Si—C nanocomposite particles, etc.). In some other implementations, about 70% of the total capacity of the blended anode may be obtained from the Si-comprising active material particles (e.g., Si—C nanocomposite particles, etc.) in a blended anode composition of about 30-40 wt. % of Si-comprising active material particles (e.g., Si—C nanocomposite particles, etc.). In some other implementations, about 80% of the total capacity of the blended anode may be obtained from the Si-comprising active material particles (e.g., Si—C nanocomposite particles, etc.) in a blended anode composition of about 45-55 wt. % of active material Si-comprising active material particles (e.g., Si—C nanocomposite particles, etc.). In some other implementations, about 92% of the total capacity of the blended anode may be obtained from the Si-comprising active material particles (e.g., Si—C nanocomposite particles, etc.) in a blended anode composition of about 65-75 wt. % of Si-comprising active material particles (e.g., Si—C nanocomposite particles, etc.). In some other implementations, about 95% of the total capacity of the blended anode may be obtained from the Si-comprising active material particles (e.g., Si—C nanocomposite particles, etc.) in a blended anode composition of about 75-85 wt. % of Si-comprising active material particles (e.g., Si—C nanocomposite particles, etc.). In some other implementations, about 98% of the total capacity of the blended anode may be obtained from the Si-comprising active material particles (e.g., Si—C nanocomposite particles, etc.) in a blended anode composition of about 85-95 wt. % of Si-comprising active material particles (e.g., Si—C nanocomposite particles, etc.). Note that the exact % capacity provided by the Si-comprising active material particles in the blended anode having a specific wt. % of the Si-comprising active material particles depends on the specific capacity of the plurality of the Si-comprising active material particles and the specific capacity of the plurality of graphite (or, broadly, carbon) active material particles.

In some embodiments, the battery anode composition may advantageously comprise one, two or more carbon-comprising functional additives (e.g., additives that enhance electrical conductivity or rate performance of mechanical properties of the electrode). In some embodiments, the carbon-comprising functional additive(s) is (are) selected from: carbon nanotubes (CNTs) (e.g., single walled carbon nanotubes (SWCNTs), double walled carbon nanotubes (DWCNTs), multi-walled carbon nanotubes (MWCNTs)), carbon nanofibers, carbon black, graphite, graphite ribbons, exfoliated graphite (e.g., exfoliated graphite flakes), graphene oxide (e.g., graphite oxide flakes) and graphene (e.g., flakes) (including, but not limited to, e.g., single-layered and/or multi-layered graphene or graphene oxide). In some embodiments, carbon additives may be purified, defective, curved and/or comprise chemical functional groups. In some embodiments, the battery electrode composition may comprise one or more binders (in some designs, two or more binder components).

An aspect is directed to a battery anode. In some embodiments, the battery anode comprises any of the foregoing battery anode electrode compositions, disposed on and/or in a current collector (e.g., Cu-based or Cu-containing current collector, such as a dense or porous foil or a mesh or a foam or a nanowire-comprising or nanoflake-comprising current collector, Cu-coated polymer substrate, etc.). In some designs, the total current collector thickness may preferably range from about 4 micron to about 14 micron (e.g., about 4-6; about 6-8; about 8-10; about 10-12; about 12-14 micron). Thinner foils (or, broadly, foils with low areal density) may be particularly preferably in weight sensitive applications. The preferable areal density may range from about 2 mg/cm² (e.g., in case of porous or polymer-coated current collectors) to about 13 mg/cm² (e.g., about 2-4; about 4-6; about 6-8; about 8-10; about 10-13 mg/cm²) (e.g., in case of solid or thicker porous or polymer-coated with thick metal layer current collectors).

In some embodiments, the battery anode comprises a battery electrode composition and a binder. In some embodiments, a coating density of the battery electrode is in a range of about 0.8 to about 1.7 g/cm³ (in some designs, about 0.8 to about 0.9 g/cm³; from about 0.9 to about 1.0 g/cm³; from about 1.0 to about 1.2 g/cm³; from about 1.2 to about 1.4 g/cm³, from about 1.4 to about 1.7 g/cm³). Higher fraction of suitable graphite material in a blended anode may benefit from higher anode density for better performance (e.g., better stability, better rate performance, higher volumetric capacity, lower swell during cycling, etc.), although excessive density may also be detrimental for the same or other characteristics. As such, a detailed optimization may be conducted for a particular battery design, with respect to factors such as electrode thickness, areal capacity loading, battery cycling environment and regime, among other factors.

An aspect is also directed to a blended battery anode, wherein both the Si-comprising anode active material particles (e.g., nanocomposite Si—C particles, among others) and graphite (or, broadly, carbon-based) active anode material may be present. The anode may preferably comprise a binder amount optimized for the properties of both the Si-comprising active material particles and the graphite particles. For example, the anode may be characterized by an areal binder loading, defined as a mass of the binder in the battery anode (e.g., measured in mg) normalized by the surface area of the active material particles (e.g., Si-comprising (e.g., nanocomposite, etc.) anode active material particles and (if present) graphite active material particles in the same battery anode (e.g., measured in m² and defined by the mass of active material particles (in g) multiplied by the Brunauer-Emmett-Teller (BET) specific surface area (SSA) in m²/g). Since a BET-SSA of both the Si-comprising active material particle population and the graphite active material particle population may vary from slurry to slurry, the binder loading may preferably be adjusted based on the desired areal binder loading. Higher BET-SSA of the active anode materials (measured in m²/g) may require a higher mass fraction of the binder in the anode electrode. For example, an anode electrode comprising an active material particle population (e.g., Si-comprising (e.g., nanocomposite, etc.) active anode material particle population or a blend of Si-comprising active material(s) particle(s) and graphite active material(s) particle(s)) with BET-SSA of about 10 m²/g may require from about 20 mg to about 150 mg of binder per about 1 g of active material particles (approximately 2-13 wt. % relative to the total weight of the binder and the active material composition, not counting the weight of conductive or other additives or the weight of the current collector), while another anode electrode comprising another active material particle population (e.g., Si-comprising (e.g., nanocomposite, etc.) anode active material particle population or a blend of Si-comprising active material(s) particle(s) and graphite active material(s) particle(s)) with BET-SSA of only about 1 m²/g may require from about 2 mg to about 40 mg of the binder per about 1 g of active material particles (approximately 0.2-4 wt. % relative to the total weight of the binder+active material composition, not counting the weight of conductive or other additives or the weight of the current collector). However, in some designs, an areal binder loading of the battery anode in both cases is in a range from about 2.0 mg/m² to about 40.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²). In some designs, a higher fraction of Si-comprising (e.g., nanocomposite, etc.) anode active material particle population in the anode (relative to the total weight of all active materials) may preferably exhibit a higher areal binder loading. In some designs, a larger average particle size of Si-comprising (e.g., nanocomposite, etc.) anode active material particle population in the anode may preferably require a slightly smaller areal binder loading. In some designs, a larger BET-SSA of Si-comprising (e.g., nanocomposite, etc.) anode active material particle population in the anode may preferably exhibit a slightly higher areal binder loading. In some designs, the areal binder loading may also depend on the binder composition and properties (e.g., adhesion, chemical composition, hardness, elastic modulus when exposed to electrolyte, maximum elongation at break, among others). So, in some designs, the optimal areal binder loading content within a range of about 2.0 mg/m² to about 40.0 mg/m² depends on the anode composition. For example, the optimal areal binder loading content in some designs may range from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²).

While the description below may describe certain examples of suitable intercalation-type graphites to be used in combination with Si-comprising (e.g., Si—C nanocomposites, etc.) active material particles in a blend, it will be appreciated that various aspects of this disclosure may be applicable to various soft-type synthetic graphite (or soft carbon, broadly), various hard-type synthetic graphite (or hard carbon, broadly), and various natural graphite (which may, for example, be pitch carbon coated, among others); including but not limited to those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g); including but not limited to those which exhibit low, moderate and high swelling; including but not limited to those which exhibit good and poor compression, including but not limited to those which exhibit BET-SSA of about 0.5 to about 40 m²/g (e.g., in some designs, from about 0.5 to about 2 m²/g; or in other designs, from about 2 to about 4 m²/g; or in other designs, from about 4 to about 6 m²/g; or in other designs, from about 6 to about 8 m²/g; or in other designs, from about 8 to about 10 m²/g; or in other designs, from about 10 to about 14 m²/g; or in other designs, from about 14 to about 20 m²/g; or in other designs, from about 20 to about 40 m²/g); including but not limited to those which exhibit lithiation efficiency of about 85-90% and more; including but not limited to those which exhibit true densities ranging from about 1.5 g/cm³ to about 2.3 g/cm³ (e.g., in some designs, from about 1.5 to about 1.8 g/cm³, in other designs, from about 1.8 to about 2.3 g/cm³); including but not limited to those which exhibit poor, moderate, or good cycle life when used in Li-ion battery anodes on their own (e.g., without Si-comprising or other active material particles); including but not limited to those which are coated and comprise coatings with coating thickness to appreciably improve compression and springing during cycling.

An aspect is also directed to a Li-ion battery comprising: (i) a suitable blended battery anode (wherein both the Si-comprising anode active material particles (e.g., nanocomposite Si—C particles, among others) and suitable graphite (or, broadly, carbon-based) active anode material (e.g., graphite active material particles) are present in the anode) and (ii) a suitable battery cathode, wherein the suitable cathode may comprise, in some designs: (iia) intercalation-type cathode or (iib) conversion-type cathode (which may include a displacement-type cathode, a chemical transformation type cathode or a true conversion-type cathode) or (iic) a mixed intercalation/conversion type cathode. Illustrative examples of suitable intercalation-type cathodes to be used in preferable cells may include, but are not limited to, e.g.: lithium nickel cobalt aluminum oxides (NCA), lithium nickel cobalt manganese aluminum oxides (NCMA), lithium nickel oxides (LNO), lithium manganese oxides (LMO) (including, but not limited to high voltage spinels), lithium nickel manganese oxides (LMNO) (including, but not limited to high voltage spinels), lithium nickel manganese cobalt oxides (NCM) or NCM-like layered oxide cathodes (including those with no cobalt and having a range of nickel content), lithium manganese rich oxides (LMR), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂ and many others), various high capacity Li-ion based materials with partial substitution of oxygen for fluorine or iodine (e.g., rocksalt Li₂Mn_{2/3}Nb_{1/3}O₂F, Li₂Mn_{1/2}Ti_{1/2}O₂F, Li_{1.5}Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and/or other lithium transition metal (TM) oxides or phosphates or sulfates (or mixed) cathode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.). It will also be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge). Illustrative examples of suitable conversion-type cathodes to be used in preferable cells may include, but are not limited to: metal fluorides, metal oxy-fluorides, metal chlorides, metal sulfides, metal selenides, their various mixtures, composites and/or others. Illustrative examples of metal fluorides, in a Li-free state, include, but are not limited to FeF₃, FeF₂, MnF₃, CuF₂, NiF₂, BiF₃, BiF₅, SnF₂, SnF₄, SbF₃, SbF₅, CdF₂, ZnF₂, TiF₃, TiF₄, AgF, AgF₂, their various mixtures, alloys and combinations, among others. In some designs, it may be advantageous to produce nanocomposites and/or core-shell structures comprising metal fluorides to enhance their performance and stability. In some designs, it may be advantageous to dope metal fluorides with oxygen or utilize metal oxy-fluorides. In a fully lithiated state, pure metal fluorides convert to a composite comprising a mixture of metal and LiF clusters (or nanoparticles). Examples of the overall reversible reactions of the conversion-type metal fluoride cathodes may include 2Li+CuF₂↔2LiF+Cu for CuF₂-based cathodes or 3Li+FeF₃↔3LiF+Fe for FeF₃-based cathodes. It will be appreciated that metal fluoride-based cathodes may be prepared in Li-free or partially lithiated or fully lithiated states. In addition to fluorides, other illustrative examples of conversion-type active electrode materials may include, but are not limited to, various metal oxy-fluorides, sulfo-fluorides, chloro-fluorides, oxy-chloro-fluorides, oxy-sulfo-fluorides, fluoro-phosphates, sulfo-phosphates, sulfo-fluoro-phosphates, mixtures of metals (e.g., Fe, Cu, Ni, Co, Bi, Cr, Zn, Ti, other metals, their various mixtures and alloys, partially oxidized metals and metal alloys, etc.) and salts (metal fluorides (including LiF or NaF), metal chlorides (including LiCl or NaF), metal oxy-fluorides, metal oxides, metal sulfo-fluorides, metal fluoro-phosphates, metal sulfides, metal oxy-sulfo-fluorides, their various combinations, etc.), and/or other salts that comprise halogen or sulfur or oxygen or phosphorous or a combination of these elements, among others. In some designs, F in metal fluorides may be fully or partially replaced with another halogen (e.g., Cl or Br or I, etc.) or their mixtures to form the corresponding metal chlorides or metal fluoride-chlorides and/or other metal halide compositions. Yet another example of a promising and suitable conversion-type cathode active material is sulfur (S) (in a Li-free state) or lithium sulfide (Li₂S, in a fully lithiated state). In some designs, selenium (Se) may also be used together with S or on its own for the formation of such cathode active materials. In some designs, it may be advantageous to produce nanocomposites and/or core-shell structures comprising S, Li₂S, Se, Li₂Se or their various mixtures and combinations to enhance their performance and stability. In some designs, conversion-type active cathode materials may also advantageously comprise metal oxides or mixed metal oxides. In some designs, such (nano)composites may advantageously comprise metal sulfides or mixed metal sulfides. In some examples, mixed metal oxides or mixed metal sulfides may comprise lithium. In some examples, mixed metal oxides may comprise titanium or vanadium or manganese or iron metal. In some examples, lithium-comprising metal oxides or metal sulfides may exhibit a layered structure. In some examples, metal oxides or mixed metal oxides or metal sulfides or mixed metal sulfides may advantageously be both ionically and electrically conductive (e.g., in the range from around 10⁻⁷ to around 10⁺⁴ S/cm). In some examples, various other intercalation-type active materials may be utilized instead of or in addition to metal oxides or metal sulfides. In some designs, such an intercalation-type active material exhibits charge storage (e.g., Li insertion/extraction capacity) in the potential range close to that of S or Li₂S (e.g., within around 1.5-3.8 V vs. Li/Li). In some designs, the use of so-called Li-air cathodes (e.g., cathodes with active material in the form of Li₂O₂, Li₂O, LiOH in their lithiation state) or similar metal-air cathodes based on Na, K, Ca, Al, Fe, Mn, Zn and/or other metals (instead of Li) may similarly be beneficial due to their very high capacities. In some designs, such cathode active materials should ideally reversibly react with oxygen or oxygen containing species in the electrochemical cell and may fully disappear upon full de-lithiation (metal removal). Cathode active materials that exhibit such characteristics may also be considered to belong to conversion-type cathodes.

In some of the preferred examples a surface of cathode active materials (e.g., intercalation-type cathode materials, such as LCO, NCM, LMR, NCMA, NCA, LMO, LMNO, LFP, LMP, LMFP, etc. or conversion-type active materials comprising S, Li₂S, metal sulfides, metal fluorides, etc.) may be coated with a layer of ceramic material. Illustrative examples of a preferred coating material for such cathodes include, but are not limited to, titanium oxide (e.g., TiO₂), tantalum oxide (Ta₂O₅), aluminum oxide (e.g., Al₂O₃), tungsten oxide (e.g., WO), chromium oxide (e.g., Cr₂O₃), niobium oxide (e.g., NbO or NbO₂) and zirconium oxide (e.g., ZrO₂), lithium phosphate (e.g., Li₃PO₄), lithium oxy-thiophosphate (e.g., Li₃P₁₊ₓO₄S_{4X}), and their various mixtures, alloys, and combinations. In some designs, such ceramic materials may additionally comprise lithium (Li)—e.g., as lithium phosphate, lithium oxy-thiophosphate, lithium titanium oxide, lithium tantalum oxide, lithium aluminum oxide, lithium tungsten oxide, lithium chromium oxide, lithium niobium oxide, lithium zirconium oxide and their various alloys, mixtures and combinations. In other preferred examples, LCO, NCM, NCMA, NCA, LFP, LMFP, LMP, LMO or LMNO may be doped with Al, Ti, Mg, Nb, Zr, Cr, Hf, Ta, W, Mo or La. In some designs, a preferred cathode current collector material is aluminum or aluminum alloy. In some designs, a preferred battery cell includes a polymer separator. In some of the preferred examples, a polymer separator is made of or comprises polyethylene, polypropylene or a mixture thereof. In some of the preferred examples, a surface of a polymer separator is coated with a layer of ceramic material. Examples of a preferred coating material for polymer separators may include, but not limited to, titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. In some designs, a preferred battery cell includes a ceramic-based or ceramic-comprising (e.g., ceramic/polymer composite) separator. The ceramic or ceramic component of such a ceramic or ceramic-comprising separator may comprise titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. The ceramic or ceramic component of such a ceramic or ceramic-comprising separator may comprise ceramic particles (e.g., elongated particles, nanofibers, flake-shaped particles, randomly shaped particles including nanoparticles, etc.) in some designs.

An aspect is directed to a Li-ion battery with a blended anode (e.g., comprising Si-comprising active material and graphite active material, etc.) that exhibits a relatively high areal capacity loading and properly matched (by areal capacity) cathode (e.g., with a slightly smaller areal capacity loading, selected according to the desired negative (N) to positive (P) ratio, N/P in the range of around 1:01 to around 1:35—in some designs, from around 1.01 to around 1.05; in other designs, from around 1.05 to around 1.10; in other designs, from around 1.10 to around 1.15; in other designs from around 1.15 to around 1.20; in other designs from around 1.20 to around 1.25; in yet other designs, from around 1.25 to around 1.35; wherein the N/P ratio corresponds to the ratio of the reversible areal capacities of the anode to cathode). Note that in some designs both the performance characteristics and cycle stability of Li-ion battery cells comprising some of such blended anodes (particularly for blended anodes with high fractions of Si or high fractions of Si-comprising active material particles—e.g., for the blended anodes with about 3-60 wt. % Si; in some designs, with about 3-10 wt. % Si or about 10-20 wt. % Si or about 20-40 wt. % Si or about 40-60 wt. % Si, or for blended anodes with the Si-comprising active material particles (e.g., Si—C nanocomposite particles, among others) contributing to about 20-100% of the total blended anode capacity; in some designs, with about 20-50% or about 50-70% or about 70-80% or about 80-90% or about 90-95% or about 95-99% or about 99-100% of the total blended anode capacity) may become particularly unsatisfactory for applications requiring long calendar life or long cycle life or low first cycle losses or other properties, if the electrode areal capacity loading exceeds around 1-2 mAh/cm², even more if the electrode areal capacity exceeds around 4-5 mAh/cm², and further more if the electrode areal capacity exceeds around 6-8 mAh/cm². Higher loading, however, is advantageous for reducing cost of energy storage devices and increasing their energy density. One or more embodiments of the present disclosure are directed to synthesis processes, compositions and various physical and chemical properties of graphite(s) and or binder(s) in such blended anodes that provide satisfactory performance for electrode area loadings in the range from around 2 mAh/cm² to around 5 mAh/cm² and more so for loadings in the range from around 5 mAh/cm² to around 8 mAh/cm² and even more so for loadings in the range from around 8 mAh/cm² to around 16 mAh/cm² (e.g., in some designs, an areal capacity loading of an electrode composition may range from around 2 mAh/cm² to around 16 mAh/cm²).

An aspect is directed to a Li-ion battery with a blended anode (e.g., comprising Si-comprising (e.g., composite) active material particles and graphite active material particles, etc.) that exhibits high energy. In some designs, degradation of Li-ion cells with blended anodes not comprising suitable graphite(s) or binder(s) may become particularly undesirably fast for multi-layered (e.g., stacked or rolled) medium sized cells (e.g., cells with cell capacity in the range from 0.2 Ah to around 10 Ah), even more so for large cells (e.g., cells with cell capacity in the range from around 10 Ah to around 40 Ah), even more so for ultra-large cells (e.g., cells with cell capacity in the range from around 40 Ah to around 400 Ah) or gigantic cells (e.g., cells with cell capacity in the range from around 400 Ah to around 4,000 Ah or even more), particularly if the blended anodes comprise moderate-to-relatively high mass fraction of Si (e.g., about 3-60 wt. %; in some designs, about 3-10 wt. % or about 10-20 wt. % or about 20-40 wt. % or about 40-60 wt. %) or if the Si-comprising active material particles (e.g., Si—C nanocomposite particles, among others) contribute to a moderate or a relatively high fraction of the total anode capacity (e.g., about 20-100%; in some designs, about 20-50% or about 50-70% or about 70-80% or about 80-90% or about 90-95% or about 95-99% or about 99-100%). However, multi-layered medium or large size cells may be attractive for some electronic devices and multi-layered large, ultra-large or gigantic cells may be particularly attractive for use in some electric transportation or grid storage applications. One or more aspects of the present disclosure facilitates the use of proper graphite(s) (or, more broadly carbon(s)) in the blended anodes with suitable microstructural, chemical, physical and/or other properties, and proper binder(s) to mitigate or overcome some or all of such limitations of blended anodes and substantially enhance performance of such Li-ion cells.

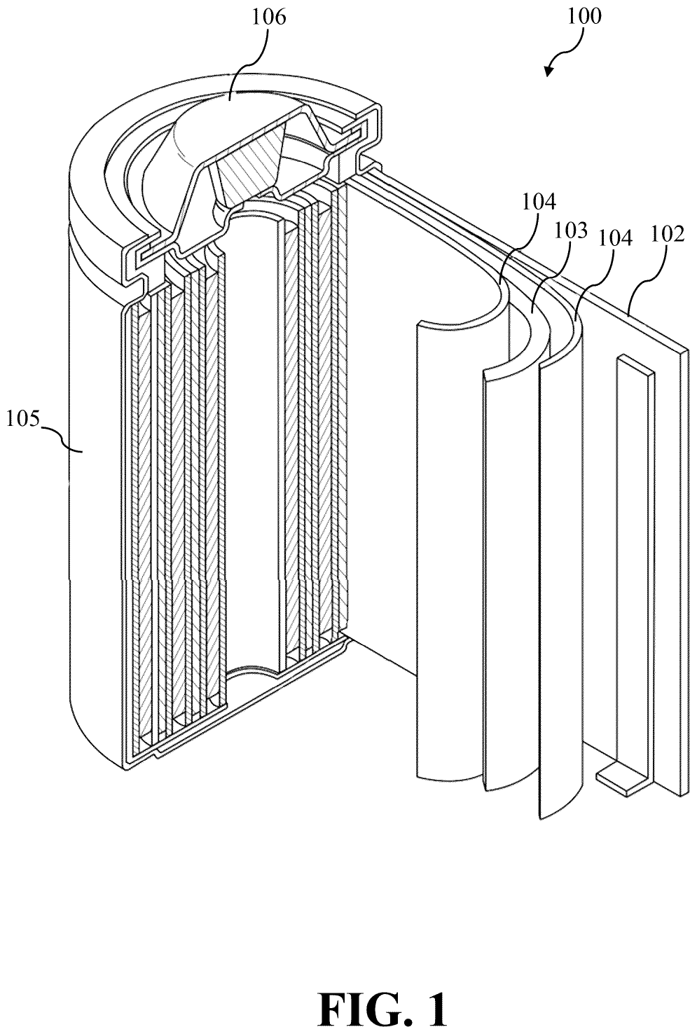

FIG. 1 illustrates an example metal-ion (e.g., Li-ion) battery in which the electrode particles, components, materials, processes, and/or other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector.

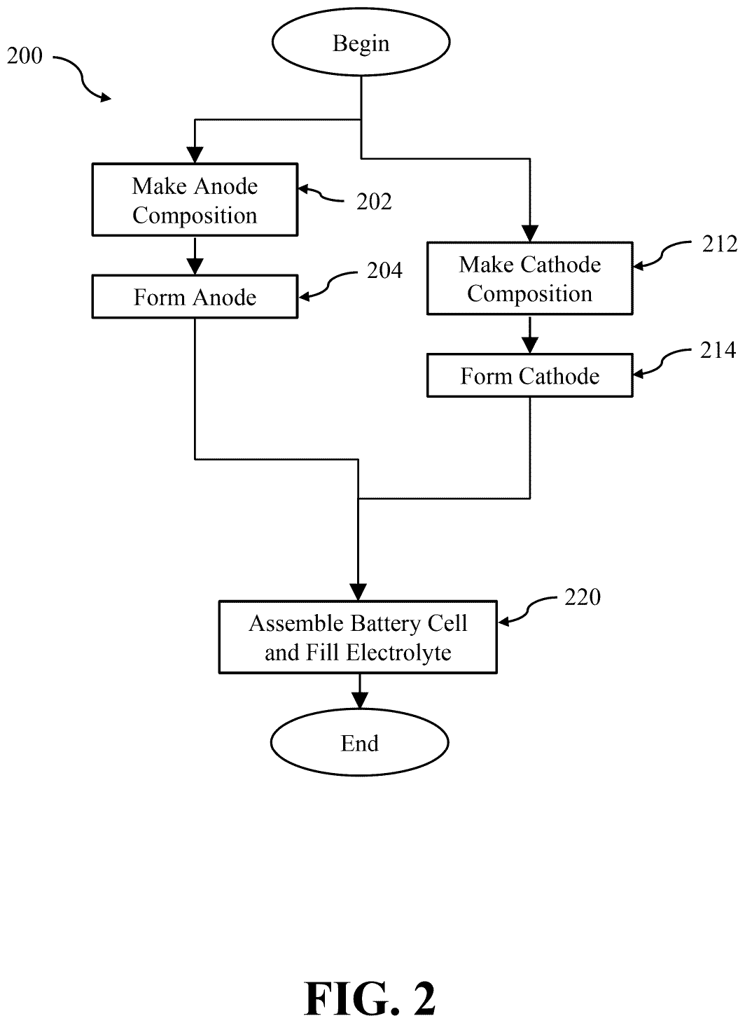

FIG. 2 is a flow diagram of a process 200 of making a Li-ion rechargeable battery cell, such as the example battery 100 of FIG. 1. In the example shown, process 200 includes stages 202, 204, 212, 214, and 220. The flow diagram includes an anode branch (left branch) that includes stages 202 and 204, and a cathode branch (right branch) includes stages 212 and 214. At stage 202, anode particles (e.g., conventional graphite (carbon) anode particles or Si-comprising (e.g., Si—C nanocomposite(s), core-shell, SiOₓ-based, or SiNₓ-based, etc.) particles are provided or made, and at stage 204, an anode is formed using the anode particles from stage 202. Similarly, at stage 212, cathode particles (e.g., conventional intercalation-type cathode particles or core-shell cathode particles or composite cathode particles, including conversion-type cathode material—comprising composite particles) are provided or made, and at stage 214, a cathode is formed.

Electrodes utilized in Li-ion batteries are typically produced by (i) formation of a slurry comprising active materials, conductive additives, binder solutions and, in some cases, surfactant or other functional additives; (ii) casting the slurry onto and/or into a metal foil current collector (e.g., Cu or Cu-alloy foil for most anodes and Al or Al-alloy foil for most cathodes); and (iii) drying the casted electrodes to completely evaporate the solvent. Note that a metal mesh, metal foam or very rough metal foil (e.g., comprising metal nanowires or metal nanosheets on its surface) may be used as current collector(s) in some designs (e.g., for higher areal capacity loadings or for achieving faster charge, etc.). Also note that a metal-coated thin polymer sheet may also be used in some designs as current collector(s) (e.g., to achieve improved safety or lower current collector weight, etc.). Also note that a porous metal foil or composite (e.g., nanocomposite) metal foils may be used in some designs (e.g., for improved properties, lower weight, etc.).

Stage 204 includes forming an anode electrode, with the anode electrode including the anode particles made or provided at stage 202. For example, stage 204 can include (1) making an anode slurry that includes the anode particles (e.g., from stage 202) and other anode slurry components (e.g., binder, additives, etc.) and (2) casting the anode slurry on and/or (in case of a porous current collector) in an anode current collector (e.g., copper foil or copper-alloy foil current collector, porous copper or copper alloy or nickel or nickel alloy foam or foil, or nickel-alloy current collector or polymer-comprising current collector, etc.). For example, other anode slurry components may include: other electrochemically-active anode active materials (e.g., suitable natural or synthetic graphite, soft carbon or hard carbon blended with Si-comprising active material particles, such as Si—C(nano)composite particles), electrically conductive additives (e.g., carbon nanotubes or carbon black or branched carbon or carbon nanofibers or graphite flakes or exfoliated graphite or graphene or graphene oxide or soft graphite or their various combinations), binders (e.g., polymer binders), and solvents (e.g., water or an organic solvent or their mixtures). In some designs, solvent-free (“dry”) electrode fabrication may be utilized (e.g., with PTFE or PTFE-comprising copolymer binder(s) or other binders).

Stage 214 includes forming a cathode electrode, with the cathode electrode including the cathode particles made or provided at stage 212. For example, this stage 214 can include (1) making a cathode slurry that includes the cathode particles (e.g., from stage 212) and other cathode slurry components and (2) casting the cathode slurry on and/or (in case of a porous current collector) in a cathode current collector (e.g., aluminum foil or aluminum-alloy foil current collector). For example, other cathode slurry components may include: other electrochemically-active cathode active materials, electrically conductive additives (e.g., carbon nanotubes or carbon black or branched carbon or carbon nanofibers or graphite flakes or graphene or graphene oxide or soft graphite or their various combinations), binders (e.g., polymer binders), and solvents (e.g., water or an organic solvent or their mixtures). In some designs, solvent-free (“dry”) electrode fabrication may be utilized.

At stage 220, the Li-ion rechargeable battery cell is assembled from at least the anode electrode (e.g., blended anode comprising graphite particles and Si—C (nano)composite particles) and the cathode electrode with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations (e.g., implementations in which a liquid electrolyte is used), a separator may be used to maintain a space between the anode and the cathode electrodes (e.g., to avoid a short-circuit).

In still further aspects, the step of assembling the battery can comprise positioning a suitable separator that can comprise polymer and/or ceramic components between the cathode and anode electrodes. In some designs, a separator may be integrated into one of the electrodes. In some designs, a separator may be adhered to one or both of the electrodes. In other designs, the separator may be omitted (e.g., if a solid electrolyte is used, the solid electrolyte may take the place of the separator). Packaging the battery into a desired configuration (e.g., a cylindrical cell configuration, a prismatic cell configuration, a pouch cell configuration), carrying out electrochemical formation (e.g., formation of a solid-electrolyte interphase (SEI) in the anode and/or a cathode-electrolyte interphase (CEI) in the cathode), degassing, sealing, and aging operations may also be carried out as part of stage 220.

Battery cell modules or battery cell packs may advantageously comprise cells with electrode and/or electrolyte compositions provided in one or more embodiments of the present disclosure. Such cell modules or packs may offer improved performance characteristics, simplified designs, better safety features or lower cost.

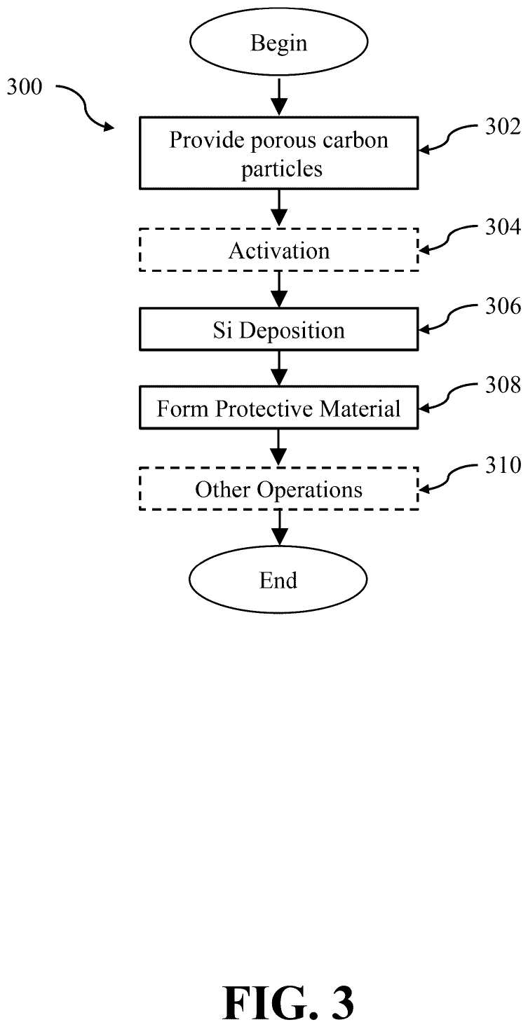

FIG. 3 is a flow diagram of a process 300 of making (e.g., Si-comprising) anode particles. Process 300 includes stages 302, 304, 306, 308, and 310. At least some of the stages that are optional in some implementations are shown in boxes with dotted lines. Accordingly, stages 304 and 310 are optional in some implementations. In some implementations, the stages may be carried out in the order shown by the arrows. In some designs, process 300 may be particularly useful when implemented as part of stage 202. If suitable modifications are made to process 300 to make cathode particles, process 300 may be implemented as part of stage 212. In some implementations, electrode particles are made using porous carbon particles or porous carbon-containing particles (e.g., using graphitic, sp²-bonded carbon or porous graphitic, sp²-bonded carbon—containing particles), with nanostructured or nano-sized active material particles or nanoparticles (e.g., Si-comprising, among others) (e.g., with average diameter or linear dimensions of such active material particles being in the range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques) being formed in the pores of the porous carbon or porous carbon-containing particles or otherwise incorporated within such carbon-containing particles. In the case of anode particles for use in Li-ion batteries, the active material particles may be silicon or silicon-comprising particles (e.g., nanoparticles).

At stage 302, porous carbon or porous carbon-containing particles are provided. In some designs, carbon (e.g., graphitic, sp²-bonded carbon) particles may be obtained from pyrolysis or carbonization (e.g., by heat treatment or hydrothermal treatment) (in some designs, followed by washing of metal-comprising or impurity compounds; and may be further followed by another heat-treatment or annealing) of a suitable precursor particle, such as a polymer particle or a biomass-derived particle or a metal-organic particle (e.g., with examples of suitable metals or combinations of two, three or more metals include, but are not limited to magnesium (Mg), calcium (Ca), Na, K, among others). In some designs, carbon particles may be obtained from carbon-comprising inorganic precursor particles (e.g., carbides or oxy-carbides, etc.). In some designs, it may be particularly advantageous to utilize Mg-comprising metalorganic compounds (e.g., Mg-comprising organic salts). Herein, processes, materials, and techniques for obtaining carbon-comprising particles by pyrolysis of magnesium (Mg) organic salt compositions are described below in more detail.

In some designs, inorganic sacrificial templates (including, but not limited to various oxides or hydroxides or oxyhydroxides of various metals and semi-metals—e.g., Zn, Mg, Si, Al, Ti, Ca, Mg, Sc, etc. and their various combinations) or soft (organic) templates may be used for the formation of porous carbon particles. In some designs, the inorganic sacrificial material may be selectively removed (e.g., etched) to form the pores of the porous carbon material. Herein, processes, materials, and techniques for etching metal (e.g., Mg) compounds (e.g., MgO) from precursor particles comprising Mg compounds and carbon, formed by pyrolysis, are described below in more detail.

In some designs, it may be preferable that the porosity (e.g., specific surface area and specific pore volume) of the porous carbon or carbon-containing particles (e.g., upon completion of stage 302) be quite high (e.g., BET specific surface area of at least about 500 m²/g) before the formation (e.g., by gaseous deposition) of the nanostructured or nano-sized active material particles therein. In some cases, the precursor particles themselves may be highly porous (e.g., BET specific surface area of at least about 500 m²/g) (e.g., porous carbon particles formed from magnesium organic salt compositions by following the processes as described herein). Nevertheless, in some designs, it may be preferable to produce or enhance porosity in carbon or carbon precursor particles (e.g., by carrying out chemical and/or physical activation on the carbon or carbon-containing particles or by leaching out non-carbon components of carbon-containing particles or by multiple processes) before formation of the active material particles therein to tune the porosity characteristics. Accordingly, stage 304 includes carrying out a porosity enhancing (e.g., an activation) process on the carbon particles (e.g., from stage 302). Stage 304 is optional depending on whether the porous carbon particles from stage 302 meet the porosity requirements for the subsequent formation of active materials, at stage 306.

For illustration, process 300 is described with respect to the formation of certain electrode (e.g., anode) particles. The concepts of process 300 including porosity enhancing (e.g., an activation) of carbon particles can be applied to other anode particles or with cathode particles that require activation of carbon particles.

In the example illustrated in FIG. 3, nanostructured or nano-sized silicon (Si) or silicon oxide (SiOₓ) or silicon nitride (SiN_{y}) or silicon oxy-nitride (SiOₓN_{y}) or silicon phosphide (SiPz) particles (0<x<2; 0<y<1.3; 0<z<1) or their various combinations, alloys and mixtures are formed within the pores (and/or on the surface) of porous carbon or porous carbon-containing particles (e.g., mostly graphitic, sp²-bonded porous carbon or mostly graphitic, sp²-bonded carbon-containing particles). For example, stage 306 includes the formation of silicon-based active material particles at least in some of the pores of the porous carbon particles. The formation (e.g., by deposition or infiltration or deposition/infiltration of a Si-comprising precursor with the subsequent conversion to the final Si or Si-based material) of silicon-based active material particles in the porous carbon particles can be accomplished by solution-based or vapor-based deposition processes, in some examples, or by other suitable means. In some implementations, stage 306 includes a CVD process that employs a silane (such as SiH₄ (silane), Si₂H₆ (disilane), Si₃H₅ (trisilane), Si₄H₁₀ (tetrasilane), dichlorosilane, trichlorosilane, silicon tetrachloride (tetrachlorosilane), methyl silane, and methyl trichlorosilane (MTS)) as a silicon precursor. For brevity, the particles upon completion of stage 306 are sometimes referred to as silicon-carbon composite particles (with an understanding that elements other than Si and C may be present within such composite particles in some designs). In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques.

In the example shown, stage 308 is carried out after stage 306. For example, stage 308 includes the formation of a protective coating on and/or in the silicon-carbon (Si—C) composite particles (from stage 306). In some designs, the suitable average thickness of the protective coating may range from about 0.2 nm to about 50 nm (in some designs, from about 0.2 nm to about 2 nm; in other designs, from about 2 nm to about 5 nm; in other designs, from about 5 nm to about 10 nm; in yet other designs, from about 10 nm to about 50 nm). In some designs, the true density of the protective coating may range from about 0.8 g/cc to about 4.8 g/cc or about 5.8 g/cc (in some designs, from about 0.8 g/cc to about 1.6 g/cc; in other designs, from about 1.6 g/cc to about 3 g/cc; in other designs, from about 3 g/cc to about 4.5 g/cc; in yet other designs, from about 4.5 g/cc to about 4.8 g/cc or about 5.8 g/cc).

In some designs, the protective or functional coating may comprise (e.g., in part) metal or semimetal oxide or oxy-carbide (including but not limited to a silicon oxide or silicon oxy-carbide) or metal or semimetal fluoride or oxy-fluoride.

In some designs, the protective coating may comprise or be based on electronically conductive material such as carbon. In some designs, such a carbon coating may be doped (e.g., with B, P, N, O and/or other elements). In some designs, the atomic fraction of individual dopants may range from about 0.01 at. % to about 10.01 at. % (in some designs, from about 0.01 at. % to about 0.1 at. %; in other designs, from about 0.1 at. % to about 1 at. %; in other designs, from about 1 at. % to about 5 at. %; in yet other designs, from about 5 at. % to about 10.01 at. %). In some designs, the protective coating may be largely impermeable to electrolyte solvent. In some designs, the protective coating may comprise both carbon and ceramic-comprising component(s) (e.g., oxide, oxy-carbide, fluoride, oxy-fluoride, etc.). In some designs, such component(s) may present as distinct layer(s).

During operation of a Li-ion battery cell (e.g., 100 in FIG. 1), the protective coating may reduce or prevent direct contact between the silicon nanoparticles and an electrolyte solvent composition. In some designs, direct contact between the electrolyte solvent composition and the silicon nanoparticles may undesirably accelerate degradation of the Li-ion battery cell.

In the example shown, stage 310 is carried out after stage 308. For example, stage 310 includes making changes to the particle size distribution (PSD). Stage 310 may include carrying out comminution on the protected silicon-carbon composite particles (from stage 308). Comminution may be carried out when the particle sizes are larger (on average) than a final desired (e.g., for a slurry and electrode processing) particle size distribution. Various processes of carrying out comminution are known in the art. For example, the comminution can be carried out by one or more of: ball milling, jet milling, attrition milling, pin milling, and hammer milling. In some implementations, it may be preferable to carry out particle size selection during stage 310. In some cases, stage 310 can include particle size selection (e.g., by sieving or by screening or by centrifugation or by other aerodynamic size classification or by other means) in addition to comminution (e.g., particle size selection after comminution). In some cases, stage 310 can include particle size selection without comminution. For example, it may be preferable to retain some of the larger particle sizes and discard the finer particle sizes. The particle size selection may be carried out by any one of suitable processes known to those skilled in the art, such as screening, sieving, and aerodynamic size classification.

The foregoing process stage 310 includes examples, such as comminution and particle size selection, of making changes to a particle size distribution (PSD) of a population of particles. In some cases, it may be preferable to employ additional or alternative processes for changing or adjusting a PSD, such as mixing two or more populations of particles wherein each of the populations has a PSD different from others of the populations. For example, particle populations of different PSDs may be obtained (e.g., obtained from a supplier or made to different PSDs including employing the aforementioned processes of comminution and/or particle size selection under different processing conditions).

The particle size distribution (PSD) that characterizes a particle population may be determined by laser particle size distribution analysis (LPSA), image analysis of electron microscopy images, or other suitable techniques. The particle size distribution (PSD) may be determined by laser particle size distribution analysis (LPSA) on well-dispersed particle suspensions in one example. Note that other types of particle size distribution (e.g., by SEM image analysis) could also be utilized (and may even lead to more precise measurements, in some experiments). While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀−D₁₀ (sometimes referred to herein as a left width), D₉₀−D₅₀ (sometimes referred to herein as a right width), D₉₀−D₁₀ (sometimes referred to herein as a full width), and (D₉₀−D₁₀)/D₅₀ (sometimes referred to herein as a span). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD is in a range of about 2.0 μm to about 16.0 μm, or in a range of about 2.0 to about 4.0 μm, or in a range of about 4.0 to about 6.0 μm, or in a range of about 6.0 to about 8.0 μm or in a range of about 8.0 to about 16.0 μm. In some embodiments, (D₉₀−D₁₀)/D₅₀ may preferably be in the range from about 0.5 to about 6, or in a range of about 0.5 to about 1 or in a range of about 1 to about 2 or in a range from about 2 to about 4 or in a range from about 4 to about 6. Smaller value of a span (more narrow particle size distribution) may be advantageous in some designs.

Upon completion of the operations in process 300 (e.g., stages 302, 304, 306, 308, 310), the composite particles may be characterized by a Brunauer-Emmett-Teller (BET) specific surface area (SSA) (e.g., obtained from the data of nitrogen sorption-desorption at cryogenic temperatures, such as about 77K). In some embodiments, the BET-SSA of the composite particles is in a range of about 0.5 m²/g to about 50 m²/g (e.g., from about 0.5 to about 3 m²/g; from about 1 to about 3 m²/g; from about 3 m²/g to about 12 m²/g; from about 12 m²/g to about 18 m²/g; from about 18 m²/g to about 30 m²/g; or, from about 30 m²/g to about 50 m²/g).

In the present disclosure, we demonstrate a new revolutionary technology to form a significantly cheaper Si—C composite with no silane or silane-derivative precursors (in some designs, with significantly reduced silane precursor consumption(s)). It is based on a composite of abundant SiO₂, which could be in the form of sand, silica or quartz, and a low-cost, commodity-chemical carbon material.

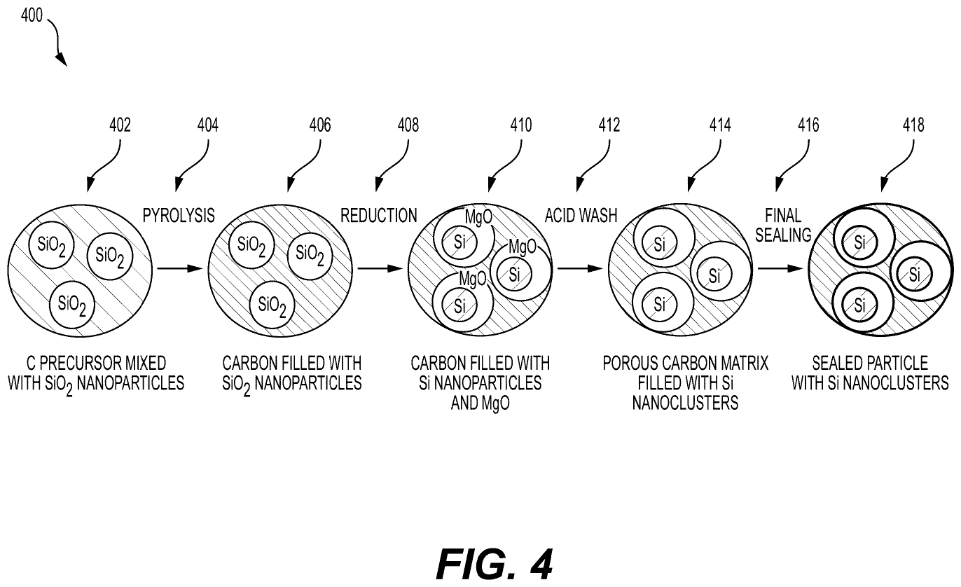

FIG. 4 is a schematic illustration of an example process 400 of making silicon-carbon composite particles, in accordance with some embodiments. A starting material comprises a mixture of silicon oxide particles and a carbon precursor compound. The example process includes carrying out magnesiothermic reduction.

Synthesis of Si (e.g., as a portion of a Si—C composite) from SiO₂ via a metallothermic reduction process requires a metal reductant capable of reducing the oxide at temperatures low enough to preserve Si nanostructuring (ideally <700° C.). The relative stability of SiO₂ compared to other oxides, most easily visualized in an Ellingham diagram as a more negative Gibbs free energy of the oxide formation reaction compared to many metal oxides across a wide range of temperatures (0-1700° C.), limits the viable options for such reductants. Among the thermodynamically viable reductant options (Al, Li, Mg, Ca), Mg is particularly appealing due to its higher vapor pressures at relatively low temperatures (<700° C.), experimentally demonstrated high Si yields, low cost, and relatively safe handling of reagents (compared to Li) and byproducts (e.g. MgO and Mg salts formed during MgO removal with acid). The mechanism for silica reduction by Mg is a solid-gas interface reaction:

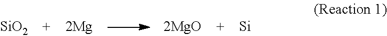

To retrieve Si structures from the thus formed Si/MgO composite, the MgO may then be washed (etched) with an acid:

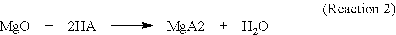

where A represents an acid anion equivalent to one H⁺, and may represent various acids, including hydrochloric, nitric, sulfuric, acetic, and citric acids, all of which have been shown to effectively dissolve MgO. In some cases, the resulting porous Si may be further treated with HF to remove residual oxide. In other implementations, Al, Li, and/or Ca, may be employed as the reductant in the metallothermic reduction process.

Herein, we disclose a low-cost, scalable magnesiothermic reduction process adapted for the synthesis of high-performance (nano) Si—C composite anodes from a SiO₂—C composite. For this purpose, we developed process hardware enabling uniform distribution of Mg vapor in the SiO₂—C feedstock from a remote Mg source. We found that the remote Mg source enables greater control of the reduction reaction compared to mixtures of Mg and SiO₂ feedstock typical in many studies, where the significant reduction exotherm may lead to the formation of undesirable byproducts or structural changes in the Si product. To further improve scalability of the overall process, we discovered the effective passivation of freshly reduced Si surfaces with a gaseous hydrocarbon precursor to mitigate re-oxidation during MgO removal, with the intention of rendering HF treatment unnecessary. Final surface area may be further tuned by the addition of C via chemical vapor deposition (CVD) or other suitable processes (e.g., annealing in controlled environment).

The example process (illustrated in FIG. 4) begins with a mixture (402) of one or more silicon oxide particles (SiOₓ, wherein x is greater than 0 and is not greater than 2, e.g., SiO₂) and a C or C-containing precursor compound (e.g., a polymer or a resin or an organic acid or a salt of an organic acid) that is then pyrolyzed in N₂ at a temperature of about 900° C. in one example illustration (in some implementations, the temperature may be in a range of 750 to 2500° C., such as 750-800° C., 800-850° C., 850-900° C., 850-950° C., 900-950° C., 950-1000° C., 1000-1050° C., or 1050-1100° C., or 1100-2500° C.) for a time period of about 30 min in one example illustration (in some implementations, in a range of 0.001 sec to 24 h, such as 0.001 sec to 1 min, 1 min to 10 min, 10 min to 30 min, 30 min to 1 h, 10 min to 1 h, 1 h to 3 h, 3 h to 6 h, 6 h to 12 h, 12 h to 18 h, or 18 h to 24 h, or even longer, depending on the temperature used; where lower temperature may require longer processing times for optimal performance) (stage 404). In some implementations, the silicon oxide particles may have an average size (e.g., D₅₀) in a range of 20 nm to 10 μm (e.g., in a range of 20 nm to 100 nm, in a range of 100 nm to 300 nm, in a range of 300 nm to 1 μm, in a range of 1 μm to 3 μm, or in a range of 3 μm to 10 μm). In some implementations, the silicon oxide particles may be porous. In illustrative examples, the mass fraction of C in the produced SiO₂—C composites (402) was varied from 10 to 65 wt. % (e.g., in a range of 10 to 20 wt. %, in a range of 20 to 30 wt. %, in a range of 30 to 45 wt. %, in a range of 45 to 55 wt. %, or in a range of 55 to 65 wt. %). Preliminary studies also included synthesis trials with C-free SiO₂ inputs (e.g. quartz and porous, amorphous SiO₂) to identify optimal reduction and MgO removal conditions. In some implementations, the carbon precursor compound may be a resin (i.e., a highly viscous organic compound that may polymerize under suitable conditions). In some implementations, the carbon precursor compound may be a polymer. In some implementations, the carbon precursor compound may be an organic acid or a salt of an organic acid (e.g., Ca salt or Mg salt or Ka salt or Na salt or Li salt or their various mixtures; note that in some designs the use of Mg salts may be preferred; note that in some other designs the use of Ca salts or a mixture of Ca and Mg salts may be preferred). In some implementations, the carbon precursor compound may form a shell around a single or multiple SiO₂ particles. In some implementations, the carbon precursor compound may be any organic compound (e.g., viscous organic compound) or metal-organic compound that forms a stable dispersion with silicon oxide particles and pyrolyzes to form the initial particles (406). In some designs, the carbon precursor compound may be synthesized (e.g., polymerized or produced in a reaction of Mg or Ca or other metal salts or compound like metal hydroxide or metal oxide, such as Mg(OH)₂ or MgO, etc. with an organic acid, such as acetic acid, citric acid, other carboxylic acids, other organic acids, their various mixtures, etc.) in a dispersion of SiO₂ particles or nanoparticles (or SiO₂ precursors) in order to produce a composite comprising of the carbon precursor compounds with imbedded one, two or more SiO₂ particles or nanoparticles or forming SiO₂ particles or nanoparticles coated with a layer of the carbon precursor compound(s). Carbonization of such carbon precursor compounds (or composite comprising of the carbon precursor compounds with imbedded one, two or more SiO₂ particles or nanoparticles) at elevated temperatures may lead to the formation of carbon (e.g., often porous, electrically conductive, sp²-bonded carbon) and (depending on the composition of the carbon precursor) ceramic nanoparticles (e.g., MgO, CaO, etc.) and the (e.g., initial) SiO₂ particles or nanoparticles. As illustrated in FIG. 4, the initial particles may comprise silicon oxide (nano)particles and carbon. In some designs, the size (e.g., diameter or average characteristic dimension) of such initial particles may range from about 1 μm to about 10 cm (e.g., in some designs, from about 1 μm to about 5 μm; in other designs, from 5 μm to about 10 μm; in other designs, from about 10 μm to about 20 μm; in other designs, from about 20 μm to about 50 μm; in other designs from about 50 μm to about 0.5 mm; in other designs from about 0.5 mm to about 5 mm; in yet other designs from about 5 mm to about 10 cm). The silicon oxide (nano)particles may be suspended in a carbon matrix in some implementations. In some designs, such intermediate particles may be spheroidal (including almost spherical) or rounded. In some designs, such initial particles may be of irregular shape. In some designs, such initial particles may be of jagged shape. In some designs, such initial particles may comprise of an agglomerate or aggregate of smaller (e.g., 10-10,000 times smaller by linear dimensions) intermediate particles (e.g., 1-10 mm intermediate particle may comprise an agglomerate of 0.001-0.05 mm intermediate particles). In some designs, such smaller intermediate particles may be spheroidal (including almost spherical) or rounded. In some designs, such smaller intermediate particles may be of irregular shape. In some designs, such smaller intermediate particles may be of jagged shape.

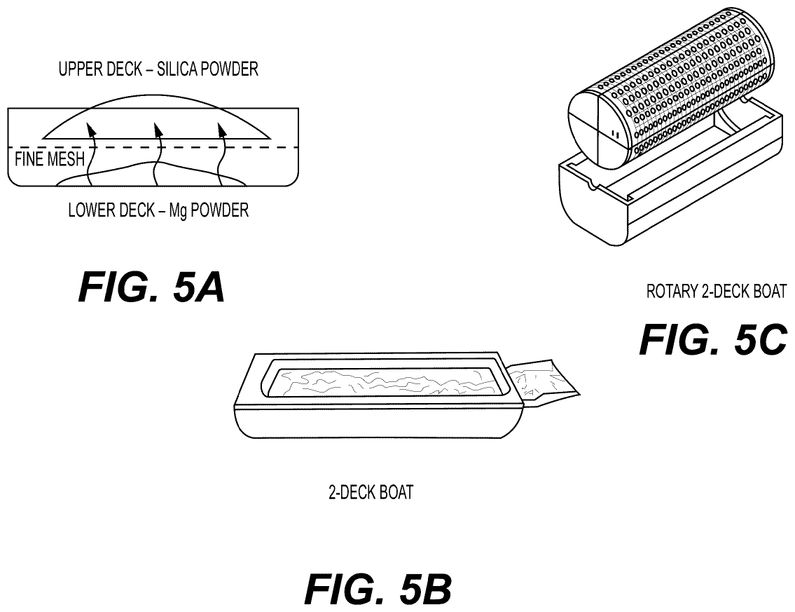

For the magnesiothermic reduction step (stage 408), the design of the reactor preferably provides a uniform Mg vapor distribution without excess (creating magnesium silicide) or deficiency of Mg (resulting in incomplete SiO₂ conversion), in some implementations. In the simplest illustrative example, this was accomplished with a two-deck boat design (illustrated in FIG. 5A, FIG. 5B) inside a tube furnace. In some designs, a reactor may be in the form of a horizontal or slightly angled (e.g., with an angle from about 1 degree to about 20 degrees) horizontal tube. In some designs, a rotary reactor may be utilized. In other designs, a reactor may be in the form of a vertical or essentially vertical tube. In other designs, a fluidized bed (e.g., vertical) reactor may be utilized. In some designs, a mechanical agitator (e.g., mixer) may be used in such reactor(s). In other designs, a fixed bed (e.g., vertical) reactor may be utilized. For initial illustrative studies, the static two-deck boat design shown in FIG. 5B was used: Mg pellets (e.g., lower-aspect ratio particles) or turnings (higher-aspect ratio particles) were loaded into the bottom compartment, while the SiO₂-based feedstock was evenly distributed on top of the steel mesh. In other implementations, a rotary two-deck boat design, shown in FIG. 5C may be employed, enabling uniform magnesiothermic reduction of larger quantities of SiO₂-based feedstock. In some implementations, the magnesiothermic reduction may be carried out at a temperature in a range of 580 to 700° C. (e.g., in a range of 580 to 610° C., in a range of 610 to 640° C., in a range of 640 to 670° C., or in a range of 670 to 700° C.). In some implementations, the magnesiothermic reduction may be carried out at a temperature of about 630° C. or in a range of 620 to 640° C. In some implementations, the magnesiothermic reduction may be carried out for a time period of 0.15 to 24 h (e.g., in a range of 10 min to 1 h, in a range of 1 h to 2 h, in a range of 2 h to 3 h, in a range of 3 h to 5 h, in a range of 3 h to 4 h, in a range of 4 h to 5 h, in a range of 5 h to 8 h, in a range of 8 h to 12 h, in a range of 12 h to 16 h, in a range of 16 h to 20 h, or in a range of 20 h to 24 h). A lengthier process (e.g., 24 h to 240 h) may also be employed in some designs, but would generally be more costly and less practical. In some implementations, the magnesiothermic reduction may be carried out for a time period of about 4 h or in a range of 3.5 h to 4.5 h.

Upon carrying out magnesiothermic reduction (stage 408) on the initial particles (406), first intermediate particles (410) are obtained. The first intermediate particles comprise carbon (e.g., from the pyrolysis of the carbon precursor), magnesium oxide, and silicon particles (e.g., obtained by reduction of the silicon oxide particles). In some implementations, the magnesium oxide may be present as magnesium oxide particles. In some implementations, the magnesium oxide and the silicon particles may be embedded in a (e.g., porous) carbon matrix. In some implementations, the magnesium oxide may be present as a shell layer that surrounds a silicon particle.

Upon completion of the magnesiothermic reduction (stage 408) and the formation of the first intermediate particles (410), newly created surfaces of silicon may be exposed to the ambient, which may oxidize. A sealing process may be carried out, to form a protective material on and/or in the first intermediate particles to produce the second intermediate particles. This sealing process is not shown in FIG. 4. In some implementations, it may be preferable to carry out a CVD process on the first intermediate particles (e.g., immediately after completion of magnesiothermic reduction, such as in the same reactor) to form a passivation layer (coating layer) on the silicon particles. Such a coating layer may be a carbon layer and may be deposited by a CVD process employing a hydrocarbon precursor (e.g., ethylene, acetylene, propylene). In some implementations, the hydrocarbon precursor gas may be propylene. In some implementations, the hydrocarbon gas (e.g., propylene) may be diluted in a carrier inert gas (e.g., N₂, Ar), in a range of 5 to 100 vol. % (e.g., in a range of 5 to 20 vol. %, in a range of 20 to 40 vol. %, in a range of 40 to 60 vol. %, in a range of 60 to 80 vol. %, or in a range of 80 to 100 vol. %). The CVD process may be carried out at a temperature in a range of 600 to 700° C. (e.g. in a range of 600 to 650° C., or in a range of 650 to 700° C.). The CVD process may be carried out for a time period in a range of 0.1 to 24 h (e.g., in a range of 0.1 to 1 h, in a range of 1 h to 2 h, in a range of 2 h to 3 h, in a range of 3 h to 5 h, in a range of 3 h to 4 h, in a range of 4 h to 5 h, in a range of 5 h to 8 h, in a range of 8 h to 12 h, in a range of 12 h to 16 h, in a range of 16 h to 20 h, or in a range of 20 h to 24 h). A lengthier process (e.g., 24 h to 240 h) may also be employed, but would generally be more costly and less practical. The CVD process would form the protective material on and/or in the first intermediate particles and generate the second intermediate particles. It may be preferable to carry out this passivation operation before carrying out the acid washing operation (stage 412).

For the acid washing operation (stage 412), a variety of acids may be employed, including stronger acids (e.g., sulfuric acid, hydrochloric acid, nitric acid) and weaker (e.g., organic) acids (e.g., citric acid, acetic acid, carbonic acid, etc.). The etching process may remove most of or substantially all of the MgO from the second intermediate particles. During the washing process, impurities may also be removed. Upon completion of the acid wash operation (stage 412), the third intermediate particles (414) are obtained. The third intermediate particles comprise carbon (e.g., from the pyrolysis of the carbon precursor compound, from the carbon-comprising coating layer) and silicon particles. There may also be residual magnesium-comprising compounds, although the mass fraction of residual magnesium-comprising compounds may be quite low (e.g., less than 1 wt. %, less than 0.1 wt. %, or less than 0.01 wt. %). The silicon particles may be present as (nano)clusters in a porous carbon matrix. In some designs (e.g., to increase Si wt. % in the Si—C(nano)composites), additional Si (e.g., as nanoparticles or as a coating layer on existing Si or on the surface of Si or C or within (nano)pores present) or Si-comprising material (e.g., doped Si or Si alloy) may be deposited (e.g., by using a CVD process (e.g., using SiH₄ or other suitable precursors)). This process is not shown in FIG. 4.

A sealing process (416) may be carried out, to form a protective material on and/or in the third intermediate particles. In some implementations, it may be preferable to carry out a CVD process on the third intermediate particles to form a passivation layer (coating layer) on the silicon particles. Such a coating layer may be a carbon layer and may be deposited by a CVD process employing a hydrocarbon precursor (e.g., ethylene, acetylene, propylene). In some implementations, the hydrocarbon precursor gas may be propylene. In some implementations, the hydrocarbon gas (e.g., propylene) may be diluted in a carrier inert gas (e.g., N₂, Ar), in a range of 5 to 100 vol. % (e.g., in a range of 5 to 20 vol. %, in a range of 20 to 40 vol. %, in a range of 40 to 60 vol. %, in a range of 60 to 80 vol. %, or in a range of 80 to 100 vol. %). The CVD process may be carried out at a temperature in a range of 600 to 700° C. (e.g. in a range of 600 to 650° C., or in a range of 650 to 700° C.). The CVD process may be carried out for a time period in a range of 0.1 to 24 h or longer if needed (e.g., up to 240 h, although such a lengthy process would be more costly and less practical) (e.g., in a range of 0.1 to 1 h, in a range of 1 h to 2 h, in a range of 2 h to 3 h, in a range of 3 h to 5 h, in a range of 3 h to 4 h, in a range of 4 h to 5 h, in a range of 5 h to 8 h, in a range of 8 h to 12 h, in a range of 12 h to 16 h, in a range of 16 h to 20 h, or in a range of 20 h to 24 h). Upon completion of the sealing process (416), sealed silicon-carbon composite particles (418) are obtained. In some implementations, the synthesis process may include respective sealing operations on the first and third intermediate particles. In some implementations, one of the above sealing operations may be omitted.

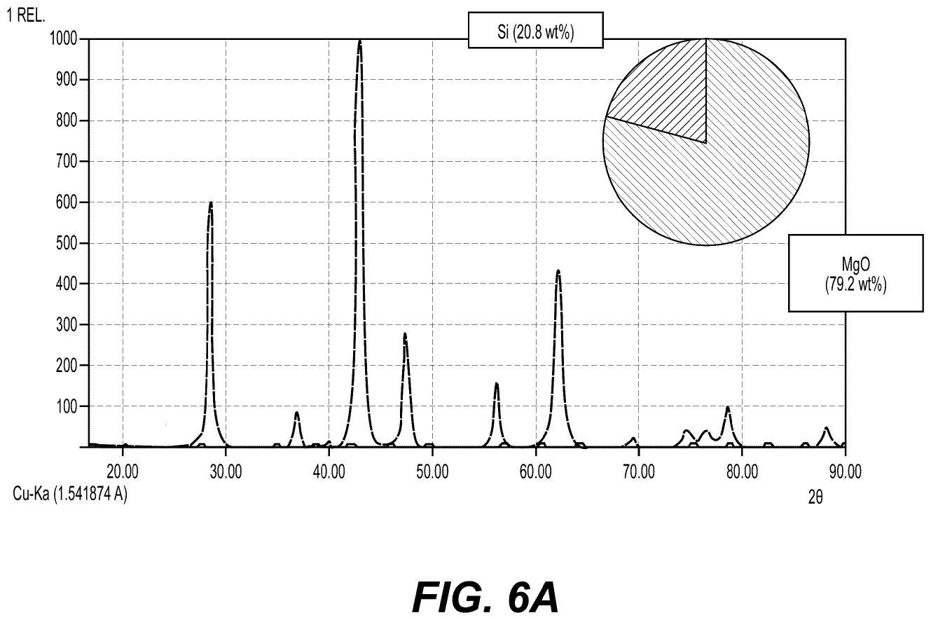

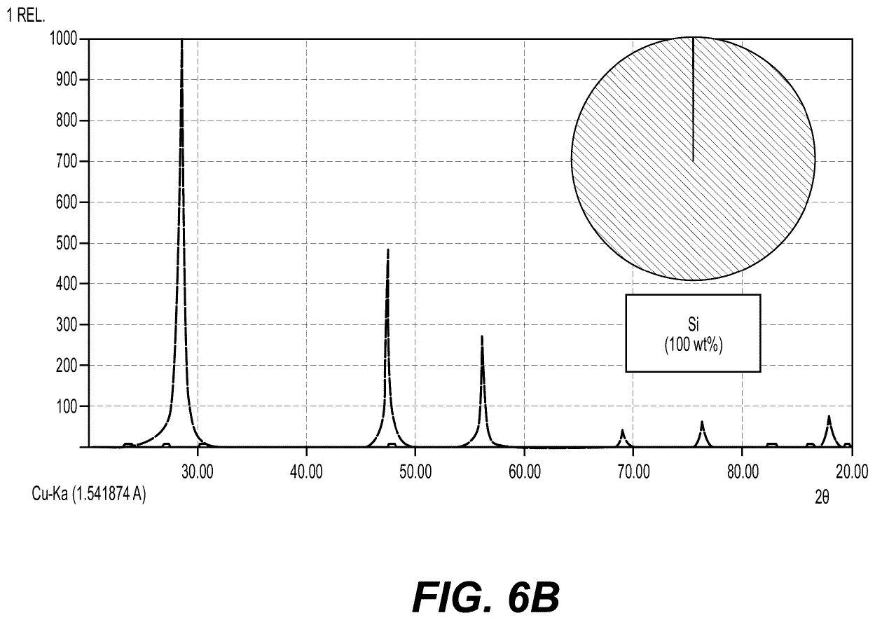

In one illustrative example, quartz and porous silica inputs that were reduced by magnesiothermic reduction at a temperature of about 630° C. for a time period of about 4 h, then washed in HCl, respectively yielded 90% and 98.6% Si, as detected by XRD. FIGS. 6A and 6B show example XRD spectra for the porous silica sample after reduction and after acid washing, respectively. No undesirable byproducts (e.g. Mg₂Si or Mg₂SiO₄) were observed by XRD, suggesting uniform and complete reduction. Note that amorphous phases that may be present will not be detected by XRD, and therefore, the composition of amorphous phases cannot be quantified with this analytical method.

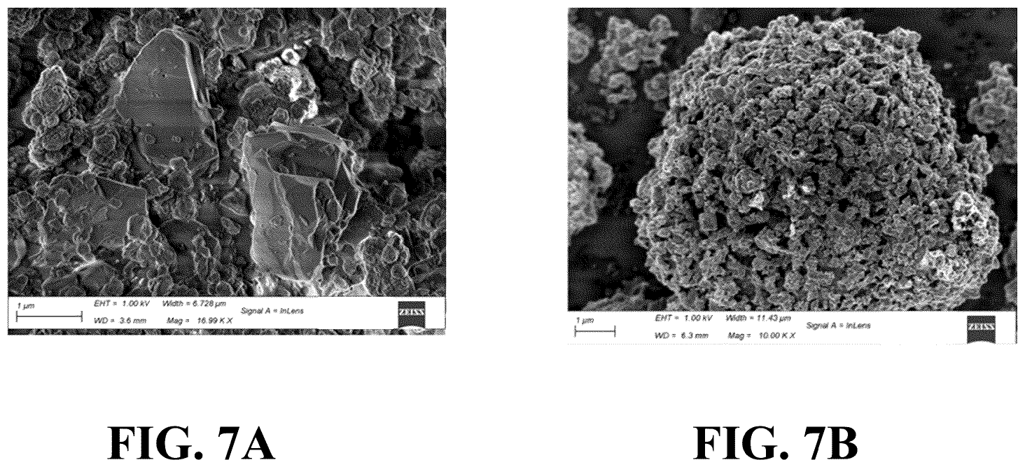

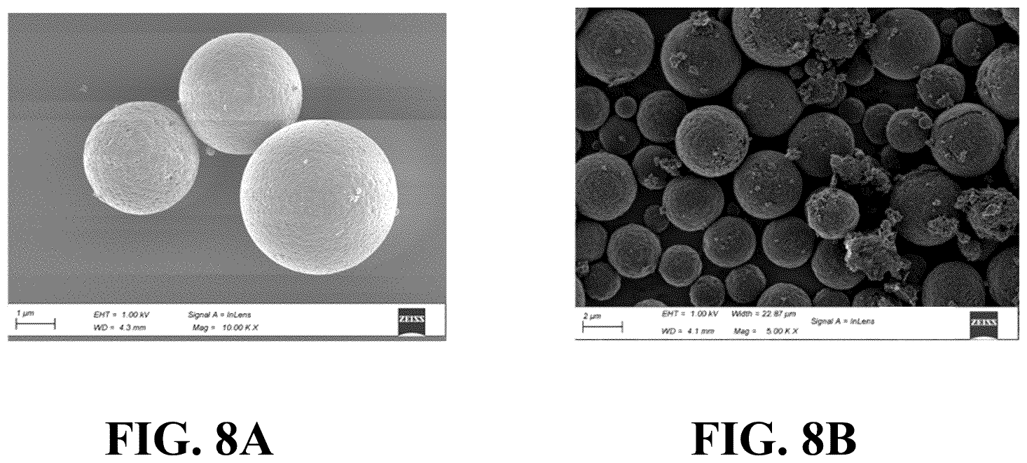

A comparison of SEM micrographs of the crystalline quartz input before (FIG. 7A) and after reduction, washing, and sealing (FIG. 7B) suggests significant morphological changes resulting from reduction. In contrast, a comparison of porous SiO₂ input before (FIG. 8A) and after reduction, washing, and sealing (FIG. 8B) suggests relatively small morphological changes. This difference in changes between crystalline quartz and porous silica suggests a porous silica structure (with approximately 60% porosity) may better withstand the volume changes from Mg incorporation and MgO removal, compared to a dense, crystalline quartz input (nonporous, or porosity below about 5%). For a quartz input, comparison of post-wash BET-SSA (approximately 190 m²/g) and input (about 6 m²/g) indicates that porosity is generated during reduction and washing, consistent with the morphological changes observed in SEM.

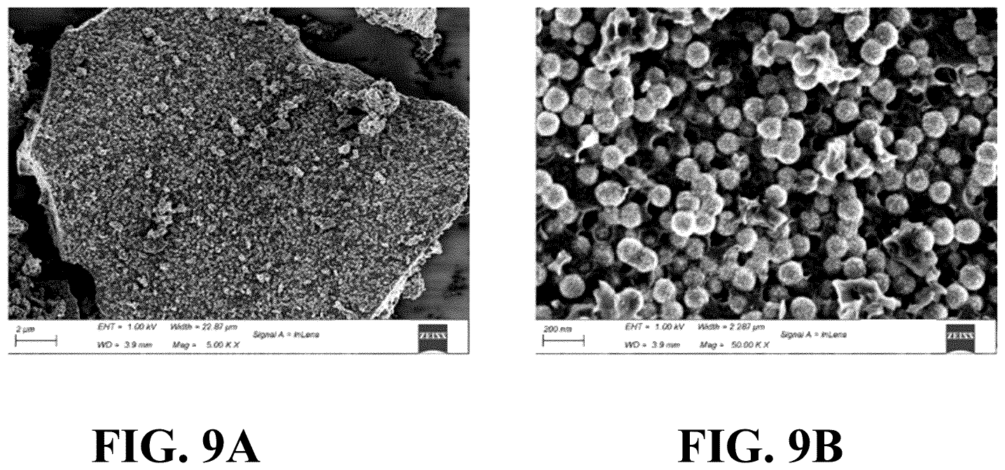

FIGS. 9A and 9B show scanning electron micrographs of a material obtained from carrying out magnesiothermic reduction at 630° C. for 4 h, followed by washing (etching) in 1 M HCl, and sealing by CVD-deposited carbon (33% propylene in N₂ at 630° C. for 9 h, at (A) 5000× magnification and (B) 50,000× magnification, where the reduced Si particles dispersed in a C matrix can be observed. The input material to the magnesiothermic reduction was a composite of 90 wt. % SiO₂ and 10 wt. % C.

Final BET specific surface area (BET-SSA) measured after reduction, washing, and sealing of a nonporous quartz input ranges between 60-135 m²/g, indicating incomplete sealing (compared to a target preferred BET-SSA <20 m²/g) under the conditions explored. Similarly, porous silica input exhibits final BET-SSA between 120-140 m²/g for the conditions explored so far. Final BET-SSA for C—SiO₂ inputs has been measured in the range 25-70 m²/g, possibly suggesting improved sealing in those structures. SEM micrographs of these C—SiO₂-derived structures (FIG. 8A) reveals porosity that is likely contributing significant surface area accessible to gas sorption measurements. Further tuning the C deposition conditions and the pore size distribution of the composite (prior to the C deposition) enables further reduction in BET-SSA. Instrumental gas analysis (IGA) revealed significant residual oxygen at the end of the process for SiO₂ and C/SiO₂ inputs in such illustrative studies, in the range 18-20 wt. % (target <5 wt. % 0). Residual oxygen may originate from incomplete reduction, incomplete MgO removal, and/or re-oxidation of Si during MgO removal with an aqueous HCl solution.

We demonstrated a lab-scale magnesiothermic reduction process for producing Si/C composites from SiO₂ and SiO₂—C composites with a remote Mg source. Si yields >90% (by XRD), with no undesirable byproducts (Mg₂Si and Mg₂SiO₄) were demonstrated with SiO₂ inputs. The input porosity appears to have an effect on morphological changes during the full process from reduction through sealing. Under the conditions reported here the final surface area BET-SSA remained higher than what is often preferable for battery performance (<20 m²/g or <10 m²/g or <5 m²/g or <1 m²/g may be preferred).

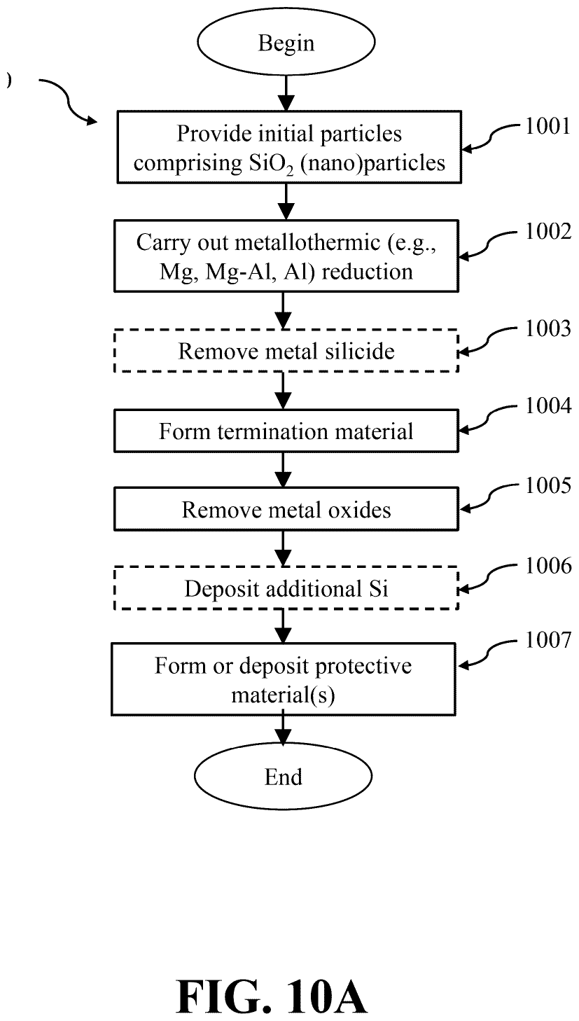

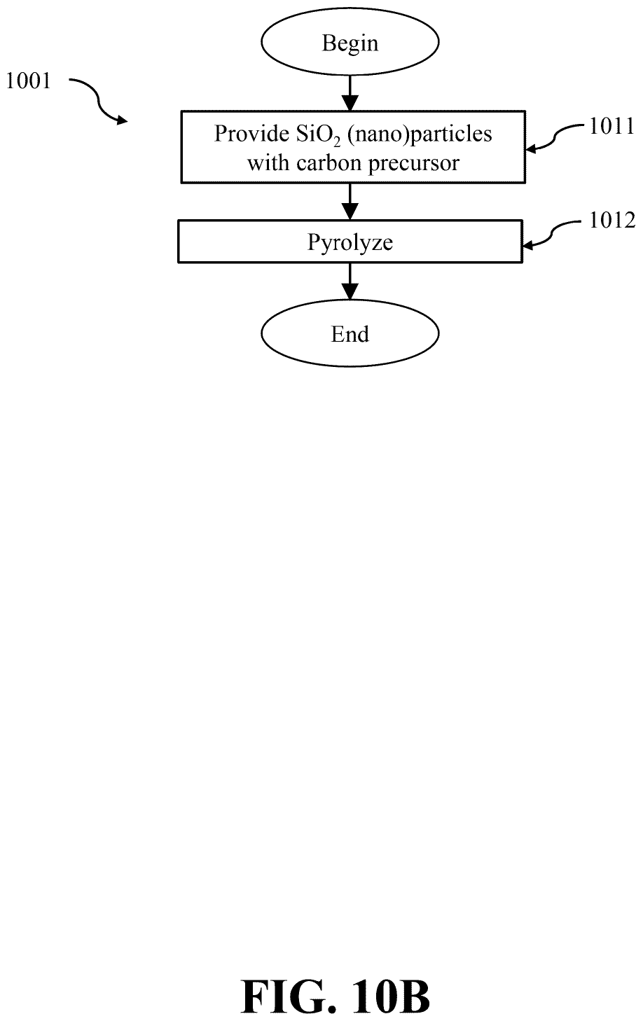

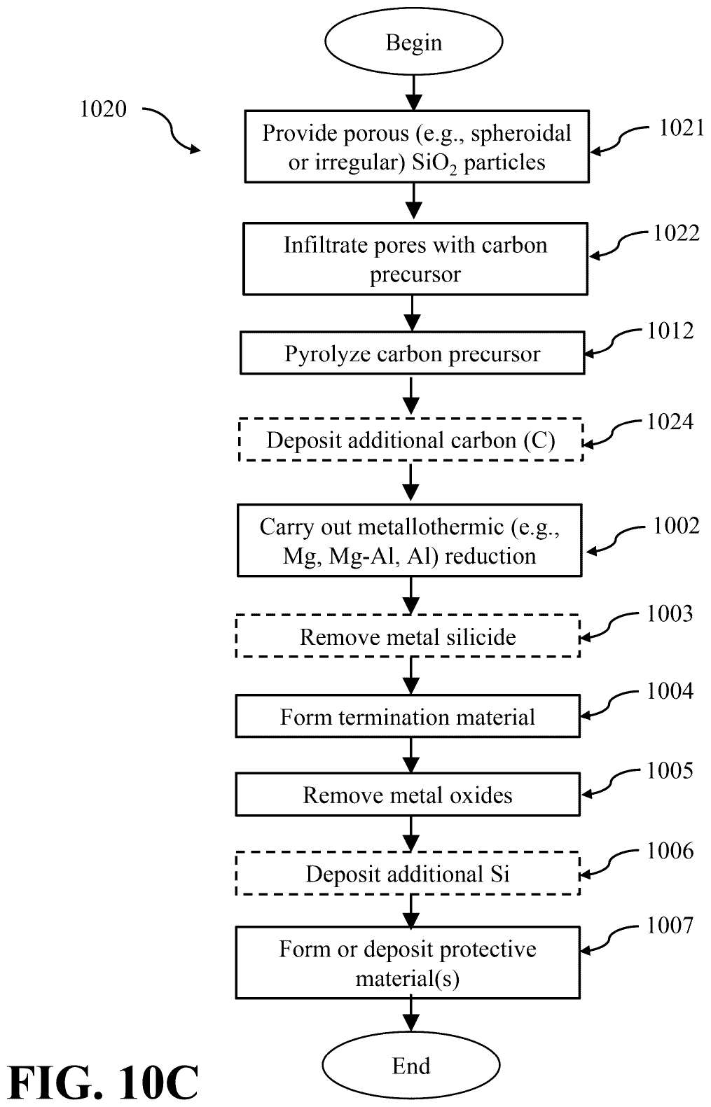

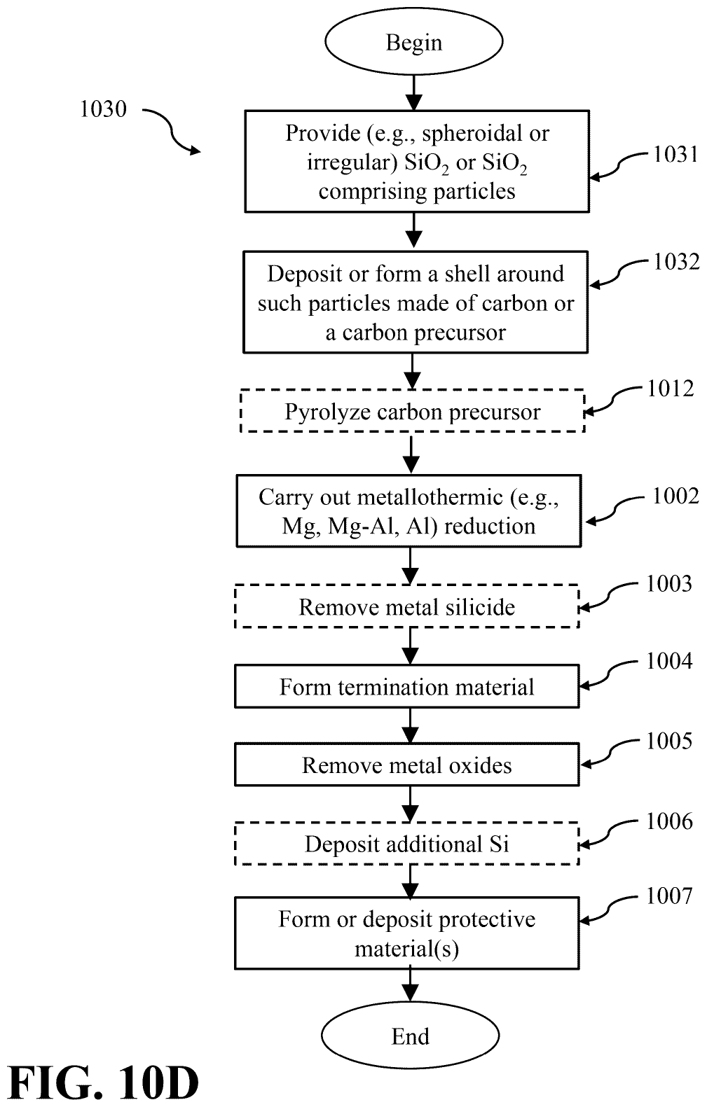

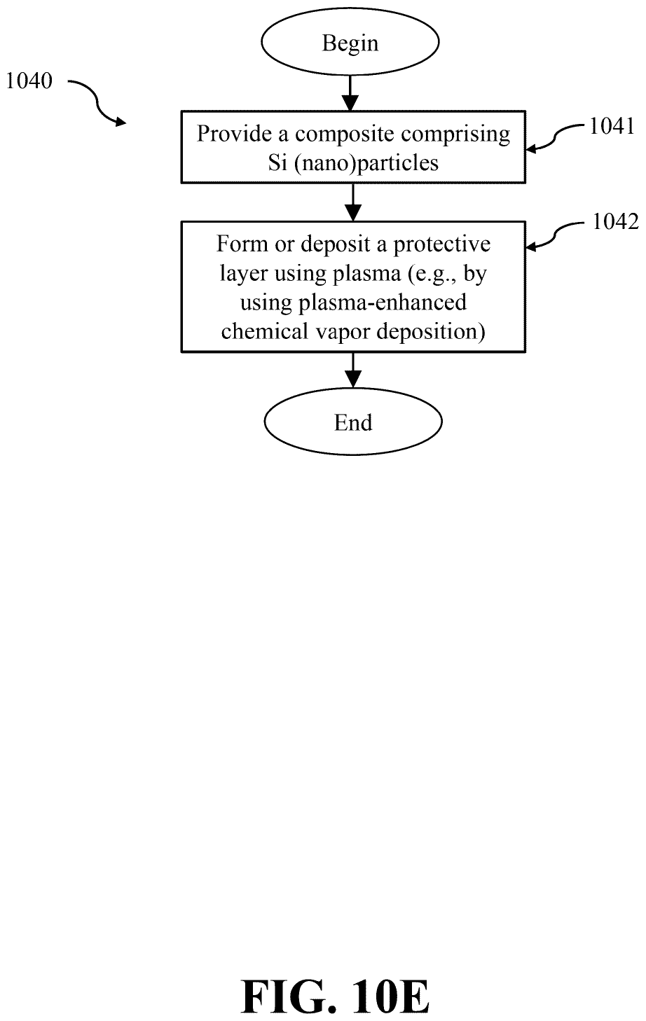

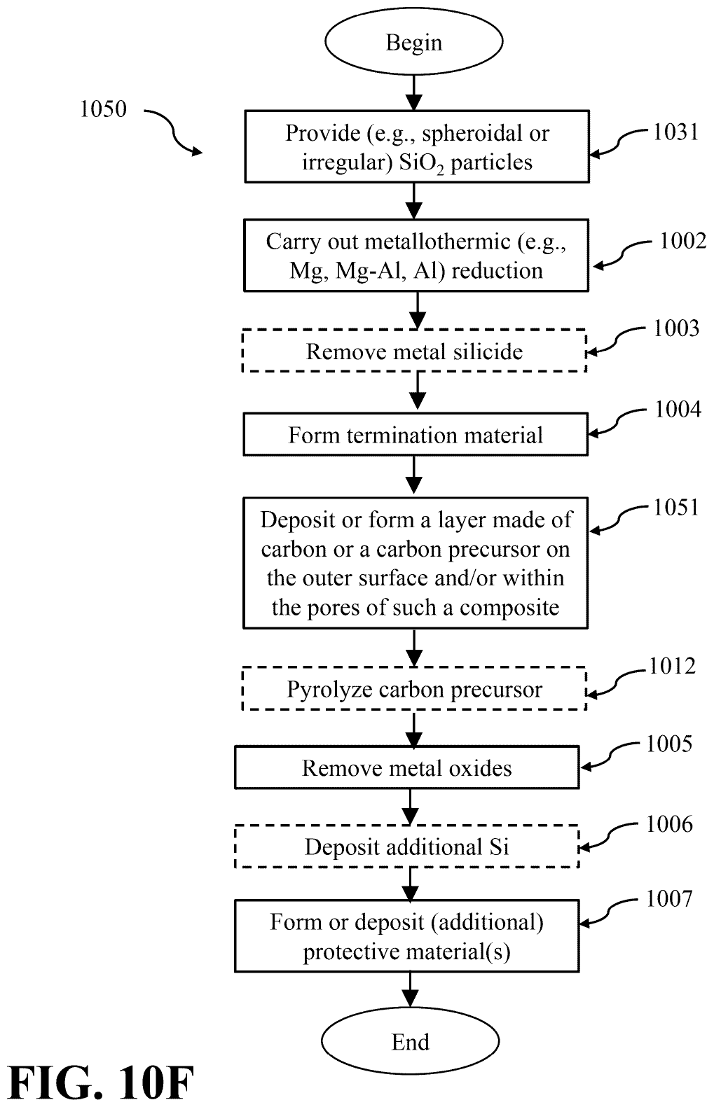

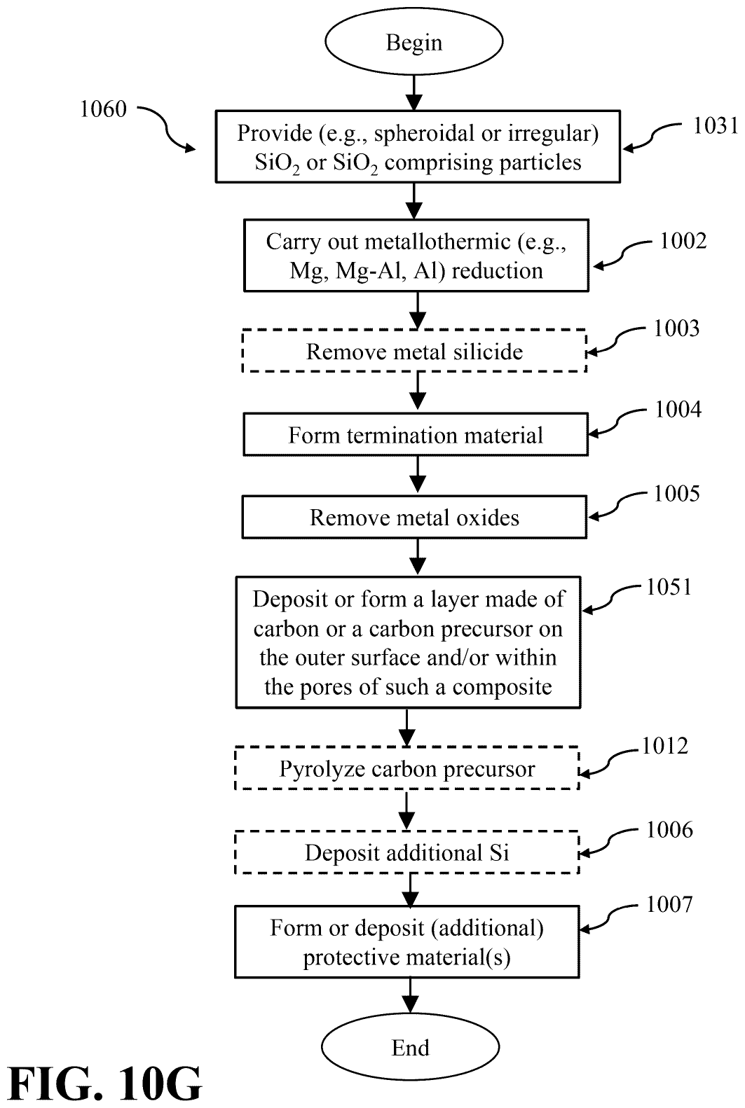

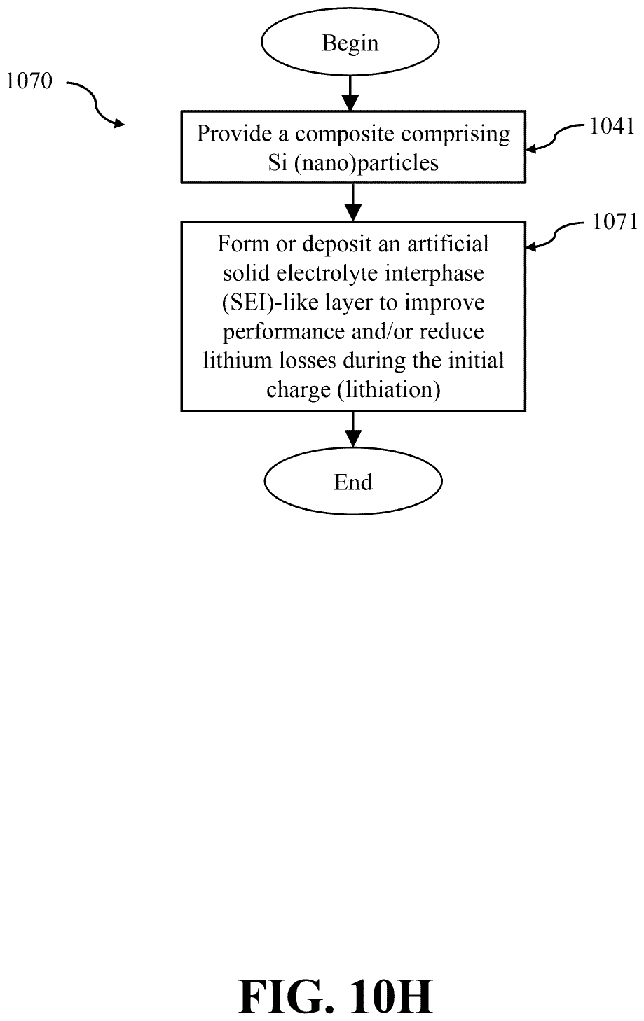

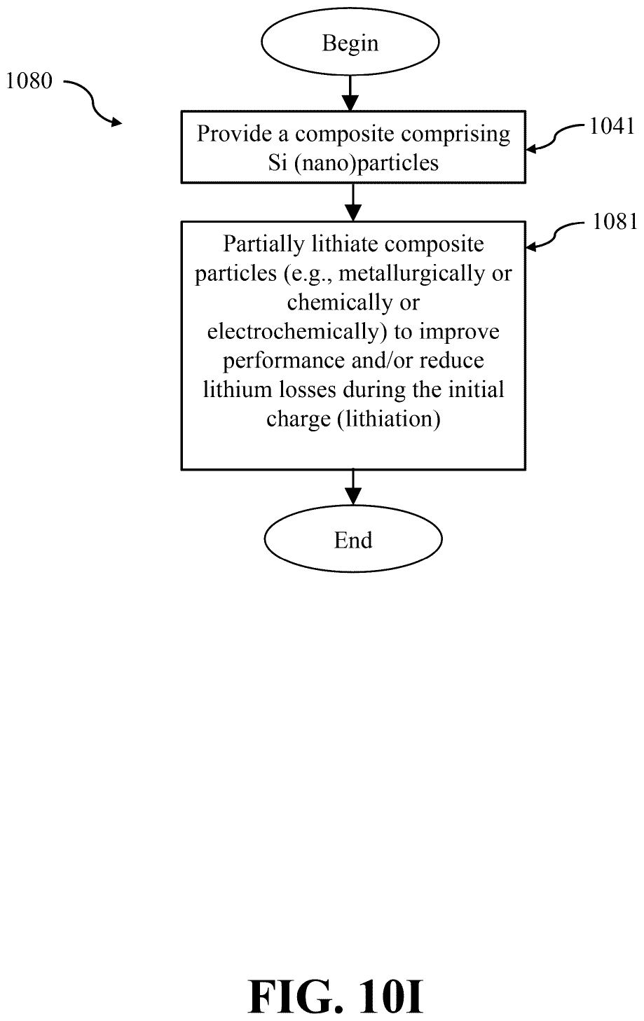

FIG. 10A is a flow diagram of an example process 1000 of making silicon-comprising particles (with an understanding that elements other than Si and C may be present within such composite particles in some designs) from silicon oxide (e.g., SiO₂) feedstock via metallothermic reduction. Process 1000 includes stages 1001, 1002, 1003, 1004, 1005, 1006 and 1007. At least some of the stages that are optional in some implementations are shown in boxes with dotted lines. Accordingly, stages 1003 and 1006 are optional in some implementations. In some implementations, the stages may be carried out in the order shown by the arrows. In some designs, process 1000 may be particularly useful when implemented as part of stage 202 (FIG. 2). If suitable modifications are made to process 1000 to make cathode particles, process 1000 may be implemented as part of stage 212 (FIG. 2).

At stage 1001, initial particles comprising silicon oxide (e.g., silicon dioxide) are provided. In some designs, these particles may be nano-sized, sub-micron in scale, or mm in scale, having an average size in a range from about 50 nm to about 20 μm (in some designs, from about 50 nm to about 70 nm; in other designs, from about 70 nm to about 100 nm; in other designs, from about 100 nm to about 200 nm; in other designs, from about 200 nm to about 300 nm; in other designs, from about 300 nm to about 500 nm; in other designs, from about 500 nm to about 700 nm; in other designs, from about 700 nm to about 1 μm; in other designs, from about 1 μm to about 2 μm; in other designs, from about 2 μm to about 3 μm; in other designs, from about 3 μm to about 5 μm; in other designs, from about 5 μm to about 7 μm; from about 7 μm to about 10 μm; in yet other designs, from about 10 μm to about 20 μm). In some designs, these particles may be provided in a variety of morphologies, such as crystalline quartz, porous silica microspheres, silica gel, or other amorphous or crystalline forms. In some implementations, the initial particles may be prepared by pyrolyzing precursor particles comprising the silicon oxide and a carbon precursor, such as a polymer or resin, to form a composite in which the silicon oxide particles are embedded within or coated by a carbon matrix. Pyrolysis may be carried out, for example, in an inert atmosphere (e.g., nitrogen) at about 900° C. in some designs (in some implementations, the temperature may be in a range of 750 to 3000° C., such as 750-800° C., 800-850° C., 850-900° C., 850-950° C., 900-950° C., 950-1000° C., 1000-1050° C., 1050-1100° C. or 1100-3000° C.) for a period of about 30 minutes in some designs (in some implementations, in a range of 0.0001 sec to 24 h (or longer, e.g., 240 h), such as 0.0001 sec to 1 min, 1 min to 10 min, 10 min to 30 min, 30 min to 1 h, 10 min to 1 h, 1 h to 3 h, 3 h to 6 h, 6 h to 12 h, 12 h to 18 h, or 18 h to 24 h, or 24 h-240 h), producing the initial particles comprising silicon oxide and carbon. In some designs, the carbon precursor may be selected from polymers, resins, organic acids, salts of organic acids (e.g., magnesium salts, calcium salts, potassium salts), or other organic or metal-organic materials capable of forming conductive, often porous, sp²-bonded carbon upon pyrolysis.

At stage 1002, a metallothermic reduction is carried out on the initial particles to convert the silicon oxide to elemental silicon. In some implementations, the reductant comprises Al, Li, Mg and/or Ca. In preferred implementations, the reductant comprises magnesium, a magnesium-aluminum alloy, or aluminum. The reduction may be carried out in a tube furnace or other suitable reactor with a configuration that promotes uniform metal vapor distribution (FIG. 5A)—such as a static (FIG. 5B) or rotary two-deck boat design (FIG. 5C) with the metal reductant positioned in a lower compartment and the silicon oxide feedstock placed above it on a mesh support. Metal (Met) vapor reacts with silicon oxide according to the solid-gas interface reaction: SiO₂+Met_{(g)}→MetO+Si.

When Mg is used as the reductant, the process is a magnesiothermic reduction. The reduction temperature is typically maintained in the range of 580 to 700° C. (e.g., in a range of 580 to 610° C., in a range of 610 to 640° C., in a range of 640 to 670° C., or in a range of 670 to 700° C.). In some implementations, the magnesiothermic reduction may be carried out at a temperature of about 630° C. or in a range of 620 to 640° C. In some implementations, the magnesiothermic reduction may be carried out for a time period of 0.5 to 240 h (e.g., in a range of 30 min to 1 h, in a range of 1 h to 2 h, in a range of 2 h to 3 h, in a range of 3 h to 5 h, in a range of 3 h to 4 h, in a range of 4 h to 5 h, in a range of 5 h to 8 h, in a range of 8 h to 12 h, in a range of 12 h to 16 h, in a range of 16 h to 20 h, or in a range of 20 h to 24 h or in a range of 24 h to 240 h). In some implementations, the magnesiothermic reduction may be carried out for a time period of about 4 h or in a range of 3.5 h to 4.5 h. In some implementations, the magnesiothermic reduction may be carried out at sub-atmospheric pressures (e.g., below 1 Torr) and in a reducing carrier gas (e.g., 5% H₂ in N₂) to inhibit silicon re-oxidation. The use of a remote magnesium source mitigates localized overheating and byproduct formation such as magnesium silicide or magnesium orthosilicate. Upon completion of the metallothermic reduction, first intermediate particles are obtained comprising elemental silicon, magnesium oxide, and, in some cases, magnesium silicide, with the silicon dispersed within or on a carbonaceous matrix if a carbon precursor was used.

In some other implementations at stage 1002, a contact-mode, mixed-bed metallothermic reduction may be used, in which the metal reductant is physically mixed with the silicon-oxide-comprising feedstock prior to heat treatment. In these designs, magnesium, a magnesium-aluminum alloy, aluminum, or combinations thereof are blended with SiO₂ or SiO₂/C composite. The mixed bed is then heated at about 600° C. in the illustrative example (in some implementations, the temperature may be in a range of 500 to 700° C., such as 500-550° C., 550-600° C., 600-650° C., 650-700° C.) for a period of about 6 h in the illustrative example (in some implementations, in a range of 1 h-24 h, such as 1 h to 3 h, 3 h to 4 h, 4 h to 5 h, 5 h to 6 h, 6 h to 7 h, 7 h to 8 h, or 8 h to 9 h, 9 h to 24 h), under reduced pressure (e.g., 15 Torr) and a reducing or inert carrier gas (e.g. 200 sccm Ar in the illustrative example for a small tube furnace), allowing the solid-solid/solid-gas reaction to proceed throughout the intimately contacted particles to produce elemental silicon and a metal-oxide by-product.

At stage 1003, any metal silicide present from stage 1002, if any, is removed. In some embodiments, silicide removal is achieved by thermal decomposition under vacuum or low pressure at an elevated temperature (e.g., extended annealing at a temperature above the reduction setpoint). In some designs, the annealing is conducted at a temperature in a range of about 550° C. to about 800° C. (e.g., about 550-600° C., about 600-650° C., about 650-700° C., about 700-750° C., about 750-800° C. In some designs, the annealing is conducted for an annealing time in a range of about 0.1 hour to 8 hours (e.g., about 0.1-1 hr, about 1-2 hr, about 2-3 hr, about 3-4 hr, about 4-5 hr, about 5-6 hr, about 6-7 hr, about 7-8 hr). In some implementations, the annealing is conducted under low pressures, in a range of about 0 to about 10 Torr (e.g., about 0-0.5 Torr, about 0.5-1.5 Torr, about 1.5-3.0 Torr, about 3.0-10.0 Torr). In some implementations, the annealing is conducted under a combination of annealing temperatures, annealing times, and annealing pressures, such as a combination of annealing temperatures in a range of about 600° C. to 750° C., annealing times in a range of about 1 to 8 hr, and annealing pressures in a range of about 0 to 1.5 Torr (e.g., (1) about 625-675° C., about 3-7 hr, about 0-1.5 Torr; (2) about 675-725° C., about 1-3 hr, about 0-1.5 Torr). In preferred example implementations, the first intermediate particles obtained from stage 1002 are annealed at a temperature of about 650° C. for 6 hours or about 700° C. for 2 hours under a pressure of about 1 Torr. In some implementations, the lower pressure anneal (e.g., 0 to 1.5 Torr) has been found to be effective in eliminating substantially all of the Mg₂Si. In designs where the reduction and termination implementations are tuned to avoid silicide formation, stage 1003 may be omitted.

At stage 1004, a termination material is formed on and/or in the first intermediate particles to produce second intermediate particles. In some implementations, this termination step immediately follows reduction (stage 1002 if stage 1003 is not used) or metal silicide removal (stage 1003) in the same reactor by chemical vapor deposition (CVD) of a hydrocarbon (e.g., propylene or acetylene) to passivate freshly formed silicon surfaces and suppress re-oxidation during subsequent wet processing. In some implementations, the termination material comprises carbon and is deposited by CVD from a hydrocarbon precursor (e.g., acetylene or propylene) to passivate freshly formed silicon surfaces and reduce oxidation during subsequent processing.

At stage 1005, the metal oxide byproduct (e.g., MgO) is selectively removed from the terminated second intermediate particles. In some implementations, the removal of the metal oxide byproduct is achieved by wet etching to form third intermediate particles. Acid solution such as hydrochloric acid, nitric acid, sulfuric acid, or an organic acid (e.g., acetic or citric acid) may be used. The etching may be carried out, for example, by stirring the particles in 1 M HCl for about 60 minutes, followed by filtration and drying, yielding third intermediate particles that comprise elemental silicon and any retained carbon from prior processing. Residual magnesium compounds, if present, are typically at low levels (e.g., in some designs, less than 2 wt. %; in some designs, less than 1.5 wt. %; in some designs, less than 1 wt. %; in some designs, less than 0.5 wt. %; in some designs, less than 0.2 wt. %, in some designs, less than 0.1 wt. %, yet in some other designs, less than 0.05 wt. %).

Stage 1006 is optional and may be employed to deposit additional silicon on the third intermediate particles obtained from stage 1005 to increase the final silicon content. This deposition can be achieved by CVD of silane, disilane, trisilane, tetrasilane, dichlorosilane, trichlorosilane, tetrachlorosilane, methyl silane, methyl trichlorosilane, or other suitable silicon precursors.

At stage 1007, a protective material is formed (including deposited) on and/or in the third intermediate particles. In some designs, the protective material comprises carbon applied by a CVD process (with or without plasma enhancement) under conditions similar to those used for the termination coating, with hydrocarbon precursors such as acetylene or propylene or ethylene or another suitable hydrocarbon precursor or their combinations. The resulting coating may have an average thickness in the range of about 0.2 to about 50 nm (e.g., in a range of 0.2 nm to 0.5 nm, in a range of 0.5 nm to 1.0 nm, in a range of 1.0 nm to 2 nm, in a range of 2 nm to 5 nm, in a range of 5 nm to 10 nm, in a range of 10 nm to 20 nm, in a range of 20 nm to 30 nm, in a range of 30 nm to 40 nm, or in a range of 40 nm to 50 nm) and may be doped with elements such as boron, nitrogen, phosphorus, or oxygen to tailor electrical conductivity, permeability to electrolyte solvents, and mechanical robustness. The protective coating reduces or prevents direct contact between the silicon and the electrolyte in a lithium-ion battery cell, thereby mitigating continuous SEI formation and improving cycle stability and first-cycle efficiency. The protective coating may (e.g., additionally) comprise a ceramic or ceramic-comprising layer (e.g., a layer comprising a metal or semimetal oxide, fluoride, oxy-fluoride, nitride, oxy-nitride, etc.). In some designs, such a layer may comprise Li-comprising ceramic nanoparticles (e.g., LiF or Li₂O or Li₃N or their various combinations) within its composition. In some designs, such a layer may comprise both carbon and ceramic nanoparticles. Such a ceramic or ceramic-comprising layer may be deposited, for example, by CVD, atomic layer deposition (ALD), plasma-enhanced (PE) CVD, plasma-enhanced ALD, spray pyrolysis or by other suitable means or their combinations.

The sequence of stages shown in FIG. 10A enables production of silicon-carbon (Si—C) composite particles with tunable silicon content, controlled microstructure, and optimized surface passivation. The resulting particles can be tailored to exhibit a Brunauer-Emmett-Teller specific surface area (BET-SSA) in the range of about 0.5 m²/g to 200 m²/g (e.g., in some designs, in a range of about preferably 0.5 m²/g to 5 m²/g; in some designs, in a range of about preferably 5 m²/g to 10 m²/g; in some designs, in a range of about preferably 10 m²/g to 20 m²/g; in some designs, in a range of about preferably 20 m²/g to 50 m²/g; in some designs, in a range of about preferably 50 m²/g to 100 m²/g; in some designs, in a range of about preferably 100 m²/g to 150 m²/g; yet in some other designs, in a range of about 150 m²/g to 200 m²/g; in some preferred designs, less than 20 m²/g; in some other preferred designs, less than 10 m²/g, in some other preferred designs, less than 5 m²/g; in yet some other preferred designs, less than 1 m²/g) and may contain nano-sized silicon particles of about 1 nm to 200 nm (e.g., in some designs, in a range of about 1 nm to 5 nm; in some designs, in a range of about 5 nm to 10 nm; in some designs, in a range of about 10 nm to 20 nm; in some designs, in a range of about 20 nm to 50 nm; in some designs, in a range of about 50 nm to 70 nm; in some designs, in a range of about 70 nm to 100 nm; in some designs, in a range of about 100 nm to 150 nm; yet in some other designs, in a range of about 150 nm to 200 nm) embedded in a conductive carbon matrix. Such particles are particularly suitable for use as high-performance anode active materials in lithium-ion batteries, offering high specific capacity, improved coulombic efficiency, and enhanced cycling stability relative to conventional silicon or silicon-carbon composites prepared using silane-based precursors.

FIG. 10B is a flow diagram of an example sub-process that implements stage 1001 of FIG. 10A to provide precursor particles comprising silicon oxide ((nano)particles) combined with a carbon precursor, and then to pyrolyze the precursor particles to yield the initial particles comprising the silicon oxide embedded within, or coated by, a carbonaceous matrix. In some implementations, the sub-process includes stage 1011, at which SiO₂ (nano)particles are provided together with a carbon precursor compound and are combined to form a composite precursor, and stage 1012, at which the composite precursor is pyrolyzed to convert the carbon precursor into carbon while retaining the silicon oxide. The completion of stages 1011 and 1012 furnishes the initial particles used in subsequent metallothermic reduction steps of FIG. 10A (e.g., stage 1002).

In some designs, the SiO₂—C composite particles comprising SiO₂ nanoparticles may be prepared by (i, Step-1) providing or forming of (a) silicon salts of organic acids or their various derivatives (e.g., acetic acid, succinic acid, propanoic acid, acrylic acid, etc.) or (b) silicon-comprising organic compounds or (c) silicon-based or silicon-comprising polymers or (d) mixtures of silicic acid(s) (e.g., orthosilicic acid, Si(OH)₄, metasilicic acid, SiO(OH)₂, pyrosilicic acid, O(Si(OH)₃)₂, disilicic acid, Si₂O₃(OH)₂, etc.) or other SiO₂ precursors with organic acids or other salts of organic acids or other organic precursor compounds (e.g., polymers), followed by (ii, Step-2) carbonization of such acids, compounds or mixtures in a controlled environment (e.g., nitrogen) at elevated temperatures (e.g., 600-3000° C. for 0.001 sec-48 h, depending on the processing temperatures) to produce porous SiO₂—C nanocomposite(s). In some designs, such an approach may comprise a step of example process 1001 of FIG. 10B, where such Si-comprising organic compounds or their mixtures are further mixed with particles of SiO₂ (e.g., nanoparticles) prior to carbonization (Step-2).

FIG. 10C is a flow diagram of an example process 1020 for making silicon-carbon (Si—C) composite particles from porous silicon dioxide particles. In some implementations, the process 1020 proceeds through stages 1021, 1022, 1012, 1024, 1002, 1003, 1004, 1005, 1006 and 1007. In some implementations, stages 1024, 1003 and 1006 are optional. In process 1020 (FIG. 10C), stages 1021, 1022, 1012 and 1024 (optional) together implement the “provide/prepare feedstock” function of stage 1001 in the process 1000 (FIG. 10A). In the process 1020 (FIG. 10C), stages 1002, 1003, 1004, 1005, 1006, and 1007 correspond directly and respectively to stages 1002, 1003, 1004, 1005, 1006, and 1007 in the process 1000 (FIG. 10A).

At stage 1021, porous silicon dioxide particles are provided as the initial feedstock. The porous silicon dioxide particles may be spheroidal (including almost spherical) or irregularly-shaped (e.g., jagged) silica, such as polydisperse porous silica microspheres having a D₅₀ of about 0.5 μm to about 25.0 μm, or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm, or other porous silica (including silica gels powder or silica gel beads) milled to be less than 20 μm in scale (e.g., less than 1 μm in scale, less than 2 μm in scale, less than 5 μm in scale, less than 7 μm in scale, less than 10 μm in scale, less than 15 μm in scale, or less than 20 μm in scale) and dehydrated by heating to a temperature in a sample range of about 500° C. to about 700° C. (e.g. about 500-550° C., about 550-600° C., about 600-650° C., about 650-700° C.) and holding for a time period in a range of about 0.5 hr to about 2 hr (e.g. about 0.5-1.0 hr, about 1.0-1.5 hr, about 1.5-2.0 hr) under N₂ prior to reduction. The temperature range of this dehydration step can be further extended, from about 635° C. to 900° C., to tune the specific pore volume of porous silica inputs, in one example from about 0.45 cm³/g to 0.10 cm³/g, and thus tune the Si volumetric loading in the final product. The use of porous rather than dense crystalline inputs beneficially moderates structural disruption through metallothermic conversion and byproduct removal. For example, porous silica retains morphology more effectively than quartz during reduction-wash-seal operations. Porous silica inputs can be advantageous because they better accommodate volume changes that occur during metal incorporation and subsequent removal of metal oxides, whereas dense quartz tends to undergo larger morphological changes during the same sequence.

At stage 1022, pores of the silica framework are infiltrated with a carbon precursor. Suitable precursors include polymers and resins that can be intimately mixed with colloidal silica and subsequently solidified within the pore network, as well as metal-organic salts that polymerize or gel in situ and then carbonize. Representative resin/silica mixtures may be prepared in alcoholic media and cured prior to pyrolysis; after curing and size conditioning, the composite is ready for pyrolysis.

At stage 1012, the C-infiltrated silica is pyrolyzed to form SiO₂/C composites particles comprising carbon and the original silica, with the carbon now present as an electrically conductive, often porous. Pyrolysis may be carried out, for example, in an inert atmosphere (e.g., nitrogen) at about 900° C. (in some implementations, the temperature may be in a range of 600 to 3000° C., such as 600-800° C., 800-850° C., 850-900° C., 850-950° C., 900-950° C., 950-1000° C., 1000-1050° C., or 1050-1100° C. or 1100-3000° C.) for a period of about 30 minutes (in some implementations, in a range of 0.001 sec to 24 h, such as 0.001 sec to 10 min, 10 min to 30 min, 30 min to 1 h, 10 min to 1 h, 1 h to 3 h, 3 h to 6 h, 6 h to 12 h, 12 h to 18 h, 18 h to 24 h, or 24 h to 240 h) under nitrogen.

Optional stage 1024 deposits additional carbon to tune electrical conductivity, pore architecture, and surface area. Stage 1024 may be implemented by additional hydrocarbon CVD cycles or by secondary infiltration/pyrolysis protocols that add carbon preferentially to surface-connected pores.

The SiO₂/C composite particles produced at stage 1012 (or at optional stage 1024, when used) are supplied to stage 1002 as the initial particles for stage 1002, after which the process proceeds through stages 1003, 1004, 1005, optional 1006, and 1007 in the same order as in the process 1000 (FIG. 10A) with the same respective implementations and functions.

FIG. 10D is a flow diagram of an example process 1030 for making silicon-carbon (Si—C) composite particles from SiO₂ or SiO₂-comprising particles. In some implementations, the process 1030 proceeds through stages 1031, 1032, 1012, 1002, 1003, 1004, 1005, 1006 and 1007. In some implementations, stages 1012, 1003 and 1006 are optional. In the process 1030 (FIG. 10D), stages 1031, 1032 and optional 1012 together implement the “provide/prepare feedstock” function of stage 1001 in the process 1000 (FIG. 10A). In the process 1030 (FIG. 10D), stage 1012 corresponds directly to stage 1012 in the process 1020 (FIG. 10C). In the process 1030 (FIG. 10D), stages 1002, 1003, 1004, 1005, 1006 and 1007 correspond directly and respectively to stages 1002, 1003, 1004, 1005, 1006, and 1007 in the process 1000 (FIG. 10A).

At stage 1031, SiO₂ or SiO₂-comprising particles are provided as the initial feedstock. Representative SiO₂ or SiO₂-comprising particles include, for example, crystalline quartz powders, porous silica microspheres, and silica gels. The SiO₂ or SiO₂-comprising particles may be spheroidal (including almost spherical) or irregularly-shaped silica, such as silica microspheres having a D₅₀ of about 0.5 μm to about 25.0 μm (or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm), or other silica (including crystalline quartz powders, silica gels powder or silica gel beads) milled to be less than 20 μm in scale (e.g., less than 50 nm in scale, less than 100 nm in scale, less than 200 nm in scale, less than 400 nm in scale, less than 600 nm in scale, less than 800 nm in scale, less than 1 μm in scale, less than 2 μm in scale, less than 5 μm in scale, less than 7 μm in scale, less than 10 μm in scale, less than 15 μm in scale, or less than 20 μm in scale) and dehydrated by heating to a temperature in a sample range of 500° C.-700° C. (e.g. 500° C., 550° C., 600° C., 650° C. or 700° C.) and holding for 1 hour (e.g. 0.5 hour, 1 hour, 1.5 hour or 2 hour) under N₂ prior to reduction.

At stage 1032, a shell made of carbon or a carbon precursor is deposited or formed conformally around the SiO₂ or SiO₂-comprising particles. Suitable carbon precursors include polymers, resins, and metal-organic salts capable of forming electrically conductive, largely sp²-bonded carbon upon pyrolysis. In one implementation, colloidal silica is mixed with a viscous resin to create a composite that, after curing and size-conditioning, is pyrolyzed at stage 1012 under N₂ to yield SiO₂/C composite particles. At stage 1012, pyrolysis can be conducted, for example, at about 900° C. (in some implementations, the temperature may be in a range of 750 to 3000° C., such as 750-800° C., 800-850° C., 850-900° C., 850-950° C., 900-950° C., 950-1000° C., 1000-1050° C., 1050-1100° C. or 1100-3000° C.) for a period of about 30 minutes (in some implementations, in a range of 0.001 sec to 24 h, such as 0.001 sec to 10 min, 10 min to 30 min, 30 min to 1 h, 10 min to 1 h, 1 h to 3 h, 3 h to 6 h, 6 h to 12 h, 12 h to 18 h, or 18 h to 24 h being suitable depending on precursor and particle size). A longer process (e.g., 24 h to 240 h) may also be used in some designs, although it would generally be more expensive and less practical. The weight percent of carbon in the resulting SiO₂/C composite may be tuned. In some implementations, prior to metallothermic reduction, the carbon fraction can be reduced by activating the SiO₂/C composite in CO₂ at about 940° C. (e.g., 800-1050° C.) until the desired mass loss is achieved. In some designs, the weight percent of carbon in SiO₂/C composites was varied from about 10 wt. % to about 65 wt. % (e.g., 10 wt. %, 15 wt. %, 20 wt. %, 30 wt. %, 40 wt. %, 50 wt. %, 60 wt. %, or 65 wt. %).

The SiO₂/C composite particles from stage 1032 (or from optional stage 1012, when used) are supplied to stage 1002 as the initial particles. The process 1030 proceeds through stages 1002, 1003, 1004, 1005, optional 1006, and 1007 in the same order as in the process 1000 (FIG. 10A) with the same respective implementations and functions.

In the example illustrated in FIG. 10E, a plasma-assisted sealing process 1040 is shown for preparing silicon-comprising composite particles suitable for use as anode active material. Process 1040 includes stages 1041 and 1042 that may be carried out in the order indicated by arrows. At stage 1041, a composite comprising silicon (Si) (nano)particles is provided. At stage 1042, a protective layer is formed or deposited on and/or in the composite particles using a plasma process, for example plasma-enhanced chemical vapor deposition (PE-CVD) or PE-ALD. In some designs, the plasma-assisted process may be used to deposit an additional functional layer (e.g., synthetic/artificial SEI) on the already sealed/pre-sealed Si—C composite particles. In some designs, the plasma-assisted processes take place at or near atmospheric pressure (e.g., 1 atm+/−0.2 atm).

At stage 1041, the composite that is provided may include Si nanoparticles (e.g., nanocrystals) dispersed within and/or supported by a carbon matrix, or present as porous Si or nanoporous Si particles integrated with carbon. In some implementations, the Si nanoparticle has an average size ranging from about 1 nm to about 200 nm (e.g., in some designs, from about 1 nm to about 10 nm, in some designs, from about 10 nm to about 30 nm, in some designs, from about 30 nm to about 100 nm, or yet in some other designs, from about 100 nm to about 200 nm), as determined by image analysis of electron microscopy, X-ray techniques, and/or neutron scattering. Such Si—C composites may be obtained, for example, as products of a metallothermic (e.g., magnesiothermic) reduction route in which silica-containing precursors are converted to Si in the presence of a metal reductant, with subsequent removal of metal oxides and optional carbon deposition, yielding Si dispersed in a carbon framework. In some designs, such Si—C composites comprise Si nanoparticles deposited (nucleated and grown) on the surface of other Si nanoparticles or on the surface of carbon (C)-terminated or C-coated other Si nanoparticles.

At stage 1042, a protective layer is formed or deposited using plasma, for example by PE-CVD. The protective material may comprise carbon, metal or semimetal oxide or oxy-carbide (including, but not limited to a silicon oxide or silicon oxy-carbide), or combinations thereof, and may be configured as a largely conformal coating that partially or fully covers external surfaces and selected pore surfaces of the composite. In some designs, an average coating thickness from about 0.2 nm to about 50 nm is preferred (e.g. in some designs, from about 0.2 nm to about 0.5 nm, in some designs, from about 0.5 nm to about 1.0 nm, in some designs, from about 1.0 nm to about 2.0 nm, in some designs, from about 2.0 nm to about 5.0 nm, in some designs, from about 5.0 nm to about 10 nm, in some designs, from about 10 nm to about 20 nm, in some designs, from about 20 nm to about 30 nm, in some designs, from about 30 nm to about 40 nm, yet in some other designs, from about 40 nm to about 50 nm) with true density 0.8 g/cc to about 4.8 g/cc or about 5.8 g/cc (in some designs, from about 0.8 g/cc to about 1.6 g/cc; in other designs, from about 1.6 g/cc to about 3 g/cc; in other designs, from about 3 g/cc to about 4.5 g/cc; in yet other designs, from about 4.5 g/cc to about 4.8 g/cc or about 5.8 g/cc). In some implementations, the carbon may be doped (e.g., B, N, P, O) to tune mechanical, transport, and interphase properties. In some designs, the atomic fraction of individual dopants may range from about 0.01 at. % to about 10.01 at. % (in some designs, from about 0.01 at. % to about 0.1 at. %; in other designs, from about 0.1 at. % to about 1 at. %; in other designs, from about 1 at. % to about 5 at. %; in yet other designs, from about 5 at. % to about 10.01 at. %). Plasma activation can facilitate deposition at reduced substrate temperatures relative to purely thermal CVD, which is advantageous for thermally sensitive composites and for maintaining desirable nanostructuring of Si. In addition, PE-CVD may enable stronger and more robust sealing (protective) layer(s), which is advantageous for both material handling as well as long-term mechanical and electrochemical stability of Si—C composites in batteries. In some designs, the outer surface of the sealing/protective layer may comprise Li compounds (e.g., LiF or Li₂O, etc.) (e.g., in order to enhance electrochemical stability or other electrochemical properties of Si—C composites in batteries).

The protective layer deposited at stage 1042 is configured to reduce or prevent direct exposure of Si surface to electrolyte solvents during battery operation, thereby moderating parasitic reactions, improving first-cycle efficiency, and stabilizing the solid-electrolyte interphase (SEI) during extended cycling. By limiting electrolyte accessibility to high-surface-area features while preserving ionic pathways, the plasma-deposited layer aids in achieving target Brunauer-Emmett-Teller specific surface area (BET-SSA) values of about 0.5-20 m²/g (and, in some cases, about 1-10 m²/g) for the finished composite particles, which are preferred for low first-cycle losses in Li-ion anodes.

In exemplary implementations, hydrocarbon precursors used in thermal CVD sealing (e.g., propylene, acetylene, ethylene, methane, etc.) may be adapted to plasma-assisted deposition to form carbon passivation layers with improved conformity at lower thermal budgets. Alternatively, oxygen-comprising silicon precursors (or combinations of hydrocarbon and oxygen-comprising precursors) may be employed to form silicon oxide-comprising protective materials. Process 1040 is compatible with upstream metallothermic reduction that employs remote metal vapor delivery and oxide removal, providing a plasma-enabled sealing variant that can be inserted after a prior thermal sealing step.

Upon completion of stage 1042, the protected silicon-carbon (Si—C) composite particles may be subjected to conventional downstream handling (e.g., drying, deagglomeration, and optional PSD adjustment) before slurry preparation and electrode casting. When incorporated into blended anodes with graphite, the plasma-sealed composites contribute to achieving targeted electrode-level metrics such as areal capacity loading and binder areal loading appropriate for high-energy Li-ion cells while maintaining acceptable swelling and impedance growth during cycling.

In summary, FIG. 10E presents a compact plasma-assisted sealing pathway in which a provided Si-comprising composite is coated via plasma deposition to afford a controlled protective material around Si (nano)features, complementing the thermally driven sealing approaches elsewhere in this disclosure and enabling attainment of surface-area and interphase properties favorable for long-life, high-energy Li-ion batteries.

FIG. 10F is a flow diagram of process 1050 for producing silicon-carbon composite particles from silicon oxide or silicon oxide-comprising particles (e.g. SiO₂ particles). For correspondence across figures, stage 1031 in process 1050 (FIG. 10F) corresponds to stage 1031 in process 1030 (FIG. 10D), denoting the same operations and ranges of processing conditions as previously disclosed for process 1030 (FIG. 10D). With respect to process 1000 (FIG. 10A), the same stages in process 1050 correspond, respectively, to stages 1002, 1003, 1004, 1005, 1006 and 1007 of process 1000 (FIG. 10A). Stage 1031 of process 1050 is a specific implementation of the “provide initial particles” stage 1001 of process 1000 (FIG. 10A). No further description of these repeated stages is necessary here.

Process 1050 departs from both process 1000 (FIG. 10A) and process 1030 (FIG. 10D) by interposing a pre-MgO removal carbon-integration process after metallothermic reduction between passivation (stage 1004) and oxide removal (stage 1005). Specifically, after metallothermic reduction, optional silicide decomposition/removal, and surface passivation (stages 1002-1004), a carbon-addition stage 1051 unique to process 1050 (FIG. 10F) is executed, followed immediately by an optional pyrolysis at stage 1012, before the metal-oxide removal is carried out at stage 1005.

Stage 1051 deposits or forms a layer made of carbon or a carbon precursor on the second intermediate particles' external surface and/or within their pores. Stage 1012 is needed to pyrolyze the carbon precursor to convert it to carbon if carbon precursor is used at stage 1051. In process 1050, stage 1051 (carbon or carbon precursor addition) and stage 1012 (optional pyrolysis to carbon) are placed after metallothermic reduction stage 1002, not before. This ordering means that the newly introduced carbon phase is deposited into the composite structure while the oxide is present, and only afterward is the oxide removed by the removal operation of stage 1005.

This distinction is significant. In process 1030 (FIG. 10D), stages 1032 and 1012 are nested within the “initial particle preparation” (corresponding to stage 1001) prior to metallothermic reduction, so the carbon is already present when metal reduction occurs. In process 1030 (FIG. 10D), there is no carbon-addition step at all after reduction. However, in process 1050 (FIG. 10F), carbon is deliberately introduced after metallothermic reduction/passivation (stages 1002-1004) and before oxide removal (stage 1005).

This late-stage carbon build confers mechanical compliance and electronically conductive coverage. Subsequent execution of the oxide-removal stage 1005 in process 1050 then removes the metal-oxide phase, leaving behind a silicon-carbon composite whose open porosity reflects the space once occupied by the oxide and whose pore walls are pre-lined with the pyrolyzed carbon. This after-reduction integration of carbon improves coating conformity within internal pore networks, mitigates structural collapse during oxide removal, and furnishes a controllable interfacial area for downstream optional silicon enrichment (stage 1006 of process 1050) and final protective-layer formation (stage 1007 of process 1050).

FIG. 10G illustrates an example process 1060 of making silicon-carbon (Si—C) composite particles from silicon oxide inputs, in which a carbon-addition operation comprising deposition of carbon or a carbon precursor followed by pyrolysis (stages 1051 and 1012) is performed after removal of metal oxides (stage 1005). In some implementations, suitable silicon oxide inputs may include porous or nonporous SiO₂ particles or SiO₂-comprising particles, which may be spheroidal or irregular in morphology, provided at stage 1031. The process then includes metallothermic reduction (stage 1002), optional removal of metal silicide (stage 1003), formation of a termination material on freshly reduced silicon surfaces (stage 1004), selective removal of metal oxides such as MgO (stage 1005), post-leach deposition of a carbon or carbon-precursor layer at the outer surface and/or within accessible pores (stage 1051), optional pyrolysis of carbon precursor, if used at stage 1051, to convert it to carbon (stage 1012), and, in some implementations, optional deposition of additional silicon (stage 1006) and formation of additional protective material(s) (stage 1007). In some designs, stages 1002, 1003, 1004, 1005, 1006, and 1007 are carried out as described elsewhere for the corresponding stages in the process 1000 of FIG. 10A and, therefore, are not repeated here.

Process 1060 differs from process 1050 of FIG. 10F in the relative placement of the carbon-addition operation (stages 1051 and 1012) with respect to the metal-oxide removal (stage 1005). In process 1050 (FIG. 10F), the carbon-precursor deposition and its pyrolysis occur prior to the metal-oxide removal (i.e., pre-leach); by contrast, in process 1060, these two stages (stages 1051 and 1012) occur after the metal-oxide removal at stage 1005 (i.e., post-leach). Apart from this sequencing difference, the remaining stages are the same between processes 1050 (FIG. 10F) and 1060 (FIG. 10G).

Executing stages 1051 and 1012 after stage 1005 in process 1060 yields a set of technical consequences that are distinct from carrying out stages 1051 and 1012 before stage 1005 in process 1050. When stages 1051 and 1012 are executed post-leach stage 1005 (process 1060), the acid-etched third-intermediate particles, which comprise silicon (e.g., as nano-clusters) and carbon with substantially removed MgO, present open pathways for conformal carbon deposition into pore networks that are no longer partially occupied by MgO. The resulting carbon layer can be tailored as a sealing or protective coating on exposed silicon and carbon surfaces and within mesopores, which may facilitate subsequent control of specific surface area (SSA) toward preferred BET-SSA targets, for example 0.5-20 m²/g or 1-20 m²/g or 1-10 m²/g in some designs. Moreover, because oxide has already been removed, the risk of entrapping oxide beneath newly formed carbon is mitigated, which can favor lower residual oxygen in the final product by reducing contributions from incomplete oxide removal. Because stages 1051 and 1012 are carried out after metal-oxide removal at stage 1005, the newly reduced silicon is exposed to the acid leach before any bulk carbon coating is applied. In some embodiments, a termination layer is therefore formed on the silicon immediately after metallothermic reduction (stage 1002) to passivate the reactive surface and limit re-oxidation during the leach. The thicker, sealing carbon layer can then be applied and optimized during stages 1051 and 1012.

By contrast, executing stages 1051 and 1012 before the metal-oxide removal (process 1050) deposits and pyrolyzes the carbon precursor while oxide remains present in the composite. Pre-leach carbon may shield newly formed silicon against re-oxidation during the subsequent acid wash and can reduce exposure of high-energy silicon facets to the liquid environment. However, the presence of a carbon overlayer prior to leaching may impede mass transport of acid into occluded regions or tortuous pores, which in some designs can slow oxide dissolution and increase the likelihood of residual metal-comprising species remaining trapped behind the carbon layer. Such entrapment or hindered access may contribute to elevated residual oxygen contents and higher final BET-SSA unless followed by additional sealing operations and extended process optimization. Consequently, while both sequencing choices are viable, post-leach carbon addition in process 1060 can simplify oxide removal and placement of carbon precisely where it is most effective for surface sealing, whereas pre-leach carbon addition in process 1050 can emphasize protection of silicon during leaching but may require further measures to ensure complete oxide removal and SSA reduction.

In the examples processes 1050 (FIG. 10F) and 1060 (FIG. 10G), metallothermic reduction (1002) is carried out after the providing of silicon-oxide (e.g., SiO₂) particles or silicon-oxide comprising (e.g., SiO₂-comprising) particles (1031). Specifically, the metallothermic reduction can be magnesiothermic reduction, carried out by mixing magnesium particles (e.g., magnesium powder) with the silicon-oxide particles (e.g., silica particles, silica gel) in a mixed-bed implementation. By mixing the magnesium powder and the silica, an average distance for the diffusion of magnesium vapor to the site of its reaction with SiOₓ can decrease. Si—C composite materials (e.g., made according to process 1060 of FIG. 10G) exhibit a dependence of the capacity on the size of the magnesium particles. For example, first cycle reversible capacities were measured in half cells employing Si—C composite materials, synthesized with magnesium particles of respective sizes. Si—C composite materials synthesized using magnesium particles of average linear dimension of about 5 mm (with a Mg to SiO₂ molar ratio of about 1.9) exhibited a first cycle reversible capacity of about 1161 mAh/g (measured relative to mass of the active Si—C composite material). On the other hand, Si—C composite materials synthesized with magnesium particles of an average linear dimension of 2 mm (with a Mg to SiO₂ molar ratio of about 1.9) exhibited a first cycle reversible capacity of about 1478 mAh/g (measured relative to mass of the active Si—C composite material). This corresponds to an increase in the first cycle reversible capacity of about 27%, from reducing the magnesium particle size from about 5 mm to about 2 mm. Furthermore, when the Mg to SiO₂ molar ratio was increased from 1.9 to 2.5, the first cycle reversible capacity increased from about 1478 mAh/g to about 1756 mAh/g (corresponding to an increase of about 19%. Accordingly, decreasing the size of the Mg particles (e.g., decreasing the Mg vapor diffusion distances) and increasing the molar ratio of Mg to SiOₓ can result in higher Si mass fractions in the composite material, as exemplified in the higher first cycle reversible capacities.

However, magnesium particles that are too small can be difficult to handle in the reduction process. The sublimation rate scales with R⁻² (R is the linear size dimension); accordingly, as the Mg particle size is decreased from the mm scale to the μm scale, the sublimation rate increases significantly. In some cases, using a higher pressure (which lowers the sublimation rate) and/or a lower temperature (which lowers the sublimation rate) for magnesiothermic reduction can compensate for the high sublimation rate resulting from small Mg particle sizes. Furthermore, nitride formation and oxide formation have a greater effect on sublimation when very small Mg particles are employed, because the magnesium nitrides and magnesium oxides account for a larger fraction of the surface area of the very small Mg particles. In some examples, Mg particles (approximate size 45 μm) were found to convert to Mg₃N₂ around 600° C. in N₂ at 1 Torr. In some implementations, magnesiothermic reduction can be carried out under the following conditions: (1) Mg particle size in a range of about 100 μm to about 200 μm (e.g., about 100-120 μm, about 120-140 μm, about 140-160 μm, about 160-180 μm, or about 180-200 μm); (2) pressure in a range of about 10 to 20 Torr (e.g., about 10-12 Torr, about 12-14 Torr, about 14-16 Torr, about 16-18 Torr, or about 18-20 Torr); temperature in a range of 550 to 650° C. (e.g., about 550-570° C., about 570-590° C., about 590-610° C., about 610-630° C., or about 630-650° C.). In some implementations, magnesiothermic reduction can be carried out under the following conditions: (1) Mg particle size in a range of about 140 μm to about 160 μm (e.g., about 150 μm); (2) pressure in a range of about 14 to 16 Torr (e.g., about 15 Torr); temperature in a range of 590 to 610° C. (e.g., about 600° C.).

FIG. 10H is a flow diagram showing a sample process 1070 that begins with composite particles comprising silicon (e.g., nanostructured or nano-sized) and proceeds to form or deposit an artificial solid-electrolyte-interphase-like (“artificial SEI-like”) layer on such Si-comprising composite particles to yield particles having the artificial SEI-like layer.

In some implementations, the composite provided at stage 1041 includes silicon-carbon particles obtained, at least in part, by metallothermic reduction of silicon oxide followed by removal of metal-comprising byproducts and passivation or sealing with a carbonaceous protective material. For example, magnesiothermic reduction can be conducted under low pressure in the presence of a hydrogen-inert carrier to suppress silicon re-oxidation, followed by washing (e.g., in hydrochloric acid) to remove MgO, and optional passivation with a hydrocarbon-derived carbon layer; such processing yields Si-comprising composite particles suitable for subsequent surface engineering (e.g., artificial SEI-like layer formation). The disclosure describes such reduction, washing, and carbon passivation operations and the resulting Si-comprising composites that can exhibit controlled Brunauer-Emmett-Teller specific surface area (BET-SSA), rendering them appropriate inputs to stage 1071.

The artificial SEI-like layer (a layer that reduces electrolyte decomposition on the anode surface during one or more cycles, including but not limited to operation at different temperatures, including, in some instances, elevated temperatures; e.g., 30-90° C.) may be formed or deposited at stage 1071 by dry, wet, or hybrid surface-chemistry techniques adapted to coat silicon-carbon composites conformally without materially degrading the underlying carbon passivation. Illustrative non-limiting approaches include chemical vapor deposition or plasma-enhanced chemical vapor deposition using suitable gaseous precursors, atomic-layer-type growth processes, and solution or sol-gel processes that yield inorganic or organo-inorganic conversion layers. In some designs, such a layer may comprise inorganic Li salts or compounds. In some designs, such a layer may comprise LiF. In some designs, such a layer may comprise Li₂O nanoparticles. In some designs, such a layer may comprise Li₃N nanoparticles. In some designs, at least components of such a layer, may be formed, in part, by chemical lithiation (e.g., by a suitable wet or solid state or dry process) followed by another process (e.g., partial oxidation or conversion in a gaseous or another layer deposition). Formation parameters are selected to maintain desirable surface area targets (e.g., low to moderate BET-SSA) and to mitigate first-cycle losses associated with native SEI formation on high-surface-area anodes. Consistent with the disclosure, sealing or passivation operations that reduce accessible surface area are expressly used to minimize first-cycle lithium losses and improve first-cycle efficiency. The artificial SEI-like layer of FIG. 10H is implemented with that same objective and can be used in addition to or in place of other protective-material operations described elsewhere.

The artificial SEI-like layer at stage 1071 is configured to improve electrochemical performance of the composite particles when used as an anode active material in a lithium-ion cell and, in particular, to reduce irreversible lithium consumption during an initial charge (lithiation) and to stabilize the particle/electrolyte interphase during subsequent cycling.

Metrology and quality control for process 1070 in FIG. 10H may include verifying phase composition by X-ray diffraction, measuring oxygen content by instrumental gas analysis, and assessing surface area and porosity by BET analysis of nitrogen sorption isotherms. These methods are expressly described for similar materials and are equally applicable to confirming that the artificial SEI-like layer meets design specifications while maintaining the desired internal architecture of the composite.

FIG. 10I is a flow diagram showing a sample process 1080 that begins with composite particles comprising silicon (e.g., nanostructured or nano-sized) (stage 1041), and proceeds to partially lithiate the composite particles to yield partially lithiated composite particles (stage 1081). Stage 1041 in process 1080 (FIG. 10I) is identical to stage 1041 in process 1070 (FIG. 10H). Accordingly, the description of stage 1041 provided with respect to process 1070 applies equally to process 1080 and is not repeated here.

At stage 1081, the partial lithiation may be effected metallurgically, chemically, or electrochemically and is configured to improve electrochemical performance (e.g., to reduce lithium losses during the initial charge and/or during the subsequent operation) by pre-consuming, in a controlled fashion, a portion of the lithium otherwise consumed to form a passivating interphase and/or by preconditioning the silicon-comprising phase toward a lithiated state that stabilizes subsequent cycling.

In some implementations, the degree of partial lithiation at stage 1081 is selected in view of the specific surface area and porosity of the composite, recognizing that first-cycle irreversibility correlates with anode surface area due to SEI formation. By tailoring the extent of lithiation at stage 1081 relative to particle morphology produced by the upstream reduction, washing, and sealing operations, the prelithiation can offset anticipated lithium consumption and thereby increase first-cycle efficiency while preserving mechanical integrity of the composite. Reducing the accessible surface area of the anode material, for example, by sealing the surface with carbon, reduces first-cycle losses and greatly improves cycle stability by minimizing the contact of electrolyte and volume changing material(s). Partial lithiation performed at stage 1081, which yields the partially lithiated Si-comprising composite particles, complements this approach by pre-supplying lithium to the anode material prior to cell formation and initial cycling.

The silicon-comprising composite particles used as inputs at stage 1041 of process 1070 (FIG. 10H) and process 1080 (FIG. 10I) may be the same class of particles described elsewhere in this disclosure, including silicon-carbon composites made by metallothermic reduction of silica-based inputs followed by acid washing and carbon sealing, and exhibiting BET-SSA within specified ranges.

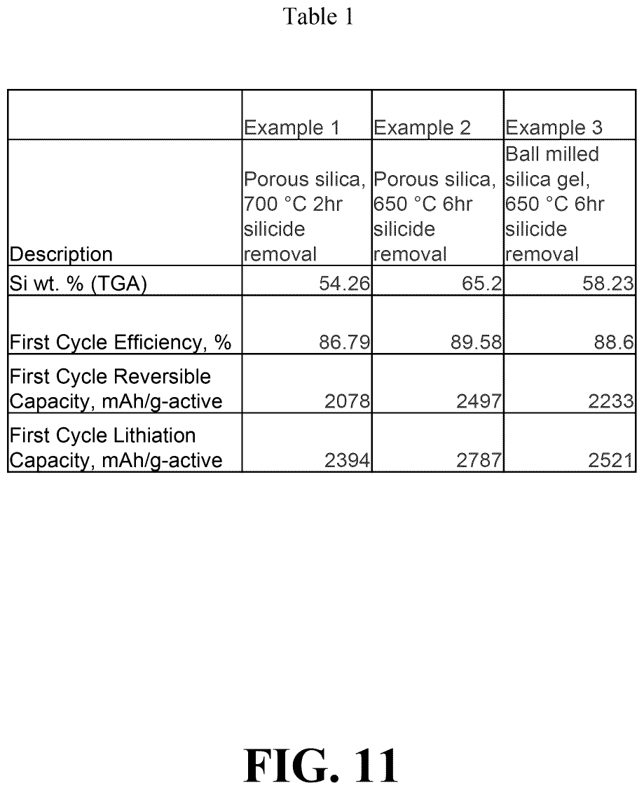

FIG. 11 (Table 1) shows the silicon mass fraction of certain Si—C composite particles and selected electrochemical testing (ECT) results of half-cells comprising those Si—C composite particles. Results for three examples of Si—C composite particles are shown. These Si—C composite particles were synthesized according to process 1060 (FIG. 10G) in which stages 1012, 1006, and 1007 are omitted. At stage 1031, the starting materials were: for the first and second example particles, porous silica microspheres, and for the third example particles, silica gel that was ball milled to a particle size of less than about 20 μm. For stage 1002, magnesiothermic reduction was carried out using Mg particles of about 150 μm in size, under the following conditions: about 600° C., about 15 Torr, and 8 hr in Ar. At stage 1003, the silicide removal anneal is carried out as follows: (1) for the first example particles, at about 700° C., about 1 Torr, about 2 hr in Ar; (2) for the second example particles, at about 650° C., about 1 Torr, about 6 hr in Ar; and (3) for the third example particles, at about 650° C., about 1 Torr, about 6 hr in Ar. At stage 1004, carbon-based termination material was formed by depositing carbon from 33% propylene in N₂ at 630° C. for a period of 1 h, at 760 Torr. At stage 1005, MgO was removed by etching material with 1M HCl for 60 min. At stage 1051, carbon-based material was formed by depositing carbon from 33% propylene in N₂ at 630° C. for a period of 26 h, at 760 Torr.

For each of the three example particles, Table 1 reports: the Si mass fraction, as determined by thermogravimetric analysis (TGA), in wt. %; the first-cycle efficiency (FCE), in %; the first-cycle reversible capacity, in mAh/g of active material; and the first-cycle lithiation capacity, in mAh/g of active material. For example particles, the Si mass fraction is estimated to be in a range of about 54 to about 65 wt. %, the rest being largely carbon (C) and small amounts of the remaining impurities (e.g., oxygen, O).

The process of estimating the Si mass fraction of Si—C composite particles by TGA is as follows. The sample of Si—C composite particles is dried and weighed before the heating protocol (the mass of the sample is referred to as msample). The sample (e.g., Si—C(nano)composite particles) undergoes a heating protocol in an oxidizing environment using a TGA instrument. In one example, the heating protocol is as follows: ramp from room temperature to a maximum temperature of 900° C. in air at a ramp rate of 40° C./min, hold at 900° C. for a heating period at maximum temperature of 60 min, and cool to 80° C. This heating protocol is sufficient to yield combustion of the carbon and conversion of the silicon to SiO₂. Other examples of heating protocols that may be employed include: (1) a maximum temperature in a range of about 900° C. to 1200° C. (e.g., 900° C., 1000° C., 1100° C., 1200° C.); (2) a ramp rate of not more than 20° C./min or in a range of 20° C./min to 50° C./min (e.g., 10° C./min, 20° C./min, 30° C./min, 40° C./min, 50° C./min); and (3) a heating period (at maximum temperature) in a range of 1 hour to 12 hours (e.g., 60 min, 2 hr, 4 hr, 8 hr, 12 hr). In some implementations, higher maximum temperatures and/or longer heating periods may provide even greater confidence that any carbides that are present (e.g., silicon carbides) will be fully oxidized and that all of the silicon nodes will be fully oxidized. Additionally, instead of cooling the furnace to 80° C., the furnace may be cooled to any temperature below 200° C. before the crucible is taken out. After the heating protocol, the residual ash, which is presumed to be substantially SiO₂ (e.g., SiO₂ mass fraction is at least 99 wt. %), is weighed (e.g., the mass of the ash mash is calculated as the mass of the crucible (sample holder) subtracted from the mass of the crucible and the ash, after the heating protocol). The mass fraction of Si in the Si—C (nano)composite particles w is estimated as follows:

$$w = \frac{{m}_{ash}}{{m}_{sample}} \frac{{M}_{Si}}{{M}_{SiO 2}} . \qquad ( Formula 1 )$$

Here, M_{Si} is the atomic mass of silicon (28.09) and M_{SiO2} is the molecular mass of SiO₂ (60.09). This calculation, which converts the mass of the ash to an estimated mass of Si before the TGA, assumes that (1) the content of oxidized silicon in the Si—C (nano)composite particles before the TGA is quite low (e.g., the content of oxidized silicon in the composite particles is 1 wt. % or lower), (2) the Si in the Si—C (nano)composite particles is substantially converted to SiO₂ during the TGA's heating protocol (e.g., at least 99 wt. % of the Si is converted to SiO₂), and (3) the residual ash is substantially SiO₂ (e.g., the SiO₂ is 99 wt. % or more of the residual ash). In some implementations, the content of oxidized silicon in the Si—C(nano)composite particles is indeed quite low; however, it is possible to quantify the oxygen content in a sample before the heating procedure using instrumental gas analysis (IGA) or another suitable technique, to correct for the presence of oxygen in the sample.

The first-cycle lithiation capacity is determined in a half cell by lithiating the anode comprising the Si—C composite particles as the active material at a constant current density of about 0.1 C to about 0.01 V vs. Li/Li⁺ followed by taper till the current density decreases to about 0.01 C. In this calculation, only the mass of the active material (e.g., Si—C composite particles) is included; inactive and other materials such as the binder and the anode current collector are excluded. In the examples shown, the first-cycle lithiation capacity was in a range of about 2394 mAh/g (corresponding to a Si mass fraction of about 54 wt. %) to about 2787 mAh/g (corresponding to a Si mass fraction of about 65 wt. %).

The first-cycle reversible capacity is determined in a half cell by lithiating the anode (according to the protocol outlined above for the first-cycle lithiation capacity), followed by delithiation at a constant current density of about 0.1 to about 1.5 V vs. Li/Li⁺. In this calculation, only the mass of the active material (e.g., Si—C composite particles) is included; inactive and other materials such as the binder and the anode current collector are excluded. In the examples shown, the first-cycle reversible capacity was in a range of about 2078 mAh/g (corresponding to a Si mass fraction of about 54 wt. %) to about 2497 mAh/g (corresponding to a Si mass fraction of about 65 wt. %).

The first-cycle efficiency is obtained by dividing the first-cycle reversible capacity by the first-cycle lithiation capacity. In the examples shown, the first-cycle efficiencies were in a range of about 86.79% to about 89.58%. Accordingly, the synthesis pathway outlined herein, including the improved silicide-removal anneal stage (1003) can be employed to obtain Si—C composite particles that are characterized by first-cycle reversible capacities and first-cycle efficiencies that are quite high.

It is possible that the silicide-removal anneal stage (1003) has an additional effect of modifying the microstructure of the Si—C composite particles, such as closing off open pores to form closed pores and increase trapped porosity. In some implementations, Si—C composite particles that have had the silicide-removal anneal stage exhibit notably smaller BET-SSA values than Si—C composite particles that have not had any silicide-removal anneal. Since the BET-SSA values are measured by nitrogen gas adsorption and desorption, BET-SSA values do not account for areas that are not accessible by nitrogen gas, such as closed pores. Si—C composite particles formed (e.g., according to process 1060) from porous silica by magnesiothermic reduction at a temperature of about 600° C., with silicide-removal anneal at 650° C. and without any silicide-removal anneal, were compared. Both samples of Si—C composite particles underwent carbon termination (stage 1004). In each case, after removal of metal oxide (stage 1005) the carbon deposition (stage 1051) was continued until BET-SSA values of less than about 10 m²/g. In the case of Si—C composite particles without any silicide-removal anneal, the change in mass of the Si—C composite particles, resulting from C deposition, was in a range of about 120 to about 140 wt. %. On the other hand, in the case of Si—C composite particles with the silicide-removal anneal, the change in mass of the Si—C composite particles, resulting from C deposition, was in a range of about 40 to about 50 wt. %.

### EXPERIMENTAL SECTION

### Materials

(1) Crystalline Quartz powder was purchased from Sigma-Aldrich (Silicon dioxide, item number: S5631). As reported by the manufacturer, this crystalline quartz powder primarily contains particles in a size range of about 0.5 to about 10 μm (approximately 80% are in a range of 1 to 5 μm). The crystalline quartz powder was used for magnesiothermic reduction, acid washing, and CVD-carbon sealing process steps, the results of which are shown in FIGS. 7A and 7B. (2) Porous, polydisperse silica microspheres were purchased from Cospheric LLC (item number: SiO2MS-2.2 1-6 um). As reported by the manufacturer, the density is about 2.2 g/cc and the D₅₀ is in a range of 2 to 4 μm. The silica microspheres were used for magnesiothermic reduction, acid washing, and CVD-carbon sealing process steps, the results of which are shown in FIGS. 8A and 8B. (3) Silica gel was purchased from the respective vendors. Silica gel powder (“technical grade, pore size 60A”, 230-400 mesh) was purchased from MilliporeSigma (item number: 717185). White silica gel beads (0.3-1 mm diameter) were purchased from the IMPAK Corporation (item number: 639AG05GM1648). (4) For the synthesis of C—SiO₂ composites, Furolite Resin 120621 was obtained from Transfurans Chemicals as the C precursor, and a colloidal silica dispersion (70-100 nm particles, 30 weight % in isopropanol) was obtained from Nissan Chemical America Corporation (item number: IPA-ST-ZL) as the SiO₂ source. Mg turnings (˜4 mesh, 99.98%) were purchased from Thermo Scientific (item number: 036193.18). Mg powder (˜20+100 mesh) was purchased from Thermo Fisher Scientific Chemicals, Inc. (item number: AA00869A1).

### Preparation of SiO₂—C Composites

Approximately 32 g colloidal silica dispersion and 32 g of resin were mixed in 5 g ethanol in a glass vessel using a vortex mixer. The liquid was then allowed to evaporate for approximately 48-72 hours. The resin was then cured at 220° C. for 2 h on a hotplate then 200° C. for 2 h in a vacuum oven (<100 mTorr). The resulting material was broken into cm-scale pieces with a hammer, then reduced to mm-scale pieces with a hammer mill. This material was then pyrolyzed under N₂ in a tube furnace at 900° C. for 30 min. This results in a composite composed of 38-45 wt. % SiO₂ and 55-62 wt. % C. The C weight % can be reduced by activation of the composite in CO₂ at 940° C. (the activation may be carried out in a temperature range of 800-1050° C.) until the desired mass loss is achieved.

### Preparation of Silica Gel for Reduction

Prior to reduction, silica gel input materials were (1) milled to produce particles with sizes of less than about 20 μm, and (2) were dehydrated by heating to about 600° C. and holding for 1 hr under N₂. The details of the procedure varied by the specific silica gel input material. “Technical grade, pore size 60A” silica gel powder was first ball milled using 6.26 mm zirconia milling media (˜145 g media with ˜7.5 g of silica gel) and then heated to about 600° C. for 1 h under N₂ to dehydrate. White silica gel beads were first heated to 600° C. for 1 h under N₂, and then milled using a Hosokawa Alpine PicoLine with a PicoJet jet milling attachment, set to a classifier speed of 20,000 rpm.

Magnesiothermic Reduction of SiO₂ and SiO₂—C Composites

We performed magnesiothermic reduction of silica in a Nacci tube furnace (Mellen, USA) with a 50×150 mm hot zone. Mg vapor diffusion to the reaction interface between the vapor and silica controls the whole reaction process. For remote Mg source reduction Mg pellets were located on the bottom of the stainless steel boat and silica was placed on top of the stainless steel mesh roughly a few mm away from Mg pellets. Mg and silica were loaded with 50% magnesium excess over the stoichiometric chemical ratio in Reaction 1. To increase the mean free path of Mg vapor and help uniform Mg vapor distribution reaction was carried at low pressure, below 1 Torr. 100 sccm of 5% H₂ in N₂ was flown through tube furnace to avoid Si re-oxidation. Reaction was carried in the temperature range 600-700° C. for 0.5-8 hours. Freshly created Si surfaces were passivated with carbon layer by flowing 33% propylene in N₂ at 630° C. for 0.5 h. The presence and amount of Si was verified by XRD.

Magnesiothermic reduction with −20+100 mesh Mg powder was performed by mixing the Mg powder with the silica input (silica microspheres or silica gel). The Mg/silica mixture is then placed in a stainless steel boat and heated in a Nacci tube furnace (Mellen, USA), with a 50×150 mm hot zone, under 200 sccm Ar at a pressure of 15 Torr to 600° C. and held for 6 h. The powder is then annealed (to promote decomposition of Mg₂Si) at a pressure below 1 Torr, either at 650° C. for 6 h or at 700° C. for 2 h. A C termination (passivation) layer is then applied to the powder by flowing 200 sccm of C₃H₆ with 400 sccm of N₂ at 630° C. for 30 min.

Magnesia Removal after Reduction

The primary byproduct of the reaction, MgO, was removed by hydrochloric acid, HCl. Typically, powder was stirred in a glass flask for 60 min in 1M HCl and then filtered through 0.45 μm PVDF filter (Millipore, USA) using a vacuum pump. After drying at room temperature overnight powder was collected and absence of MgO was verified by XRD (Rigaku Miniflex).

### Sealing—Battery Electrode Surface Area Reduction

First cycle losses in LIB are correlated to anode specific surface area (SSA) due to solid electrolyte interphase (SEI) layer formation. Therefore, to minimize first cycle losses FCL and improve first cycle efficiency FCE, highly porous materials may be sealed off. We used carbon sealing, depositing carbon from 33% propylene in N₂ at 630° C. for a period of 18 to 26 h. This carbon sealing stage corresponds to stage 1004. Final BET-SSA was verified by nitrogen gas sorption.

Analysis of Phase Composition from X-Ray Diffraction

Powder X-ray diffraction measurements were performed on a Rigaku Miniflex configured in a Bragg-Brentano geometry. Phase composition (in weight %) was then calculated from the XRD spectra using the Toraya direct derivation (DD) method integrated in Match! software.

Analysis of O Content with Instrumental Gas Analysis (IGA)

The weight % oxygen in intermediate and final products was measured using a LECO ONH836 elemental analyzer with argon as a carrier gas. The system was calibrated daily using a JCRM R 025 standard prior to any O measurements. Three replicate measurements with 20-25 mg of sample each were performed with 4000 W of heating power and a graphite crucible, with no flux, nickel nibbles, nor graphite additives.

### BET Analysis of Final Surface Area

Specific surface area (SSA) was calculated from application of the Brunauer-Emmet-Teller (BET) method to N₂ physisorption isotherms measured at 77 K using a MICROMERITICS TRISTAR II 3020 (software version 3.02). Prior to the gas sorption measurement, powder samples were degassed under low vacuum (>380 mTorr) for 1 hr at 300° C. During measurement, N₂ is introduced into the sample cell at 77 K and adsorbed to the sample by primarily van der Waals forces, and the adsorbed amount of N₂ is measured as a function of relative pressure p/p₀ (where p₀ is the saturation pressure of N₂). Both adsorption and desorption isotherms are measured, with the resulting hysteresis giving information on the pore network structure. Porosity regimes are defined by the IUPAC as follows: micropores: pore widths of <2 nm, mesopores: pore widths in a range of 2 to 50 nm, and macropores: pore widths >50 nm. Accurate micropore measurements typically require lower pressures (p/p₀<104) and/or the use of other adsorbate gasses (Ar, CO₂) for analysis. Thus, micropore volumes are estimated by these N₂ isotherms. Further, since pores of pore sizes >400 nm cannot be probed using N₂ physisorption, accurate characterization of macropores of pore sizes greater than 400 nm requires other techniques, such as mercury porosimetry, which has not been considered here. Accordingly, the pore volume fractions discussed herein are estimates based on N₂ physisorption. The Brunauer-Emmet-Teller (BET) method was used to extract the SSA of the materials from the linear regime of a 1/[n((p₀/p)−1)] vs. p/p₀ plot (typically in the relative pressure range 0.05-0.3) using the BET equation (Equation 1):

$$\frac{\frac{p}{{p}_{0}}}{n ( 1 - \frac{p}{{p}_{0}} )} = \frac{1}{{n}_{m} C} + \frac{C - 1}{{n}_{m} C} ( \frac{p}{{p}_{0}} ) \qquad ( Equation 1 )$$

where p/p₀ is the relative pressure, n is the amount of adsorbed N₂ [mol/g], C is a constant (calculated from this linear fit), and nₘ is the BET monolayer capacity [mol/g] (also calculated from this linear fit). The SSA is then calculated from the following Equation 2:

$$S = {n}_{m} \cdot {N}_{a} \cdot σ \qquad ( Equation 2 )$$

where Nₐ=Avogadro's number an σ is the cross-sectional area of N₂.

### Scanning Electron Microscopy

Scanning electron microscope (SEM) images were collected using a Zeiss Sigma operating with a 1 kV accelerating voltage and InLens detector.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of making silicon-carbon composite particles, the method comprising: (A1) providing a mixture of silicon oxide particles and a carbon precursor compound; (A2) pyrolyzing the mixture to form first intermediate particles comprising carbon and the silicon oxide particles; (A3) carrying out magnesiothermic reduction on the first intermediate particles in the presence of magnesium vapor to form second intermediate particles comprising the carbon, magnesium oxide, and silicon particles; (A4) selectively removing the magnesium oxide from the second intermediate particles to form third intermediate particles; and (A5) forming a protective material on and/or in the third intermediate particles to form the silicon-carbon composite particles.

Clause 2. The method of clause 1, wherein: the silicon oxide particles comprise silicon dioxide particles.

Clause 3. The method of any of clauses 1 to 2, wherein: the silicon oxide particles have an average size in a range of about 50 nm to about 10 μm.

Clause 4. The method of any of clauses 1 to 3, wherein: the carbon precursor compound is a polymer.

Clause 5. The method of any of clauses 1 to 4, wherein: the carbon precursor compound is a resin or an organic acid or a salt of an organic acid.

Clause 6. The method of any of clauses 1 to 5, wherein: the selectively removing comprises etching the second intermediate particles with an acid.

Clause 7. The method of any of clauses 1 to 6, further comprising: (B1) carrying out chemical vapor deposition of a carbon material from a hydrocarbon precursor on the second intermediate particles.

Clause 8. The method of any of clauses 1 to 7, wherein: the protective material comprises carbon.

Clause 9. The method of any of clauses 1 to 8, wherein: the silicon-carbon composite particles exhibit a Brunauer-Emmett-Teller specific surface area (BET-SSA) in a range of about 0.5 to about 20 m²/g.

Clause 10. The method of any of clause 9, wherein: the BET-SSA is in a range of about 1 to about 10 m²/g.

Clause 11. The silicon-carbon composite particles made according to the method of any of clauses 2 to 10.

Clause 12. A Li-ion rechargeable battery, comprising: an anode comprising the silicon-carbon composite particles of clause 11; a cathode; and an electrolyte ionically coupling the anode and the cathode.

Additional implementation examples are described in the following numbered Additional Clauses:

Additional Clause 1: A method of making silicon-carbon composite particles, the method comprising: (A1) carrying out metallothermic reduction on initial particles comprising silicon oxide in the presence of a metal to form first intermediate particles comprising (1) an oxide of the metal and (2) elemental silicon; (A2) forming a termination material on and in the first intermediate particles to form second intermediate particles; (A3) selectively removing the oxide of the metal from the second intermediate particles to form third intermediate particles; and (A4) forming a protective material on and in the third intermediate particles to form the silicon-carbon composite particles.

Additional Clause 2: The method of Additional Clause 1, wherein: the metal comprises magnesium or a magnesium-aluminum alloy.

Additional Clause 3: The method of any of Additional Clauses 1 to 2, wherein: the metal is in vapor form during the metallothermic reduction (A1).

Additional Clause 4: The method of any of Additional Clauses 1 to 3, further comprising: (B1) forming a mixture of particles of the metal and the first intermediate particles, wherein: the forming of the mixture (B1) is carried out before the carrying out of the metallothermic reduction (A1).

Additional Clause 5: The method of any of Additional Clauses 1 to 4, wherein: the silicon oxide comprises silicon dioxide.

Additional Clause 6: The method of any of Additional Clauses 1 to 5, wherein: the silicon oxide is present as silicon oxide particles having an average size in a range of about 50 nm to about 10 μm.

Additional Clause 7: The method of any of Additional Clauses 1 to 6, further comprising: (B2) pyrolyzing precursor particles to form the initial particles, the initial particles additionally comprising carbon, the precursor particles comprising the silicon oxide and a carbon precursor.

Additional Clause 8: The method of any of Additional Clauses 1 to 7, wherein: the carbon precursor is a polymer.

Additional Clause 9: The method of any of Additional Clauses 1 to 8, wherein: the carbon precursor is a resin.

Additional Clause 10: The method of any of Additional Clauses 1 to 9, wherein: the first intermediate particles additionally comprise magnesium silicide; and the method further comprises: (B3) annealing the first intermediate particles to remove the magnesium silicide from the first intermediate particles.

Additional Clause 11: The method of any of Additional Clauses 1 to 10, wherein: the termination material comprises carbon.

Additional Clause 12: The method of any of Additional Clauses 1 to 11, wherein: the forming of the termination material (A2) comprises chemical vapor deposition of the carbon from a hydrocarbon precursor.

Additional Clause 13: The method of any of Additional Clauses 1 to 12, wherein: the hydrocarbon precursor is selected from acetylene and propylene.

Additional Clause 14: The method of any of Additional Clauses 1 to 13, wherein: the termination material comprises a silicon oxide.

Additional Clause 15: The method of any of Additional Clauses 1 to 14, wherein: the forming of the termination material (A2) comprises carrying out oxidation of the elemental silicon of the first intermediate particles.

Additional Clause 16: The method of any of Additional Clauses 1 to 15, wherein: the selectively removing (A3) comprises etching the second intermediate particles with an acid.

Additional Clause 17: The method of any of Additional Clauses 1 to 16, wherein: the protective material comprises carbon.

Additional Clause 18: The method of any of Additional Clauses 1 to 17, wherein: the forming of the protective material (A4) comprises chemical vapor deposition of the carbon from a hydrocarbon precursor.

Additional Clause 19: The method of any of Additional Clauses 1 to 18, wherein: the hydrocarbon precursor is selected from acetylene and propylene.

Additional Clause 20: The method of any of Additional Clauses 1 to 19, wherein: the silicon-carbon composite particles exhibit a Brunauer-Emmett-Teller specific surface area (BET-SSA) in a range of about 0.5 to about 20 m²/g.

Additional Clause 21: The method of any of Additional Clauses 1 to 20, wherein: the BET-SSA is in a range of about 1 to about 10 m²/g.

Additional Clause 22: The method of any of Additional Clauses 1 to 21, further comprising: (B4) depositing silicon on the third intermediate particles.

Additional Clause 23: The method of any of Additional Clauses 1 to 22, wherein: the depositing of the silicon (B4) comprises chemical vapor deposition (CVD) of the silicon.

Additional Clause 24: The silicon-carbon composite particles made according to the method of any of Additional Clauses 1 to 23.

Additional Clause 25: A Li-ion rechargeable battery, comprising: an anode comprising the silicon-carbon composite particles of any of Additional Clauses 1 to 24; a cathode; and an electrolyte ionically coupling the anode and the cathode.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A method of making silicon-carbon composite particles, the method comprising:
(A1) carrying out metallothermic reduction on initial particles comprising silicon oxide in the presence of a metal to form first intermediate particles comprising (1) an oxide of the metal and (2) elemental silicon;
(A2) forming a termination material on and in the first intermediate particles to form second intermediate particles;
(A3) selectively removing the oxide of the metal from the second intermediate particles to form third intermediate particles; and
(A4) forming a protective material on and in the third intermediate particles to form the silicon-carbon composite particles.

2. The method of claim 1, wherein:
the metal comprises magnesium or a magnesium-aluminum alloy.

3. The method of claim 1, wherein:
the metal is in vapor form during the metallothermic reduction (A1).

4. The method of claim 1, further comprising:
(B1) forming a mixture of particles of the metal and the first intermediate particles,
wherein:
the forming of the mixture (B1) is carried out before the carrying out of the metallothermic reduction (A1).

5. The method of claim 1, wherein:
the silicon oxide comprises silicon dioxide.

6. The method of claim 1, wherein:
the silicon oxide is present as silicon oxide particles having an average size in a range of about 50 nm to about 10 μm.

7. The method of claim 1, further comprising:
(B2) pyrolyzing precursor particles to form the initial particles, the initial particles additionally comprising carbon, the precursor particles comprising the silicon oxide and a carbon precursor.

8. The method of claim 7, wherein:
the carbon precursor is a polymer.

9. The method of claim 7, wherein:
the carbon precursor is a resin.

10. The method of claim 1, wherein:
the first intermediate particles additionally comprise magnesium silicide; and
the method further comprises:
(B3) annealing the first intermediate particles to remove the magnesium silicide from the first intermediate particles.

11. The method of claim 1, wherein:
the termination material comprises carbon.

12. The method of claim 11, wherein:
the forming of the termination material (A2) comprises chemical vapor deposition of the carbon from a hydrocarbon precursor.

13. The method of claim 12, wherein:
the hydrocarbon precursor is selected from acetylene and propylene.

14. The method of claim 1, wherein:
the termination material comprises a silicon oxide.

15. The method of claim 14, wherein:
the forming of the termination material (A2) comprises carrying out oxidation of the elemental silicon of the first intermediate particles.

16. The method of claim 1, wherein:
the selectively removing (A3) comprises etching the second intermediate particles with an acid.

17. The method of claim 1, wherein:
the protective material comprises carbon.

18. The method of claim 17, wherein:
the forming of the protective material (A4) comprises chemical vapor deposition of the carbon from a hydrocarbon precursor.

19. The method of claim 18, wherein:
the hydrocarbon precursor is selected from acetylene and propylene.

20. The method of claim 1, wherein:
the silicon-carbon composite particles exhibit a Brunauer-Emmett-Teller specific surface area (BET-SSA) in a range of about 0.5 to about 20 m²/g.

21. The method of claim 20, wherein:
the BET-SSA is in a range of about 1 to about 10 m²/g.

22. The method of claim 1, further comprising:
(B4) depositing silicon on the third intermediate particles.

23. The method of claim 22, wherein:
the depositing of the silicon (B4) comprises chemical vapor deposition (CVD) of the silicon.

24. The silicon-carbon composite particles made according to the method of claim 1.

25. A Li-ion rechargeable battery, comprising:
an anode comprising the silicon-carbon composite particles of claim 24;
a cathode; and
an electrolyte ionically coupling the anode and the cathode.
